(19) United States
(12) Patent Application Publication
(10) Pub. No.: US 2022/0387239 A1
(43) Pub. Date: Dec. 8, 2022

(54) MULTI-FUNCTION FRAME POSITIONING DEVICE

(71) Applicant: Spine Care Technologies, Inc., Glen Head, NY (US)

(72) Inventors: Roland Kiser, Glen Head, NY (US); David Cuccia, Syosset, NY (US); Alan Squillante, Kings Park, NY (US)

(21) Appl. No.: 17/765,343

(22) PCT Filed: Oct. 20, 2020
(86) PCT No.: PCT/US2020/056440

§ 371 Date: Mar. 30, 2022

Related U.S. Application Data
(60) Provisional application No. 62/923,946, filed on Oct. 21, 2019.

(51) Int. Cl. A61G 13/08; A61G 13/00; A61G 13/04; A61G 13/06; A61G 13/12

(52) U.S. Cl. CPC A61G 13/08; A61G 13/009; A61G 13/04; A61G 13/06; A61G 13/1245; A61G 2203/14; A61G 2203/20

(57) ABSTRACT

A frame positioning device comprises a base assembly, an elevation and rotation assembly coupled to the base assembly, and a table assembly coupled to the elevation and rotation assembly. The table assembly comprises a table support and pivot sub-assembly, a first table section subassembly, and a second table section subassembly. The table support and pivot subassembly is coupled to the first table section subassembly via a first pivot point. The table support and pivot subassembly is coupled to the second table section subassembly via a second pivot point.

### CROSS-REFERENCE TO RELATED APPLICATION

The present application is an international application which claims the benefit of and priority to U.S. Provisional Application Ser. No. 62/923,946, filed Oct. 21, 2019 and entitled “Treatment Tables,” which is incorporated by reference herein in its entirety.

### BACKGROUND

The present application relates to physical treatment tables for the application of manual and automated therapies. Various types of tables are designed for use by practitioners to perform a variety of different types of treatments for patients or other users of the treatment tables. A treatment table, for example, may be used in physical medicine and rehabilitation treatments, pain management, orthopedic treatments, sports medicine, physical therapy, chiropractic treatment, etc. There is a need for improved treatment tables configured to provide assisted movement of a patient for various treatments and application of diagnostic imaging.

### SUMMARY

Embodiments of the invention provide multi-function frame positioning devices for effecting positioning and mobilization of a user positioned thereon. In some embodiments, a multi-function frame positioning device provides a treatment table configured for effecting extension, flexion, lateral flexion, rotation, distraction of a spine, and mobilization of a patient or other user of the treatment table. These movements and positions can be combined during treatments or diagnostic procedures.

In some embodiments, a frame positioning device comprises a base assembly, an elevation and rotation assembly coupled to the base assembly, and a table assembly coupled to the elevation and rotation assembly. The table assembly comprises a table support and pivot subassembly, a first table section subassembly, and a second table section subassembly. The table support and pivot subassembly is coupled to the first table section subassembly via a first pivot point. The table support and pivot subassembly is coupled to the second table section subassembly via a second pivot point.

The elevation and rotation assembly may comprise one or more actuators, the one or more actuators being configured to adjust an elevation of the table assembly relative to the base assembly and to adjust a rotation of the table assembly about a table pivot point axis of a table pivot point coupling the table assembly to the elevation and rotation assembly.

The elevation and rotation assembly may comprise at least one of: a four-bar mechanism; one or more telescoping pillars; one or more robotic arms; and one or more sets of sliding pillars table.

The table support and pivot subassembly may comprise two or more actuators, at least a first one of the two or more actuators being coupled to the first table section subassembly and at least a second one of the two or more actuators being coupled to the second table section subassembly. The first actuator may be configured to at least one of elevate, tilt and rotate the first table section subassembly about the first pivot point, the second actuator may be configured to at least one of elevate, tilt and rotate the second table section subassembly about the second pivot point, and said at least one of the elevation, tilt and rotation of the first table section subassembly may be independent of said at least one of the elevation, tilt and rotation of the second table section subassembly.

The first table section subassembly may comprise a thoracic support section and the second table section subassembly may comprise a pelvis support section and a leg support section.

The first table section subassembly may further comprise a lumbar support section.

The second table section subassembly may further comprise a lumbar support section.

The pelvis support section and the lumbar support section may comprise a combined lumbar and pelvis support pad.

The pelvis support section may comprise a pelvis support pad and the lumbar support section comprises a lumbar support pad, the pelvis support pad being separate from the lumbar support pad.

The second table section subassembly may further comprise a knee support section disposed between the pelvis support section and the leg support section. The knee support section may be configured for at least one of telescoping, sliding and pivoting independent of the pelvis support section and the leg support section.

The table assembly may further comprise a third table section subassembly coupled to the table support and pivot subassembly, the third table section subassembly comprising a lumbar support section.

The pelvis support section may be configured to at least one of elevate, tilt, rotate and extend independent of the leg support section.

At least one of the first table section subassembly and the second table section subassembly may comprise at least one support pad configured for sliding along an axis extending between lateral edges of the table assembly.

At least one of the first table section subassembly and the second table section subassembly may comprise at least one support pad configured for pivoting about an axis extending from a top edge of the table assembly to a bottom edge of the table assembly.

At least one of the first table section subassembly and the second table section subassembly may be configured for attachment to a C-arm structure.

The frame positioning device may further comprise a controller. The controller may be configured to adjust at least one of an elevation and a rotation of the table assembly relative to the base assembly utilizing the elevation and rotation assembly. The controller may be configured to adjust said at least one of the elevation and the rotation of the table assembly between a vertical position and a horizontal position. The controller may be configured to adjust positions of the first table section subassembly and the second table section subassembly about the first and second pivot points.

The frame positioning device may comprise or be part of a treatment table.

In some embodiments, a method of operating a frame positioning device comprises obtaining at least one of motion and scan analysis data for a user, determining position settings for performing one or more sequences of motion of the user based at least in part on the motion and scan analysis data, and performing a selected one of the one or more sequences of motion by adjusting positioning of a table assembly of the frame positioning device utilizing one or more actuators of the frame positioning device. The table assembly comprises a table support and pivot subassembly, a first table section subassembly coupled to the table support and pivot subassembly via a first pivot point, and a second table section subassembly coupled to the table support and pivot subassembly via a second pivot point. Adjusting the positioning of the table assembly comprises at least one of adjusting a first position of the first table section subassembly about the first pivot point and adjusting a second position of the second table section subassembly about the second pivot point. The method is performed by a controller of the frame positioning device, the controller comprising at least one processing device comprising a processor coupled to a memory.

The table assembly may be coupled to an elevation and rotation assembly of the frame positioning device, and adjusting the positioning of the table assembly may further comprise at least one of adjusting an elevation and a rotation of the table assembly relative to a base assembly of the frame positioning device, the base assembly being coupled to the elevation and rotation assembly.

The method may further comprise receiving input data related to at least one of patient size, patient body type, and one or more expected treatment protocols, wherein the table assembly is coupled to an elevation and rotation assembly of the frame positioning device, and wherein adjusting the positioning of the table assembly further comprises adjusting at least one of an elevation and a rotation of the table assembly relative to a base assembly of the frame positioning device, the base assembly being coupled to the elevation and rotation assembly.

The method may further comprise receiving feedback related to the positioning of the table assembly associated with the selected sequence of motion, and further adjusting the positioning of the table assembly of the frame positioning device based at least in part on the received feedback.

In some embodiments, a computer program product comprises a non-transitory processor-readable storage medium having stored therein program code of one or more software programs, wherein the program code when executed by a controller of a frame positioning device causes the controller to perform steps of obtaining at least one of motion and scan analysis data for a user, determining position settings for performing one or more sequences of motion of the user based at least in part on the motion and scan analysis data, and performing a selected one of the one or more sequences of motion by adjusting positioning of a table assembly of the frame positioning device utilizing one or more actuators of the frame positioning device. The table assembly comprises a table support and pivot subassembly, a first table section subassembly coupled to the table support and pivot subassembly via a first pivot point, and a second table section subassembly coupled to the table support and pivot subassembly via a second pivot point. Adjusting the positioning of the table assembly comprises at least one of adjusting a first position of the first table section subassembly about the first pivot point and adjusting a second position of the second table section subassembly about the second pivot point.

The table assembly may be coupled to an elevation and rotation assembly of the frame positioning device, and adjusting the positioning of the table assembly may further comprise at least one of adjusting an elevation and a rotation of the table assembly relative to a base assembly of the frame positioning device, the base assembly being coupled to the elevation and rotation assembly.

The program code when executed by the controller of the frame positioning device may further cause the controller to perform the step of receiving input data related to at least one of patient size, patient body type, and one or more expected treatment protocols, wherein the table assembly is coupled to an elevation and rotation assembly of the frame positioning device, and wherein adjusting the positioning of the table assembly further comprises adjusting at least one of an elevation and a rotation of the table assembly relative to a base assembly of the frame positioning device, the base assembly being coupled to the elevation and rotation assembly.

The program code when executed by the controller of the frame positioning device may further cause the controller to perform the steps of receiving feedback related to the positioning of the table assembly associated with the selected sequence of motion, and further adjusting the positioning of the table assembly of the frame positioning device based at least in part on the received feedback.

### BRIEF DESCRIPTION OF THE DRAWINGS

FIGS. 1A-1D depict a treatment table, according to an embodiment of the invention.

FIGS. 2A-2D depict base and table sections of a treatment table, according to an embodiment of the invention.

FIGS. 3A-3H depict aspects of a base section of a treatment table, according to an embodiment of the invention.

FIGS. 4A-4F depict aspects of a table section of a treatment table, according to an embodiment of the invention.

FIGS. 5A-5EE depict aspects of a table support and pivot subassembly of a table section of a treatment table, according to an embodiment of the invention.

FIGS. 6A-6E depict aspects of an interface between a table support and pivot subassembly, a thoracic sub-assembly, and a lumbar, pelvis and leg subassembly of a table section of a treatment table, according to an embodiment of the invention.

FIGS. 7A-7C depict aspects of pivot control sections, according to an embodiment of the invention.

FIGS. 8A-8E depict aspects of a thoracic subassembly of a table section of a treatment table, according to an embodiment of the invention.

FIGS. 9A-9Q depict aspects of lumbar and pelvis sections of a lumbar, pelvis and leg subassembly of a table section of a treatment table, according to an embodiment of the invention.

FIGS. 10A-10Q depict aspects of a leg section of a lumbar, pelvis and leg subassembly of a table section of a treatment table, according to an embodiment of the invention.

FIGS. 11A-11J depict retraction, extension and tilt of portions of a lumbar, pelvis and leg subassembly of a table section of a treatment table, according to an embodiment of the invention.

FIGS. 12A-12R depict various motions of a table support and pivot subassembly, a thoracic subassembly, and a lumbar, pelvis and leg subassembly of a table section of a treatment table, according to an embodiment of the invention.

FIGS. 13A-13I depict various additional motions of a table support and pivot subassembly, a thoracic subassembly, and a lumbar, pelvis and leg subassembly of a table section of a treatment table, according to an embodiment of the invention.

FIGS. 14A-14C depict pelvis tilt of a pelvis support pad of lumbar, pelvis and leg subassembly of a table section of a treatment table, according to an embodiment of the invention.

FIGS. 15A and 15B depict extension of a leg section of a lumbar, pelvis and leg subassembly of a table section of a treatment table using a belt mechanism, according to an embodiment of the invention.

FIG. 16 depicts extension of a leg section of a lumbar, pelvis and leg subassembly of a table section of a treatment table using a rack and pinion mechanism, according to an embodiment of the invention.

FIGS. 17A-17C depict modular support pads and rotation of portions of a treatment table, according to an embodiment of the invention.

FIGS. 18A-18G depict insertable wedge support pads for a treatment table, according to an embodiment of the invention.

FIGS. 19A and 19B depict a treatment table with a control system and underarm supports, according to an embodiment of the invention.

FIGS. 20A-20J depict joystick controls for a treatment table, according to an embodiment of the invention.

FIG. 21 depicts a treatment table with an alternate control system, according to an embodiment of the invention.

FIG. 22 depicts a treatment table with another alternate control system, according to an embodiment of the invention.

FIG. 23 depicts support pads of a treatment table with integrated controls, according to an embodiment of the invention.

FIG. 24 depicts a support pad of a treatment table, according to an embodiment of the invention.

FIGS. 25A-25I depict a support pad of a treatment table with removable pads, according to an embodiment of the invention.

FIG. 26 depicts tilt of a treatment table utilizing a telescopic pillar base, according to an embodiment of the invention.

FIG. 27 depicts tilt of a treatment table utilizing a robotic arm base, according to an embodiment of the invention.

FIGS. 28A and 28B depict tilt of a treatment table utilizing first and second sets of sliding pillars, according to an embodiment of the invention.

FIGS. 29A-29E depict positioning of a user on a treatment table, according to an embodiment of the invention.

FIG. 30 depicts movements of a treatment table, according to an embodiment of the invention.

FIGS. 31A-31K depict movement of a pelvis pad, according to an embodiment of the invention.

FIGS. 32A-32C depict a pelvis pad coupled to a lumbar pad, according to an embodiment of the invention.

FIG. 33 shows an example of an information processing system that may be utilized to implement at least a portion of a treatment table, according to an embodiment of the invention.

FIG. 34 shows input data provided to a control system of a treatment table operated by a practitioner, according to an embodiment of the invention.

FIGS. 35A and 35B show a process flow for a practitioner and control system for operation of a treatment table, according to an embodiment of the invention.

### DETAILED DESCRIPTION

Illustrative embodiments of the invention will be described herein in the context of illustrative treatment tables, along with illustrative apparatus, systems and methods for utilizing such treatment tables. However, it is to be understood that embodiments of the invention are not limited to the illustrative methods, apparatus, systems and devices but instead are more broadly applicable to other suitable methods, apparatus, systems and devices.

Illustrative embodiments provide multi-function frame positioning devices. A multi-function frame positioning device may provide a three-dimensional (3D) human frame positioning system utilized for enhancing accuracy and precision of body positioning and movement. Such multi-function frame positioning devices and 3D human frame positioning systems may be used to enhance treatment protocols in the practice of, for example, physical therapy, chiropractic treatment, decompression, pain management injections during motion picture X-ray fluoroscopy, etc. Multi-function frame positioning devices and 3D human frame positioning systems described herein may be used to reconfigure patient or other user support platforms or interfaces manually or automatically, mimicking body posture in response to received digital scanning input data of the patient or other user's posture and distortion (e.g., scoliosis) as derived from various 3D body posture scanners. The multi-function frame positioning devices and 3D human frame positioning systems may provide treatment tables for effecting one or more of extension, flexion, lateral flexion, rotation, and distraction of a spine of a patient or other user. It should be understood that references herein to “treatment tables” refer to example implementations of what is more generally referred to as a 3D human frame positioning system or a multi-function frame positioning device.

In some embodiments, a treatment table includes a platform adapted to rest upon a floor, a four-bar mechanism or other type of elevation assembly to lift the table, actuators to rotate the table from a vertical position to a horizontal position, and several actuators and systems to position and move elements of the table simultaneously to provide superior treatments including one or more of extension, flexion, lateral flexion, rotation, and distraction of the spine of the patient. The treatment table is designed to treat the patient in a number of orientations from vertical to horizontal, and can use gravity to assist in vertical or near vertical orientations. Although many views of the figures are shown in either horizontal or vertical positions, it should be appreciated that movement of the treatment table elements can be accomplished in any given orientation of the table from vertical to horizontal. While various embodiments are described below with respect to a therapeutic treatment table (e.g., for use with physical medicine and rehabilitation treatments, pain management, orthopedic treatments, sports medicine, physical therapy, chiropractic treatments, etc.), it should be appreciated that the treatment tables described herein are not limited solely to use for any particular health care discipline such as for physical therapy treatments. The treatment tables described herein may be used in other contexts where it is desired to effect one or more of extension, flexion, lateral flexion, rotation, distraction, and motion of a spine of a patient or other user. The treatment tables described herein also allow easier application of manual therapeutic features, including but not limited to skeletal manipulation while under the effects of body traction. For example, the treatment tables described herein may be used as multi-purpose physical therapy tables. The term “treatment table” as used herein is thus intended to be construed broadly, so as to encompass chiropractic tables, physical therapy tables, etc.

A number of the figures described in further detail below illustrate various possible movements and positions of different elements of a frame positioning device (e.g., a treatment table). Although not explicitly shown for clarity of illustration, some or all of the movable elements may be equipped with position sensors to provide feedback to a control system of the frame positioning device. Such feedback may relate to all degrees of freedom, both translational and angular.

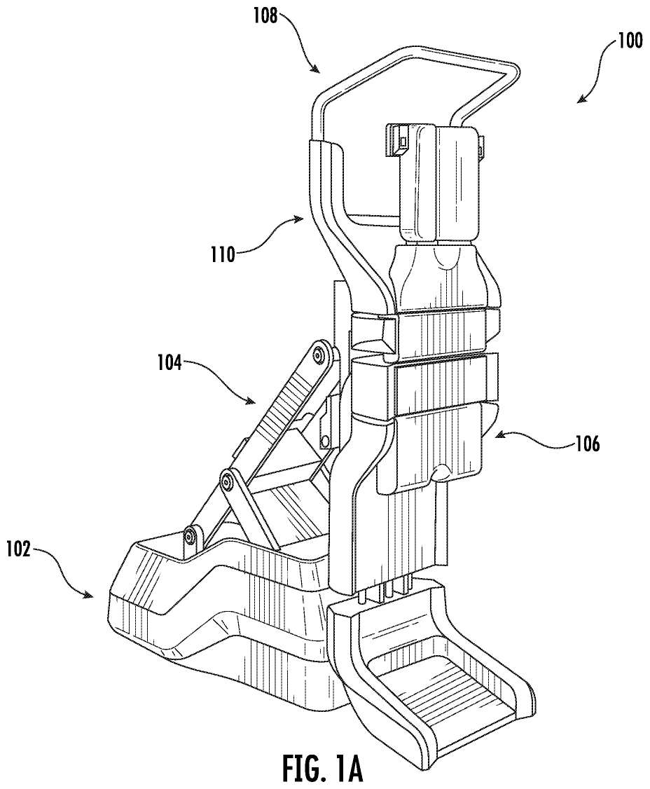

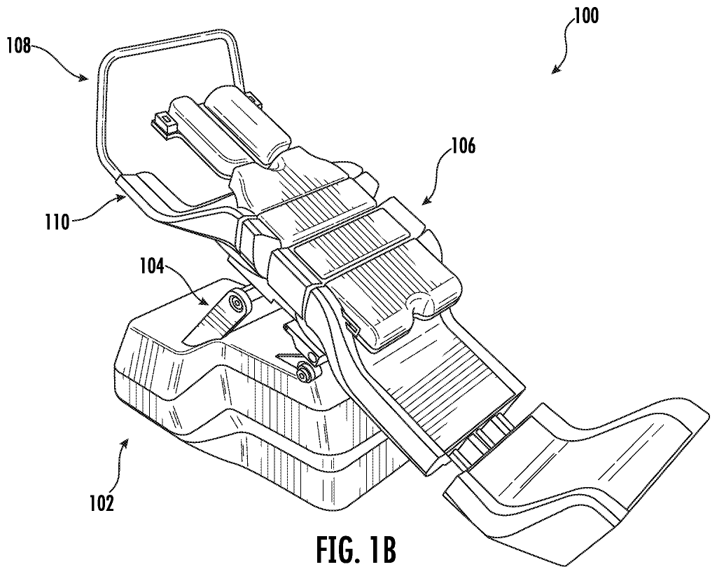

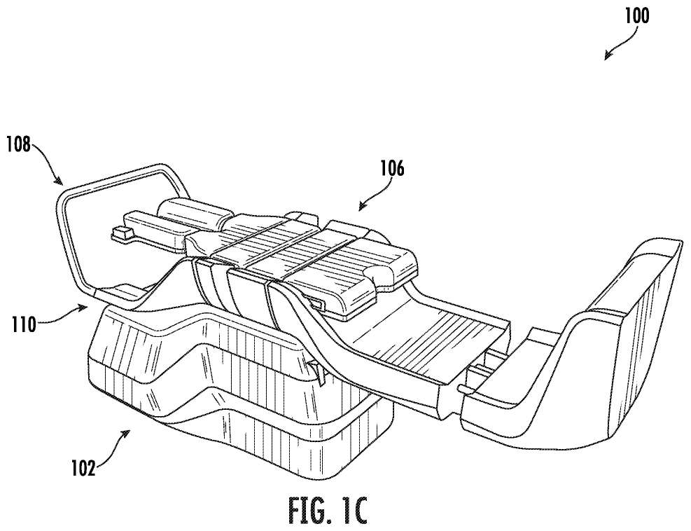

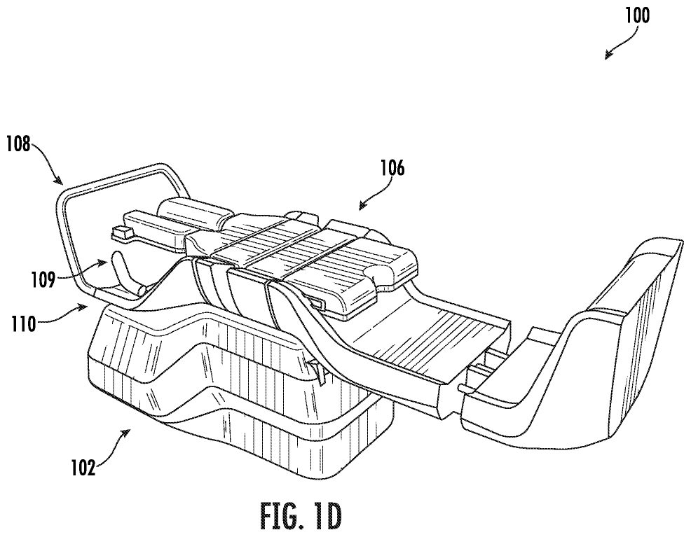

FIGS. 1A-1D show a treatment table 100 including a platform 102, a four-bar mechanism 104 and a table 106. FIG. 1A shows the four-bar mechanism 104 rotating a rotationally attached patient support platform gantry 106, also referred to herein as table 106, to an upright position (e.g., where the table 106 is perpendicular to the floor on which the platform 102 rests). FIG. 1B shows the four-bar mechanism 104 rotating the table 106 at an angle (e.g., a 45 degree (deg) angle) relative to the floor on which the platform 102 rests. FIG. 1C shows the table 106 rotated to a flat position (e.g., where the table 106 is parallel to the floor on which the platform 102 rests) using the four-bar mechanism 104. As will be described in further detail below, the treatment table 100 may include various actuators that control the four-bar mechanism 104 to rotate the table 106 as desired. It should be further appreciated that, in some embodiments, such actuators are configured to rotate the table 106 at any desired angle (e.g., at any angle between the upright position shown in FIG. 1A and the flat position shown in FIG. 1C). In other embodiments, the actuators are configured to rotate the table 106 to certain predetermined positions (e.g., at 5 degree angle of rotation increments between the upright position shown in FIG. 1A and the flat position shown in FIG. 1C). It should also be further appreciated that other mechanisms may be employed to lift and rotate the table 106.

FIGS. 1A-1C also show an overhead bar 108 that can be gripped by a patient or other user of the treatment table 100 during certain treatments (e.g., prone and supine treatments). The overhead bar 108 may be adjustable and removable. Adjustments of overhead bar 108 may be in any orientation, including translation, rotation, and any combination of rotation and translation. FIG. 1D shows an alternative configuration further including grips 109. The patient can hold the grips 109 when in the prone position. The grips 109 may be fixed, repositionable (e.g., manual or powered repositioning), removable, combinations thereof, etc. The patient may alternately grip the overhead bar 108 while in the prone position. Also shown is a forearm rest 110, which may be utilized by a patient or other user of the treatment table 100 while in the prone position. In some embodiments, the overhead bar 108 may have controls that the patient can access when enabled by the practitioner. In other embodiments, the grips 109 may have controls that the patient can access when enabled by the practitioner.

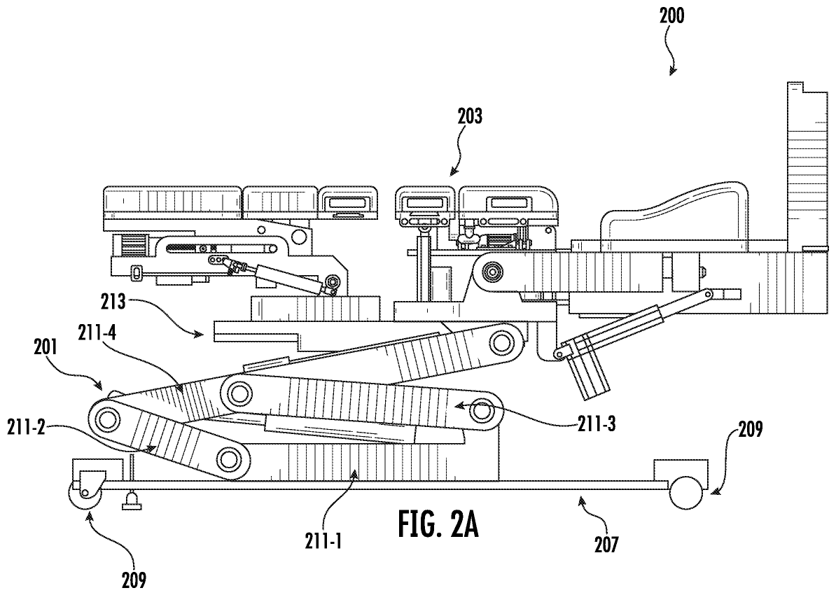

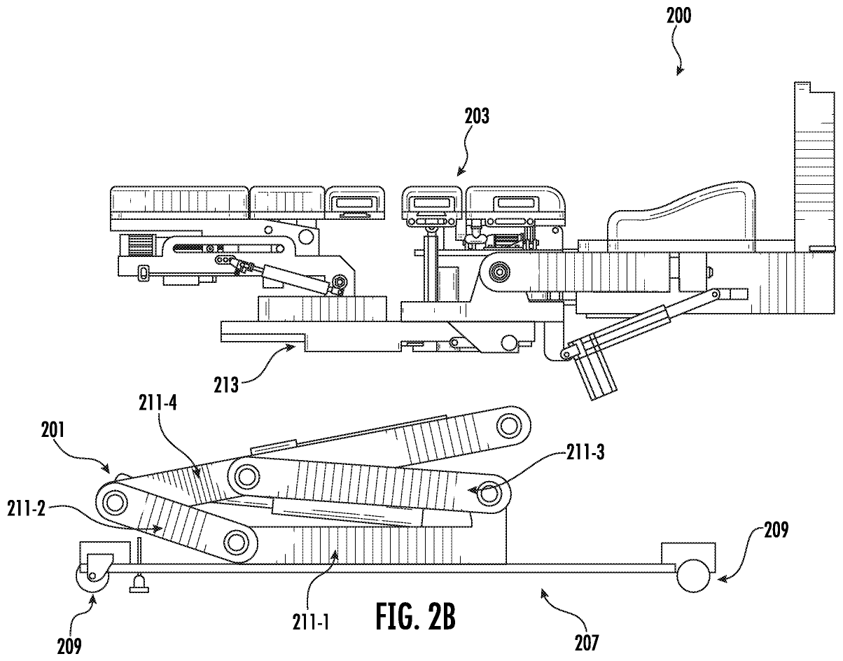

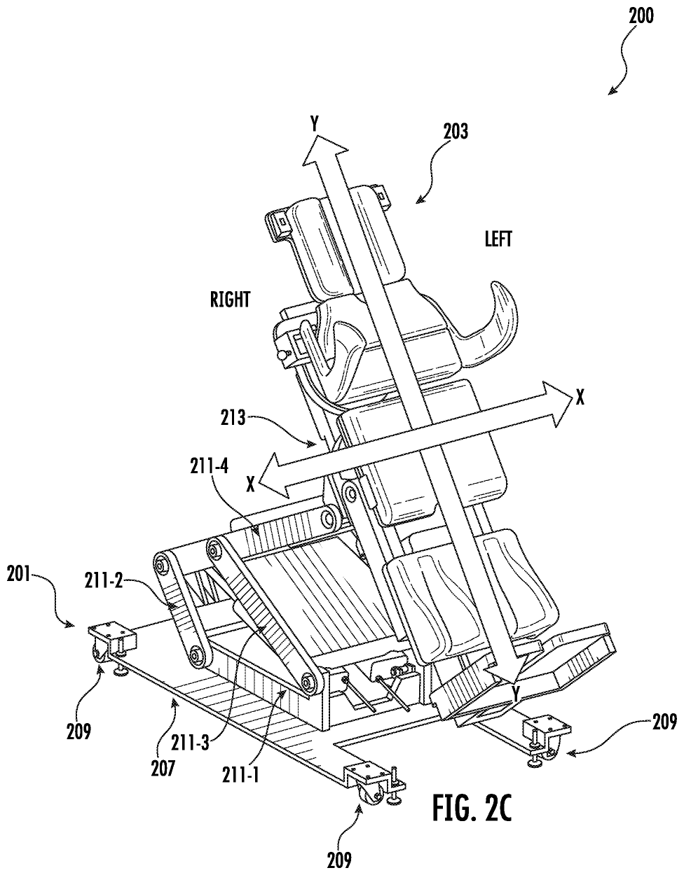

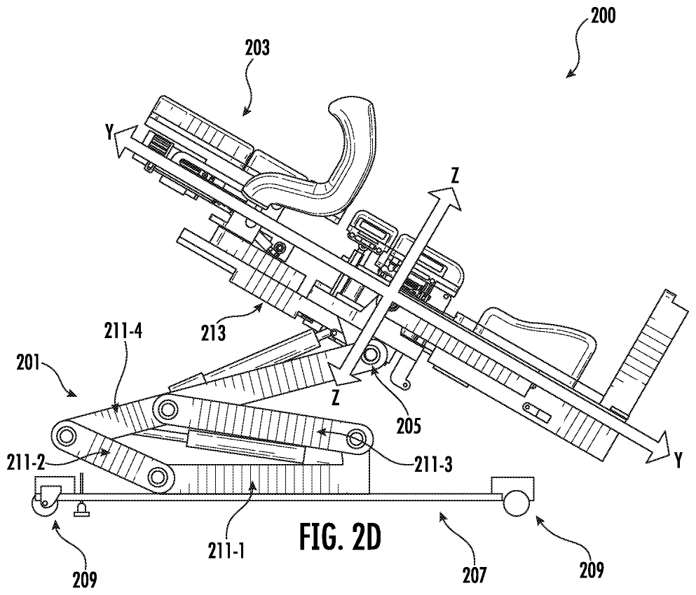

FIGS. 2A-2D show a base section 201 and a table section 203 of a treatment table 200. The base section 201 includes a platform 207 that may include wheels 209 for easy transport and setup of the treatment table 200. The platform of the base section 201 is coupled to a four-bar mechanism including elements 211-1, 211-2, 211-3 and 211-4. The elements 211-1 through 211-4 are collectively referred to herein as four-bar mechanism 211. The four-bar mechanism 211 is coupled to a table support platform 213. The four-bar mechanism 211 is configured to adjust the rotation and elevation of the table support platform 213 to effect rotation and elevation of the table section 204. FIG. 2A shows the table section 203 at its lowest position horizontal position, and FIG. 2B shows the base section 201 and the table section 203 separated from one another. FIGS. 2C and 2D illustrate the different axes and positions used in the description below. The axes used for the description are relative to a patient or user of the treatment table 200 in the prone or supine position on the table section 203 as illustrated in FIGS. 2C and 2D. The axes always follow the tilt of the table section 203. The “right” and “left” are defined relative to the patient or user in the supine position. FIG. 2D also illustrates the table section tilt axis 205 about which the table section 203 tilts.

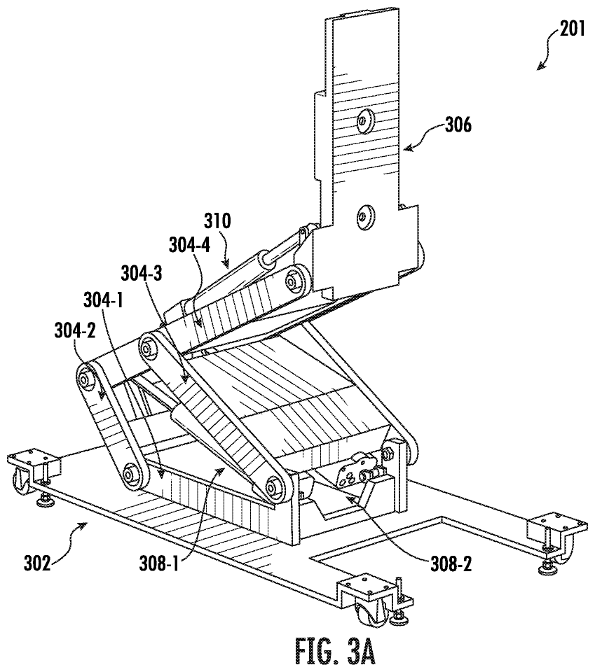

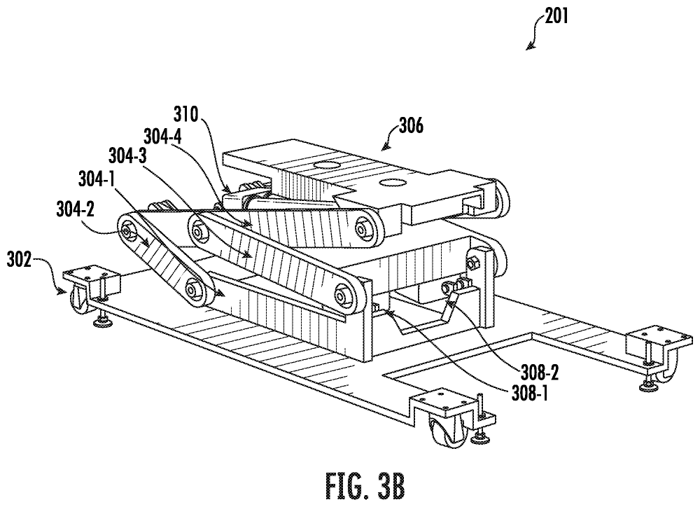

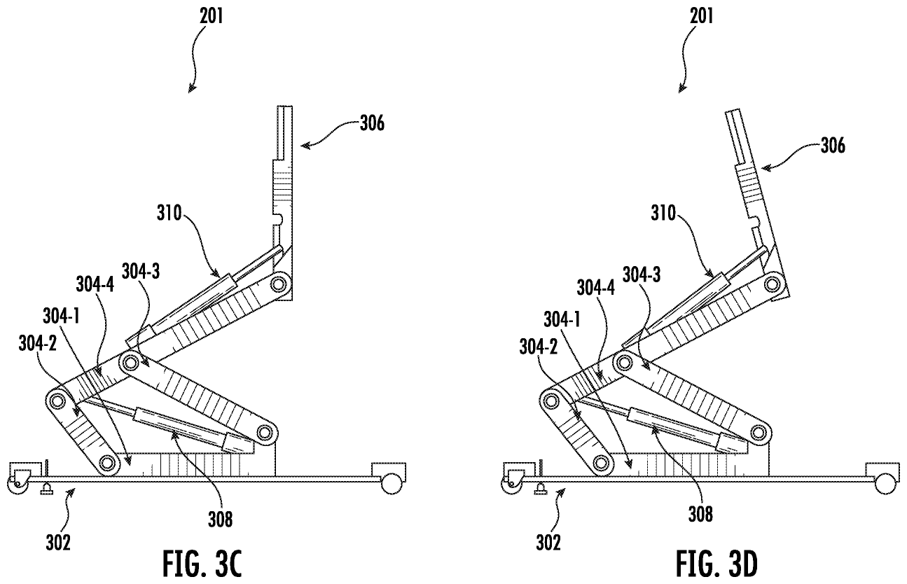

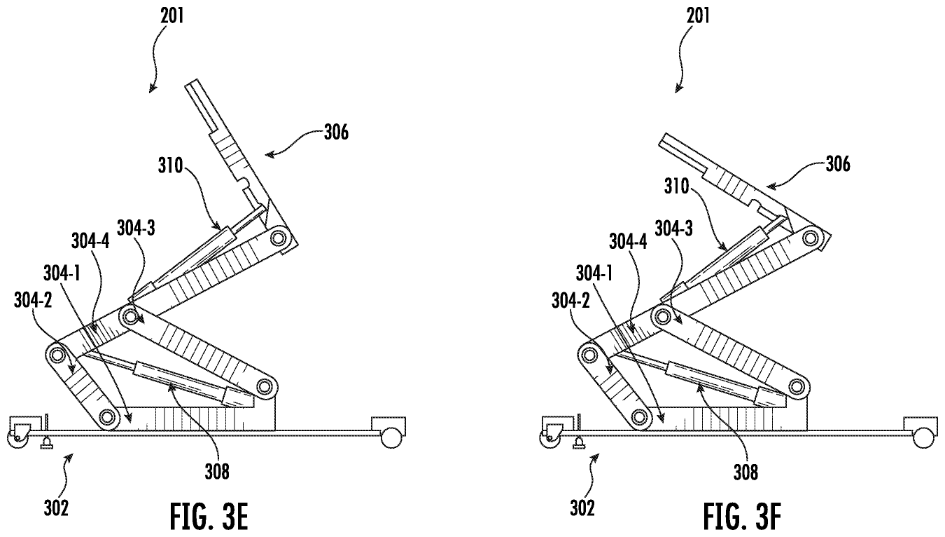

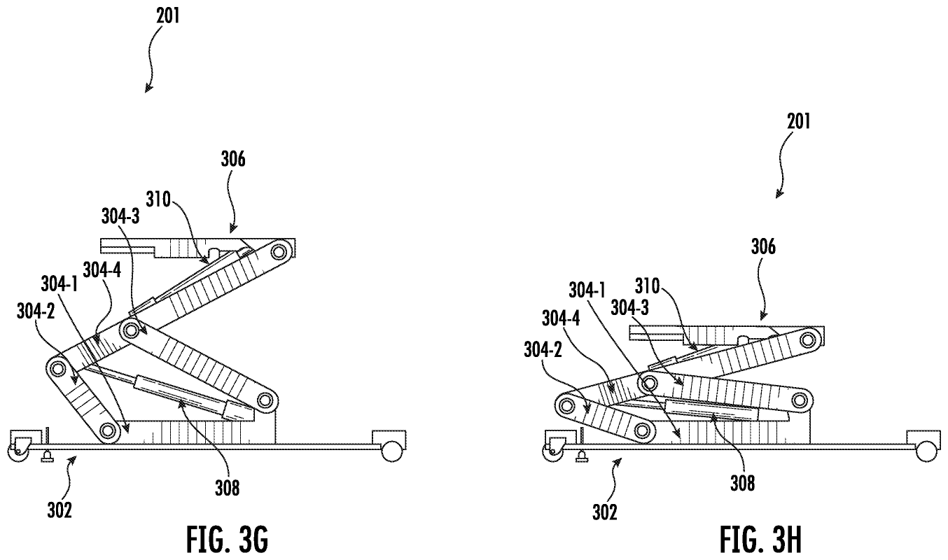

FIGS. 3A-3H show details of the base section 201 of treatment table 200. The base section 201 includes a floor platform 302, a four-bar mechanism including elements 304-1, 304-2, 304-2 and 304-4 (collectively, four-bar mechanism 304) and a table support platform 306. The floor platform 302 rests on the floor or other surface on which the associated treatment table rests. The four-bar mechanism 304 is used to raise and lower the height of an associated table section (not shown). The table support platform 306 is configured for use in coupling the base section 201 to an associated table section (e.g., table section 203). FIG. 3A shows the table support platform 306 in its vertical position, corresponding to the upright position of table 106 shown in FIG. 1A. FIG. 3B shows the table support platform 306 in a horizontal position, corresponding to the flat position of table 106 shown in FIG. 1C. With the table support platform 306 in the vertical position of FIG. 3A, the patient is able to walk onto the table facing the unit or with their back to the unit. When facing the unit, the patient will be rotated as shown in FIG. 1C to be in the prone position for treatment. When backed into the unit, the patient will be rotated as shown in FIG. 1C to be in the supine position for treatment.

FIGS. 3A-3H also illustrate four-bar actuators 308-1 and 308-2 (collectively, four-bar actuators 308) and a table support platform actuator 310. The four-bar actuators 308 and table support platform actuator 310 are used to elevate and rotate the associated table section between the different positions as illustrated in FIGS. 3C-3H. It should be appreciated that the particular number of actuators may vary as needed to provide the desired force and extension for elevating and rotating the table section. For example, while FIGS. 3A-3H illustrate two four-bar actuators 308-1 and 308-2 and one table support platform actuator 310, in other embodiments there may be just a single four-bar actuator and multiple table support platform actuators, just a single four-bar actuator and a single table support platform actuator, multiple four-bar actuators and multiple table support platform actuators, etc.

The combination of elevation and rotation of the treatment table that can be achieved by the combination of the four-bar mechanism 304 and the rotating table section (e.g., including the table support platform 306) advantageously offers a wide range of treatment options that can be used by the practitioner. It should be noted that multiple combinations of lift and tilt can be achieved. For example, the four-bar mechanism 304 can be raised while the rotating table section (e.g., including the table support platform 306 and other portions of the treatment table providing a patient platform) can be in the horizontal position. As another example, the four-bar mechanism 304 can be at an intermediate position, while the patient platform or table section can be rotated into various degrees of tilt from vertical to horizontal. The four-bar mechanism 304 allows the patient platform or table section to move to a horizontal position that is stable and low, as compared to other types of lift mechanisms that may be used to transition from a vertical to a horizontal position. This is due to the ability of the four-bar mechanism 304 to lower the top bar (e.g., 304-4) down low as shown in FIG. 3B. Additionally, the table support platform actuator 310 can tuck into the profile of the four-bar mechanism 304 further enabling a low platform position for table support platform 306. Such low horizontal position is particularly useful in ways that allow a practitioner to treat certain conditions. The vertical position also advantageously allows patients with certain acute conditions to access the treatment table more easily.

The sequence of positions shown in FIGS. 3C-3H illustrate how the table support platform 306 is moved from the vertical or upright position to the lowest flat or horizontal position. A control system of the treatment table (not shown) can coordinate movement of the four-bar actuators 308 and table support platform actuator 310 to the desired treatment position in a smooth and efficient manner. The practitioner may also control the movement in various other sequences as desired. The desired treatment position, in some embodiments, is preset. A practitioner may use a semi-automatic mode control position interface (e.g., using a joystick control, using a touchscreen control, etc.) for coordinating such movement. The practitioner may also select a desired patient treatment height and angle, and the control system may automatically actuate the four-bar actuators 308 and table support platform actuator 310 to the selected height and angle in the smoothest and most time-efficient manner.

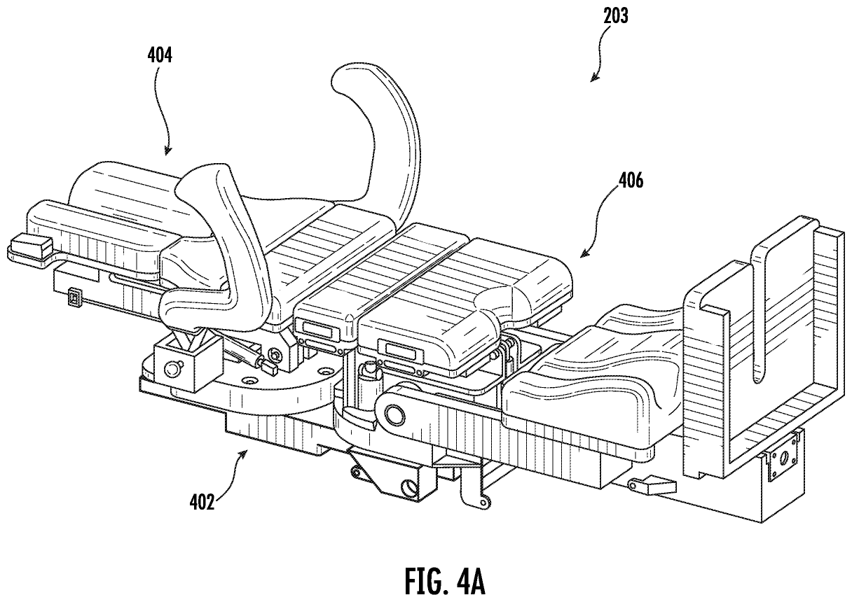

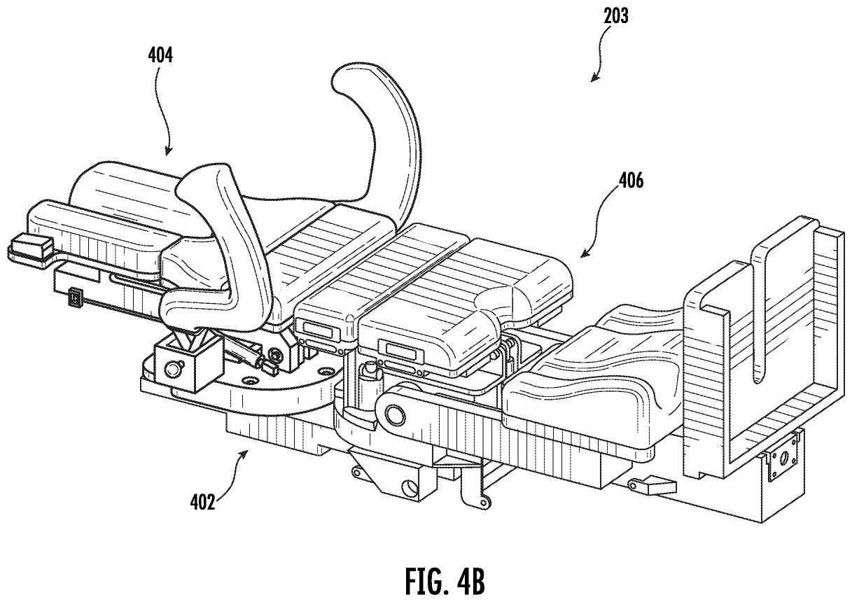

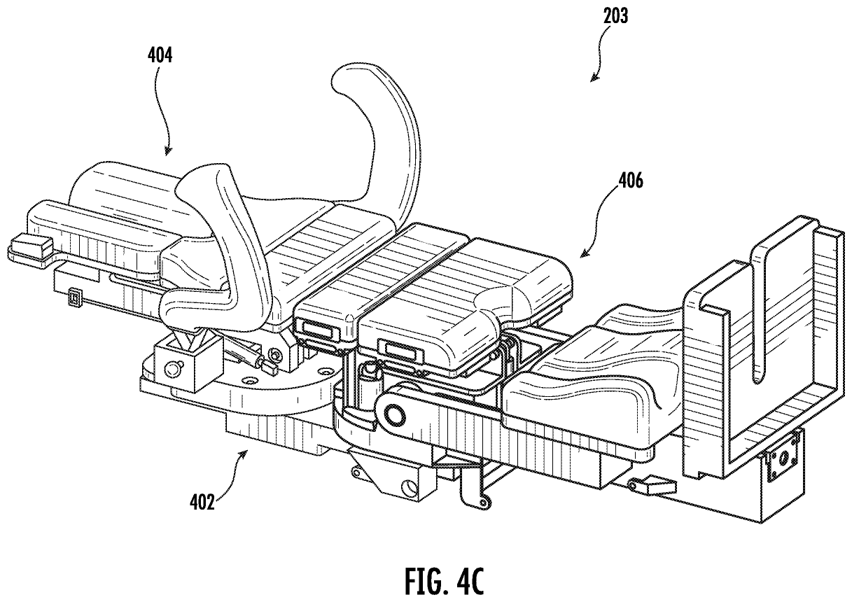

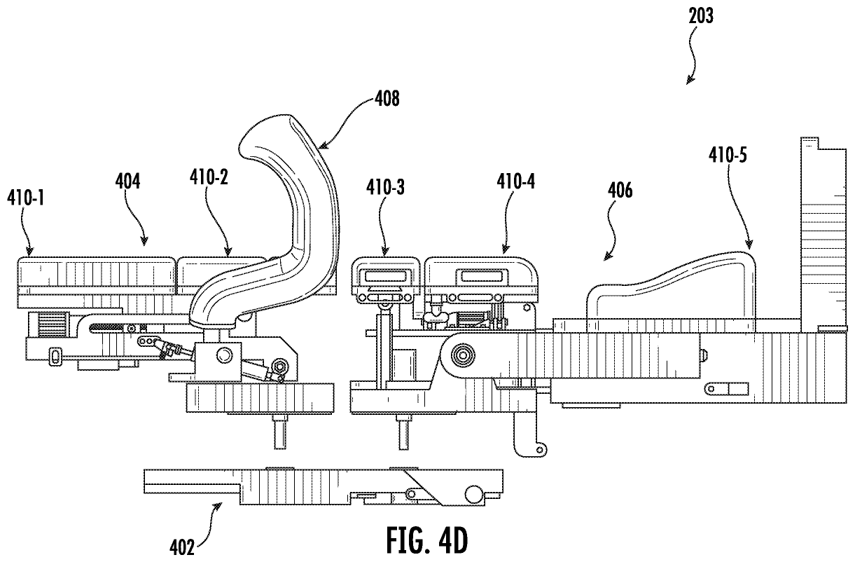

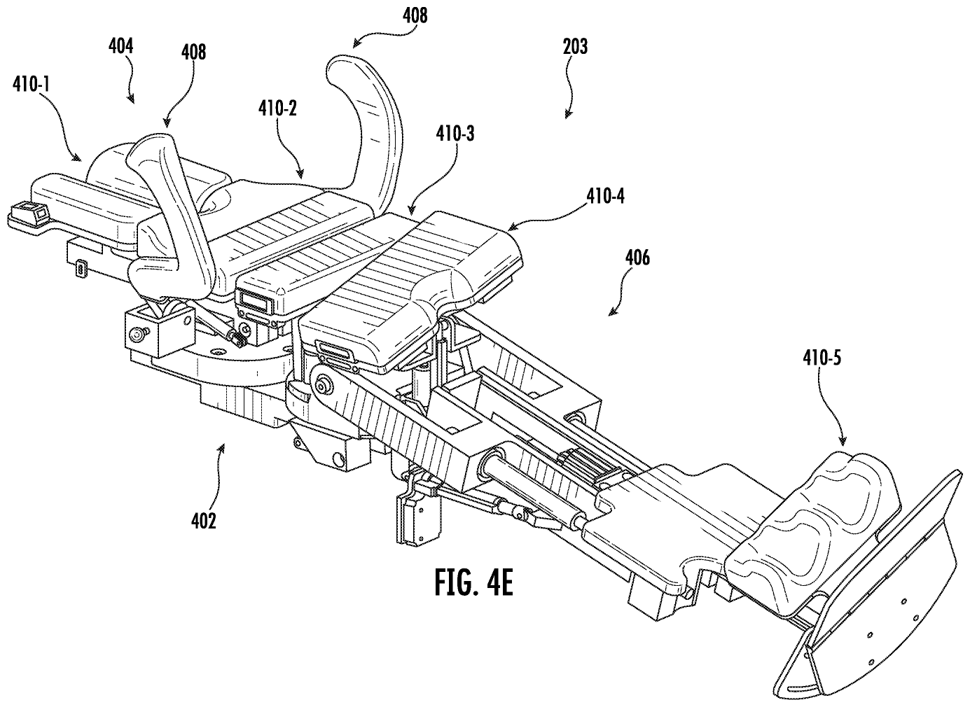

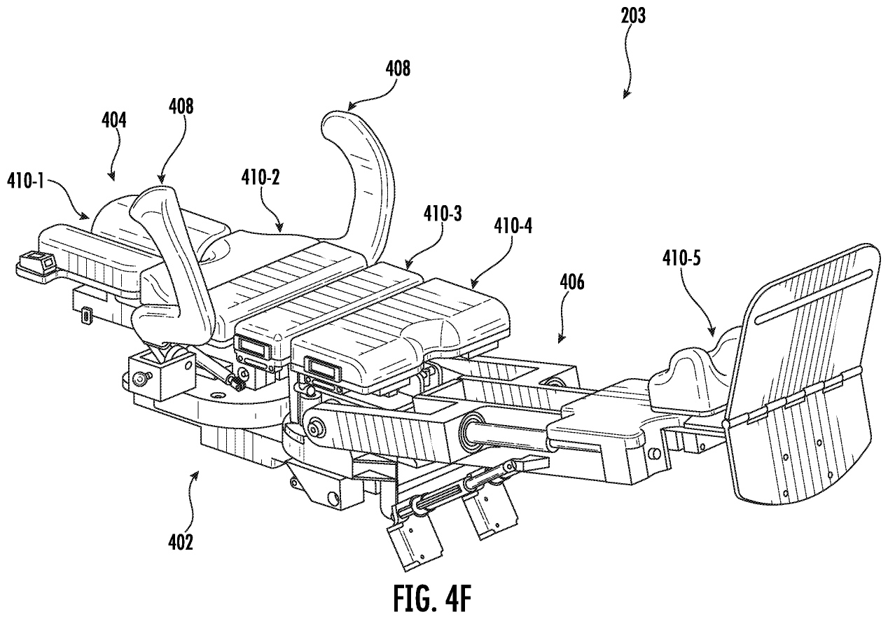

FIGS. 4A-4F show details of the table section 203 of treatment table 200, including a table support and pivot subassembly 402, a thoracic subassembly 404, and a lumbar, pelvis and leg subassembly 406. The table support and pivot subassembly 402 is highlighted in FIG. 4A, the thoracic subassembly 404 is highlighted in FIG. 4B, and the lumbar, pelvis and leg subassembly 406 is highlighted in FIG. 4C. In some embodiments, the lumbar, pelvis and leg subassembly 406 is further divided into a lumbar and pelvis subassembly and a leg subassembly that are independent of one another. In other embodiments, the lumbar, pelvis and leg subassembly 406 may be divided into a lumbar subassembly, a pelvis subassembly and a leg subassembly that are each independent of one another, or into a lumbar assembly and a pelvis and leg subassembly that are independent of one another, etc. In a similar fashion, the thoracic subassembly 404 may be divided into a head support subassembly and a thoracic support subassembly that are independent of one another. Subassemblies being independent of one another refers to the ability of such subassemblies to separately rotate, translate or otherwise move relative to one another. In embodiments where the thoracic subassembly 404 and/or the lumbar, pelvis and leg subassembly 406 are divided into multiple independent subassemblies, such independent subassemblies may be coupled to one another via various pivot and/or translational points to enable desired independent motion thereof.

FIG. 4D shows the table support and pivot subassembly 402, the thoracic subassembly 404, and the lumbar, pelvis and leg subassembly 406 of the table section 203 separated from one another. It should be appreciated that various configurations of the thoracic subassembly 404, including those described elsewhere herein, can be swapped out by practitioners to customize the treatment table as desired for a particular implementation (e.g., to provide a desired balance between available treatment options, cost and complexity of the device, etc.). Similarly, various configurations of the lumbar, pelvis and leg subassembly 406, including those described elsewhere herein, can be swapped out by practitioners to customize the treatment table as desired for a particular implementation (e.g., to provide a desired balance between available treatment options, cost and complexity of the device, etc.). The table section 203 may include under arm supports 408, ankle support straps (not shown) and various belts (not shown) to assist in securing the patient to the treatment table to provide targeted treatments. The table section 203 includes various support pads, including a head support pad 410-1, thoracic support pad 410-2, lumbar support pad 410-3, pelvis support pad 410-4 and leg or ankle support pad 410-5 (collectively, support pads 410). It should be appreciated that the support pads 410 may utilize modular assemblies as described in further detail below. Further, any of the support pads 410 may be separated into multiple distinct support pads as desired for a particular application. For example, the leg support pad 410-5 may include individual leg support pads for left and right legs of a user. Various other customizations of the support pads shown here and in other embodiments may be used as desired to provide optimal or desired therapeutic positioning and comfort for a patient or other user.

FIGS. 4E and 4F show two different positions of the lumbar, pelvis and leg subassembly 406 of the table section 203 of treatment table 200. FIG. 4E shows pelvis pad 410-4 tilt along with leg support pad 410-5 tilt. FIG. 4F shows elevation of the leg support pad 410-5 of the lumbar, pelvis and leg subassembly 406. It should be understood that the pivot points for the thoracic subassembly 404 and the lumbar, pelvis and leg subassembly 406 may be adjustable in distance from each other. Further, in some embodiments the thoracic subassembly 404 is not pivotable but the lumbar, pelvis and leg subassembly 406 is, or vice versa. Additionally, the pivoting could be accomplished by a different mechanism than is shown. It should also be noted that any of these elements may be modular in nature and can be added or subtracted from the treatment table based on individual needs of the end user.

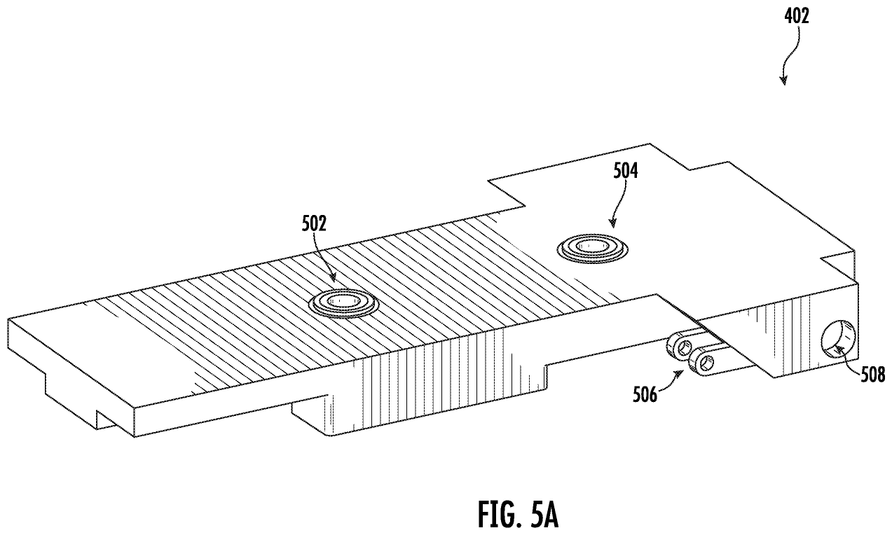

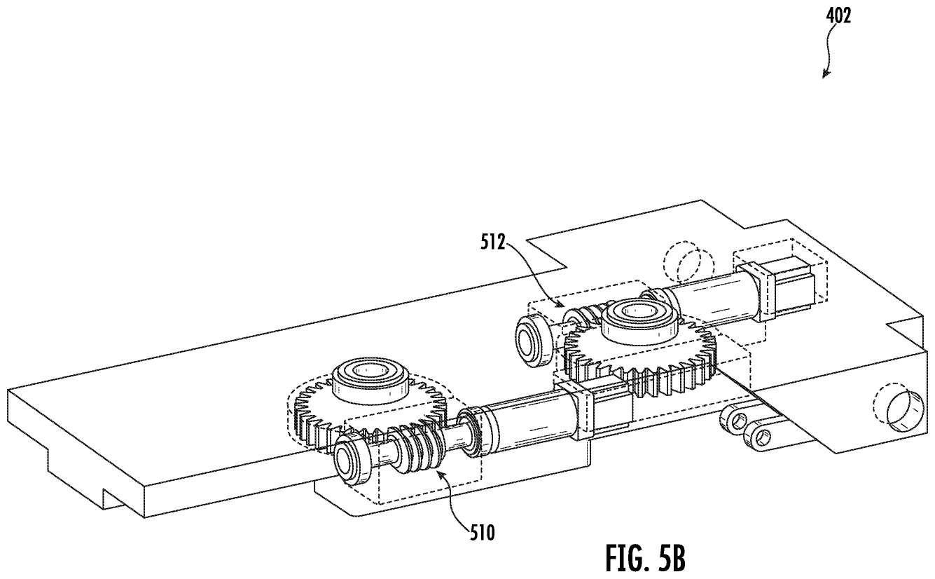

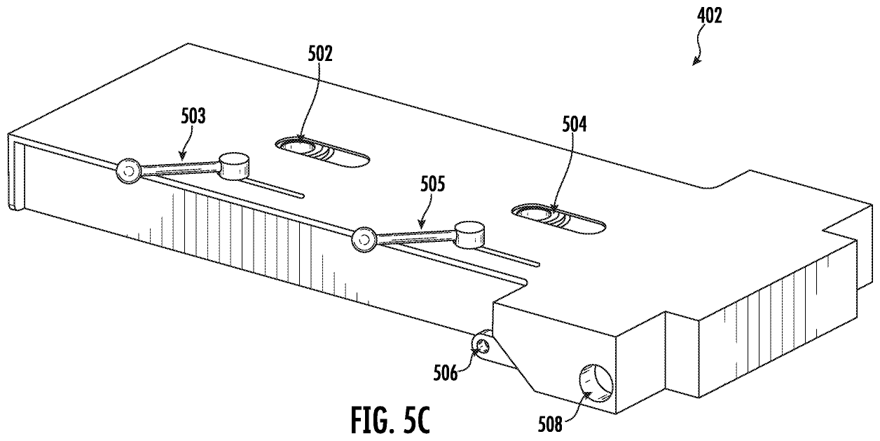

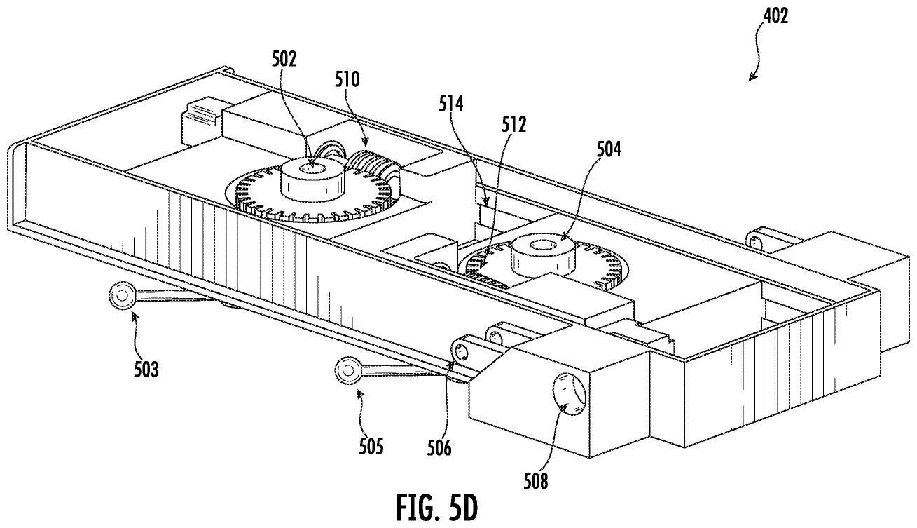

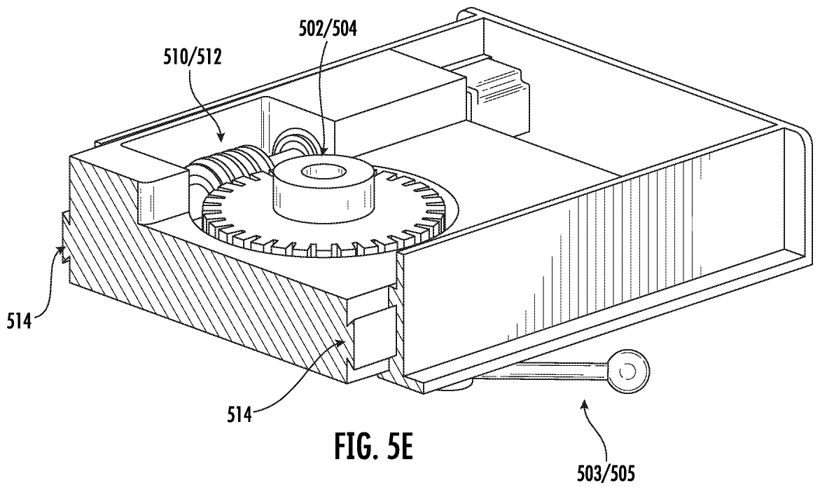

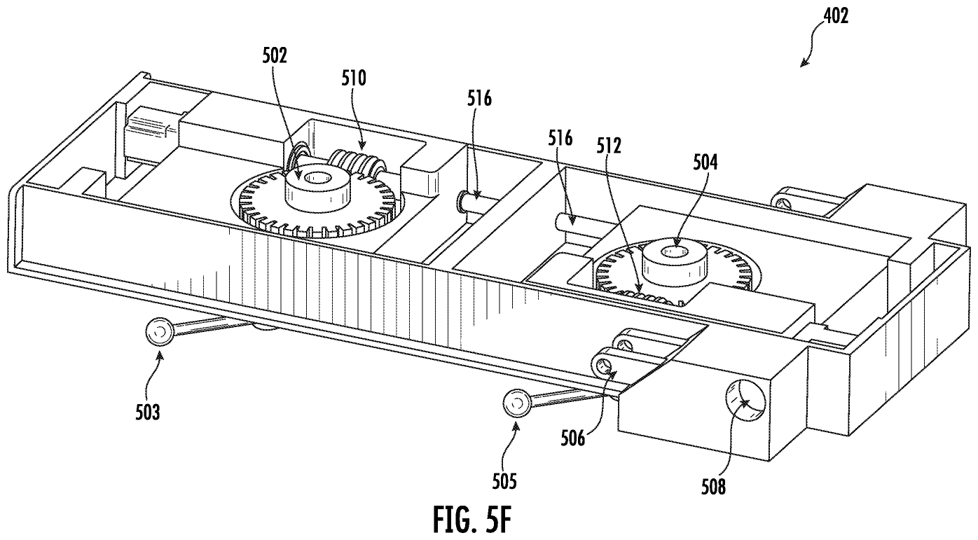

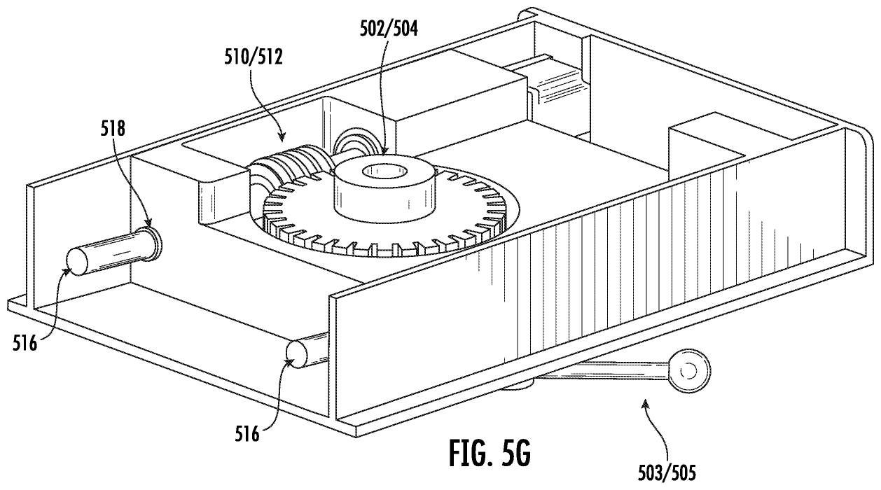

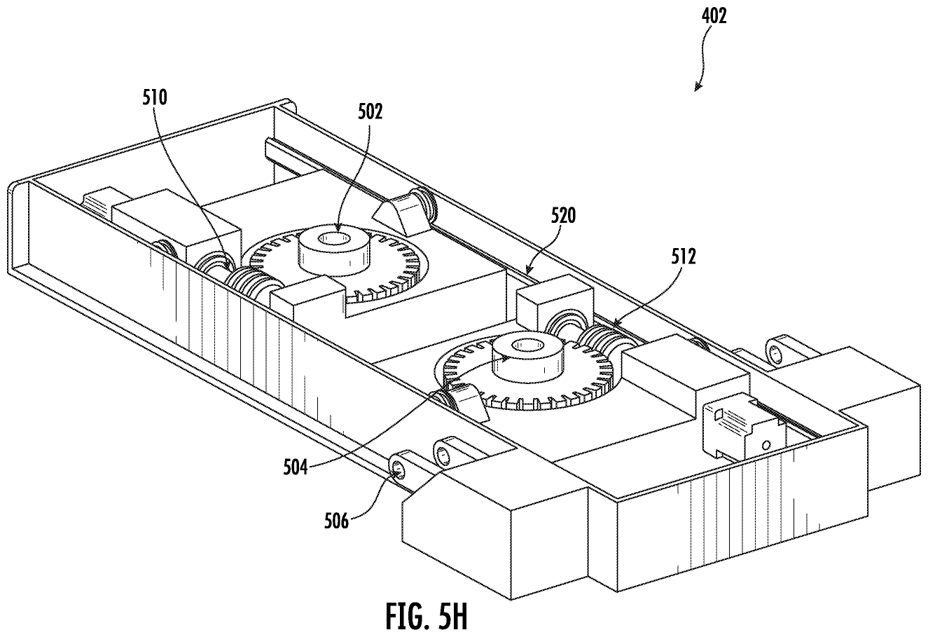

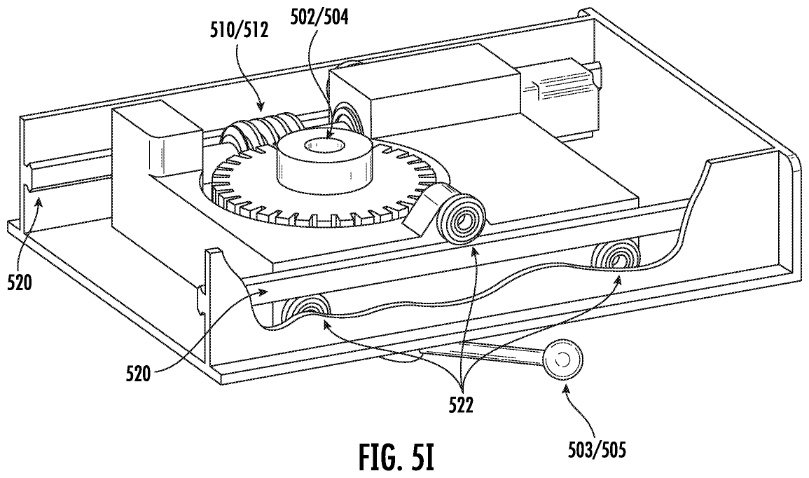

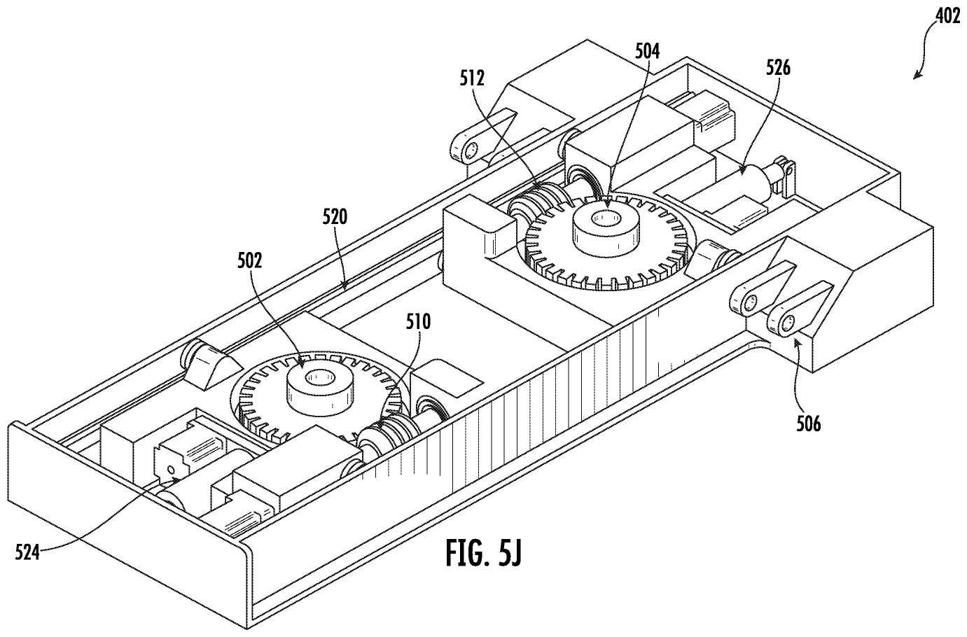

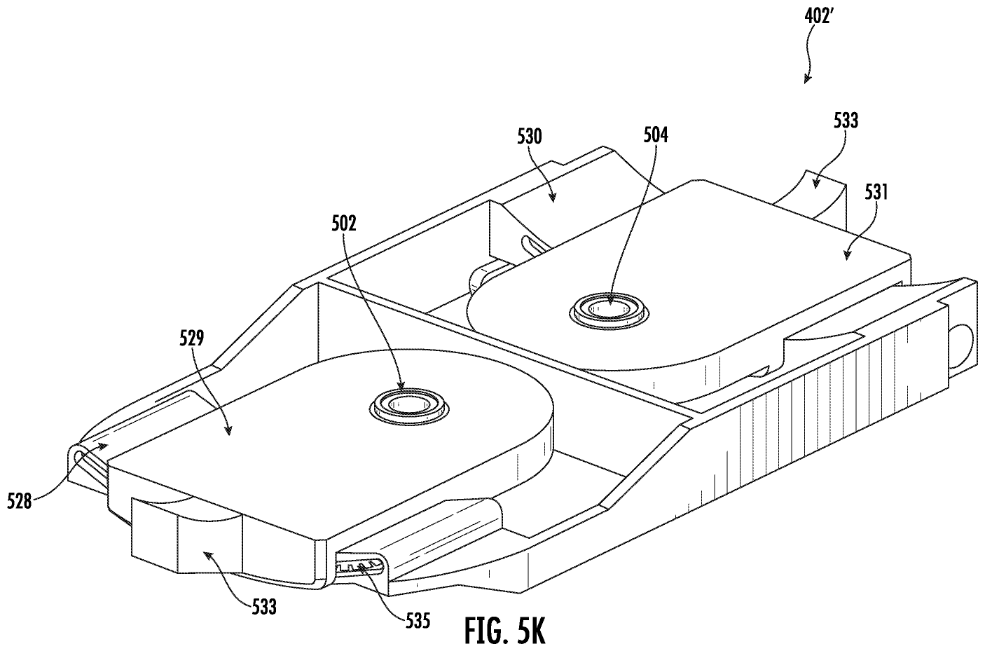

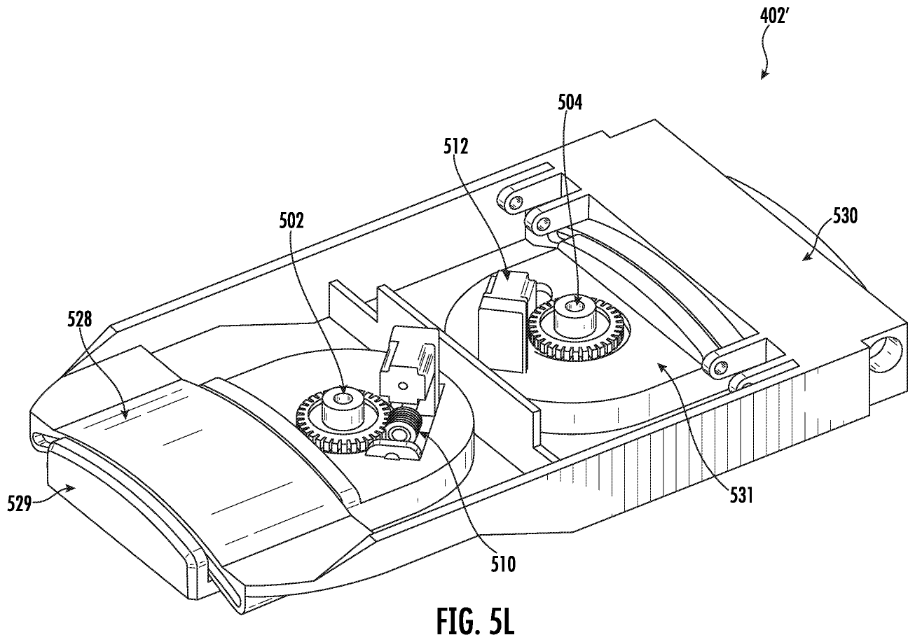

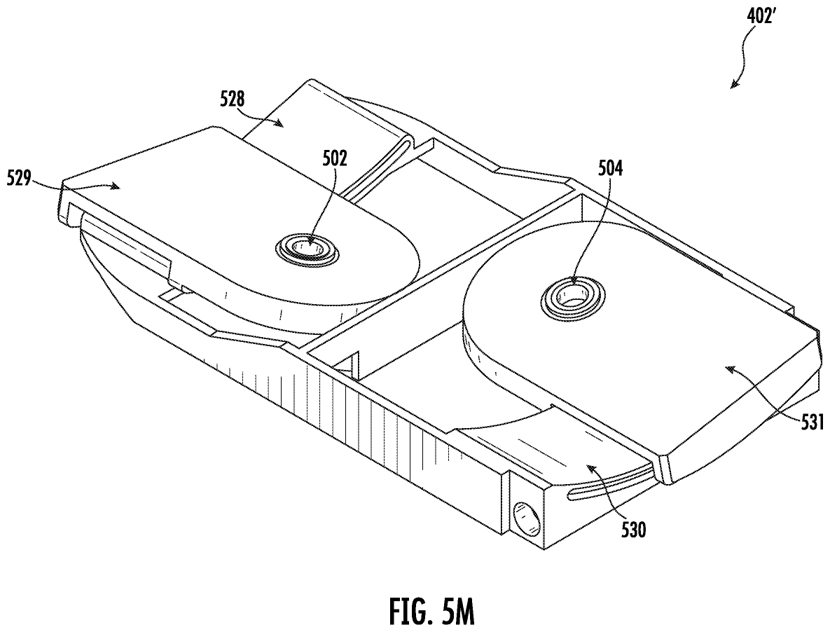

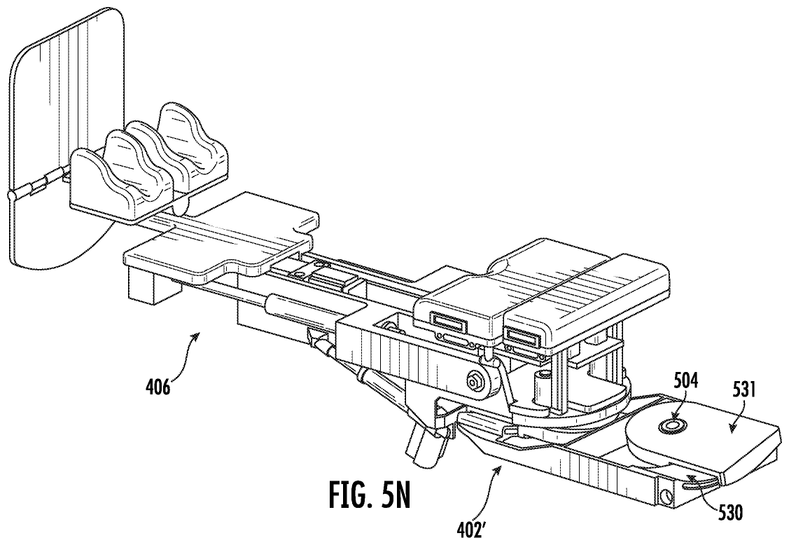

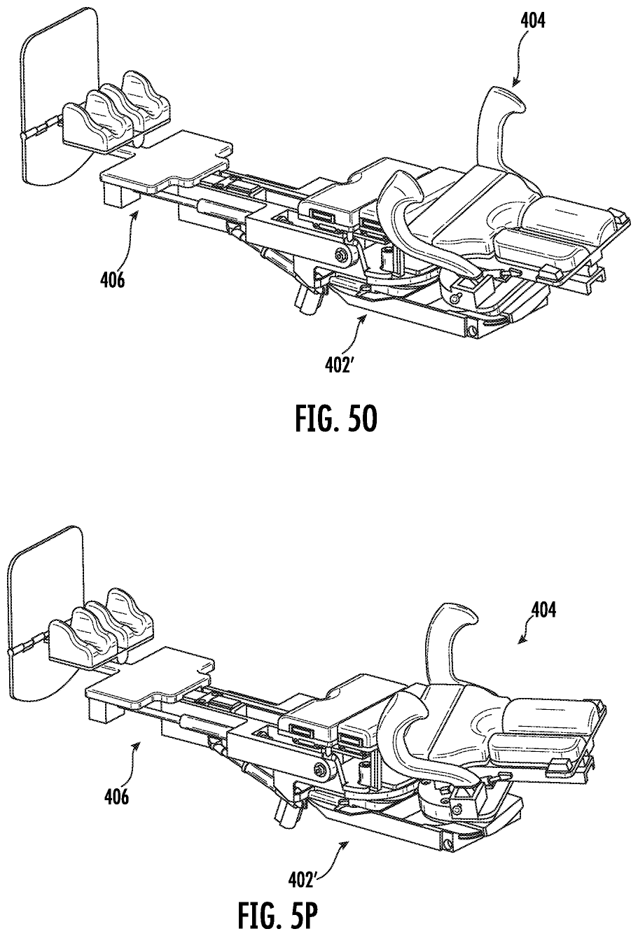

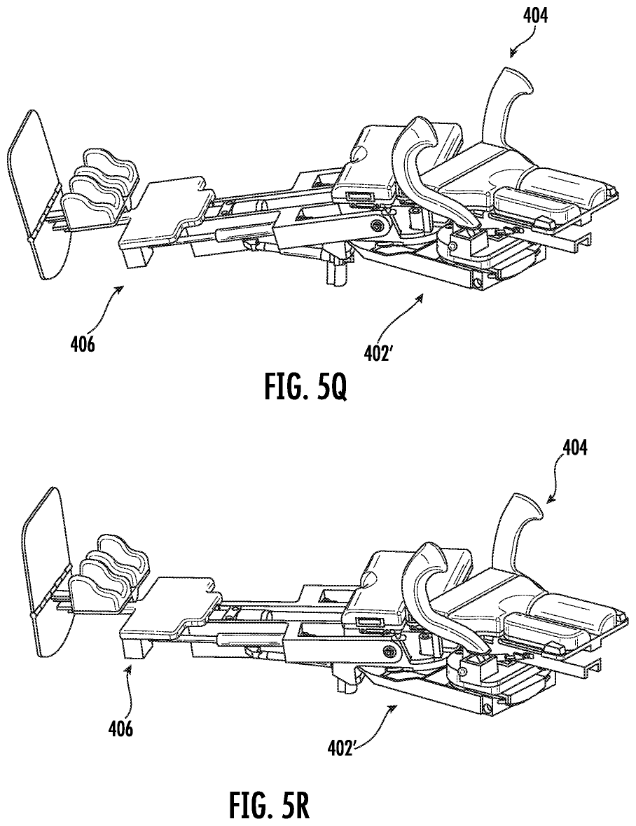

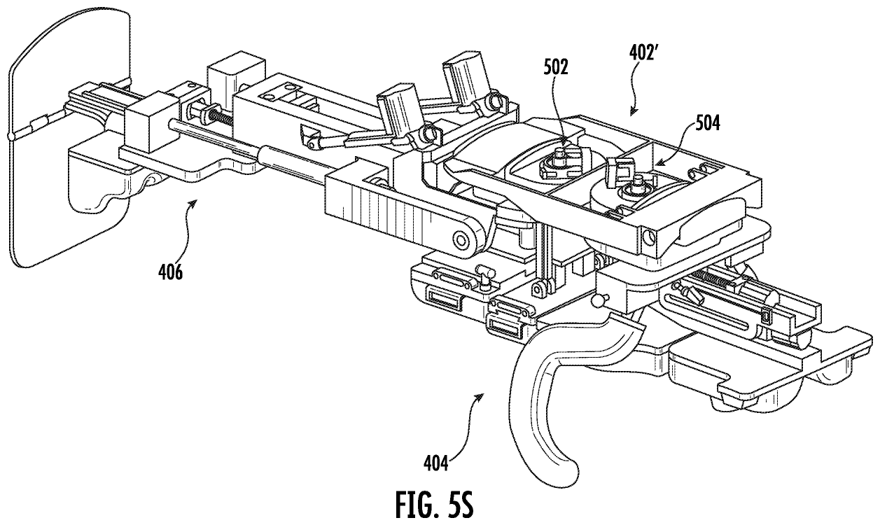

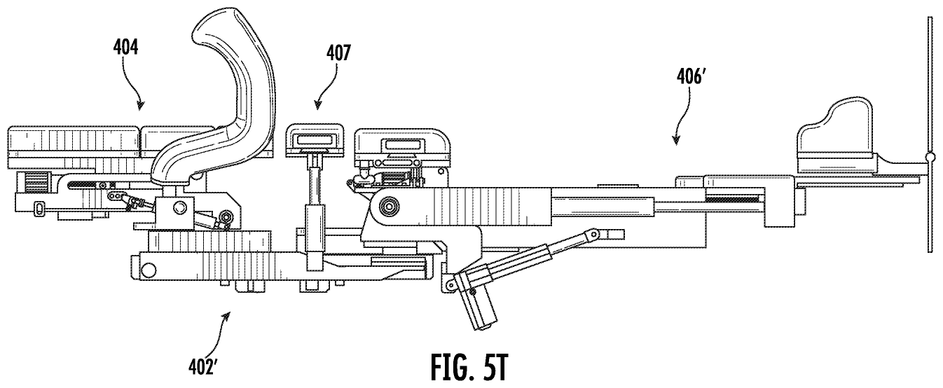

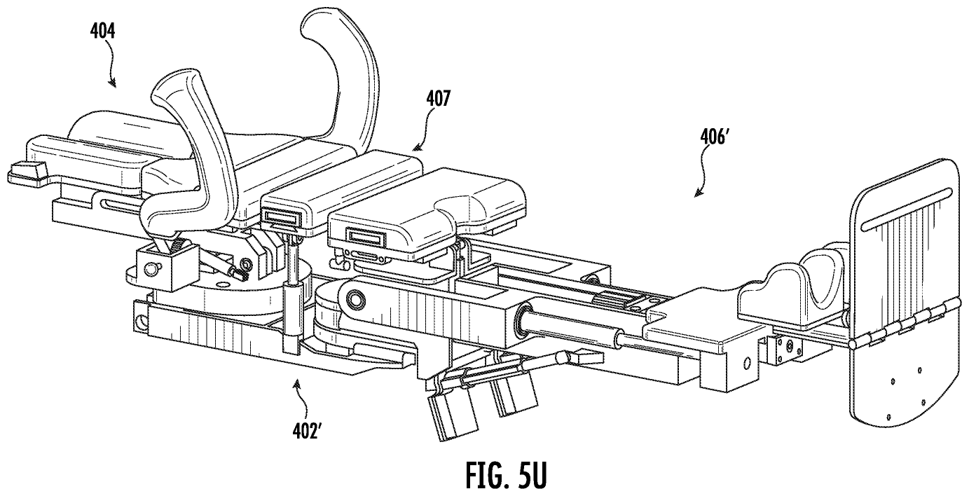

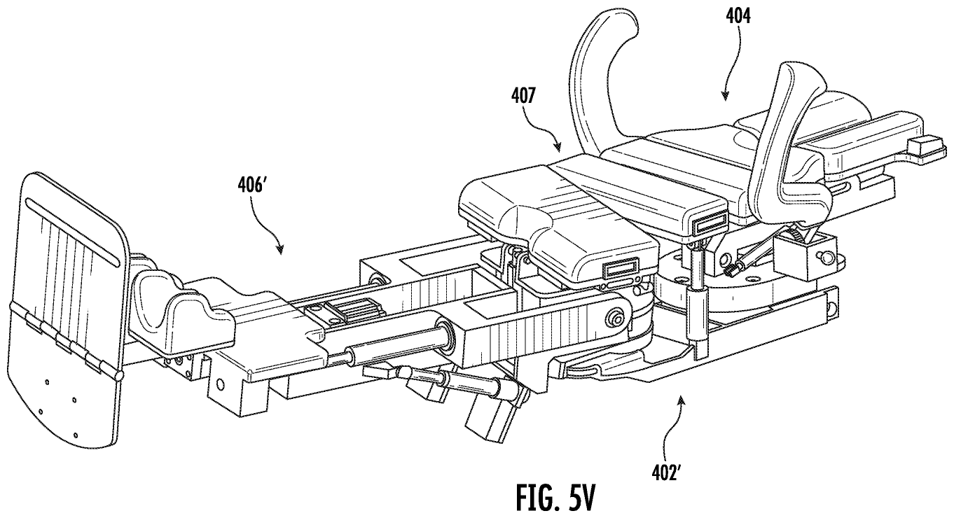

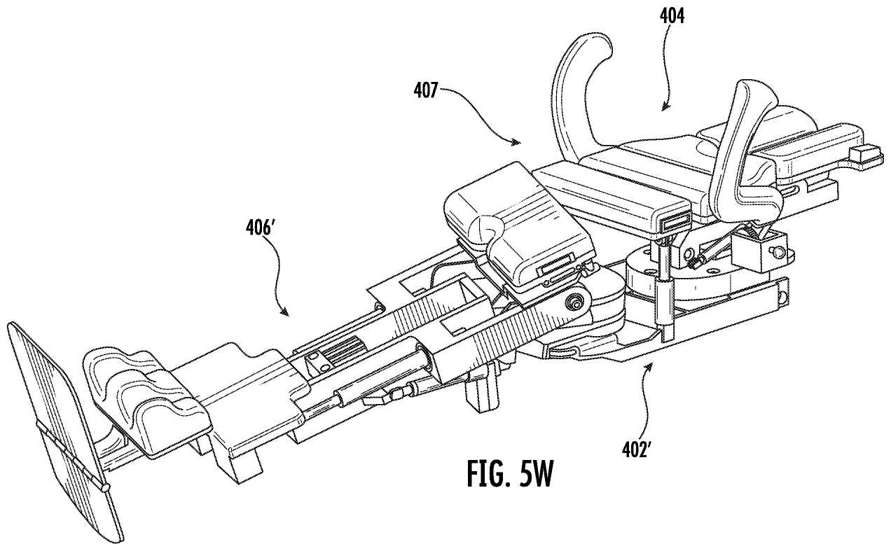

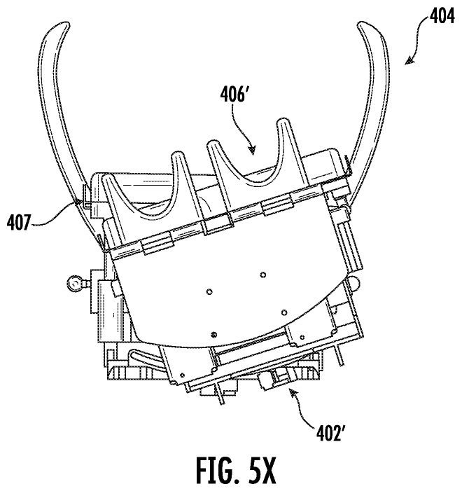

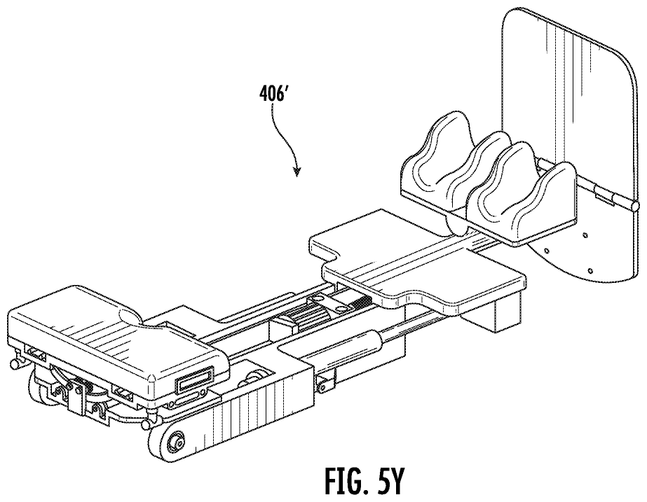

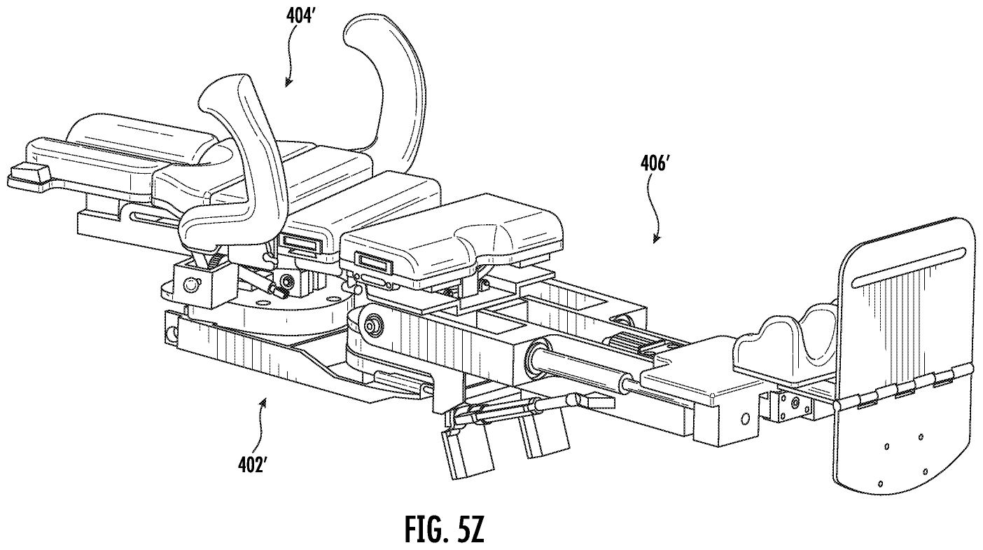

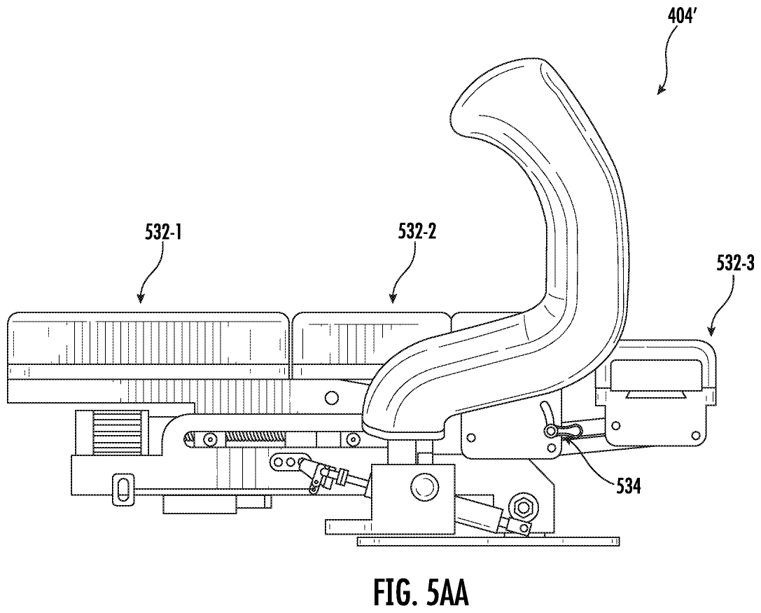

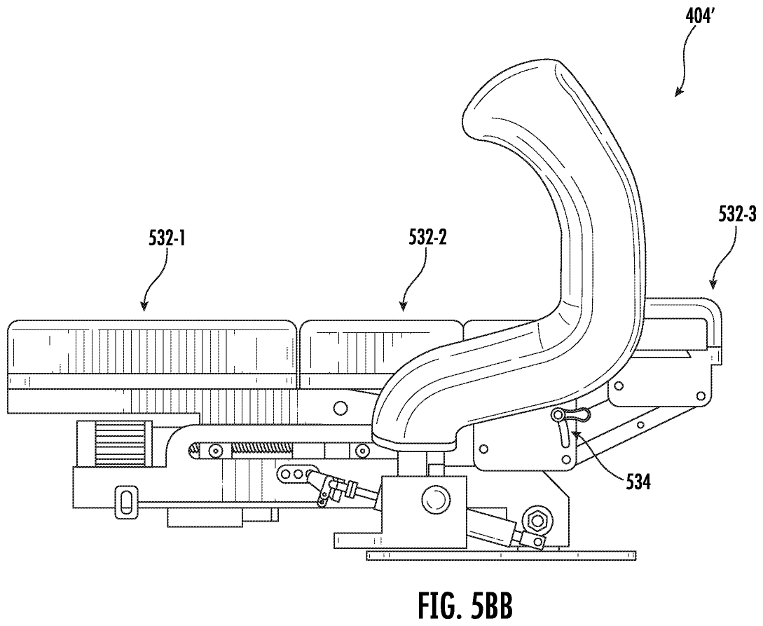

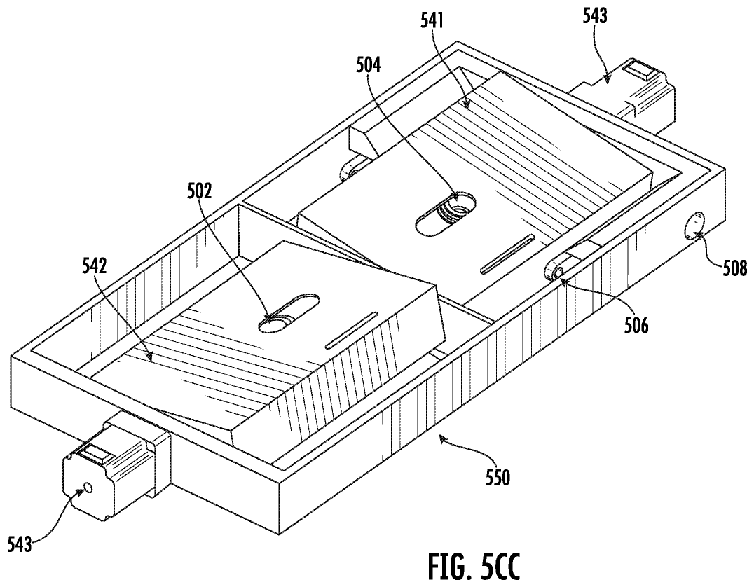

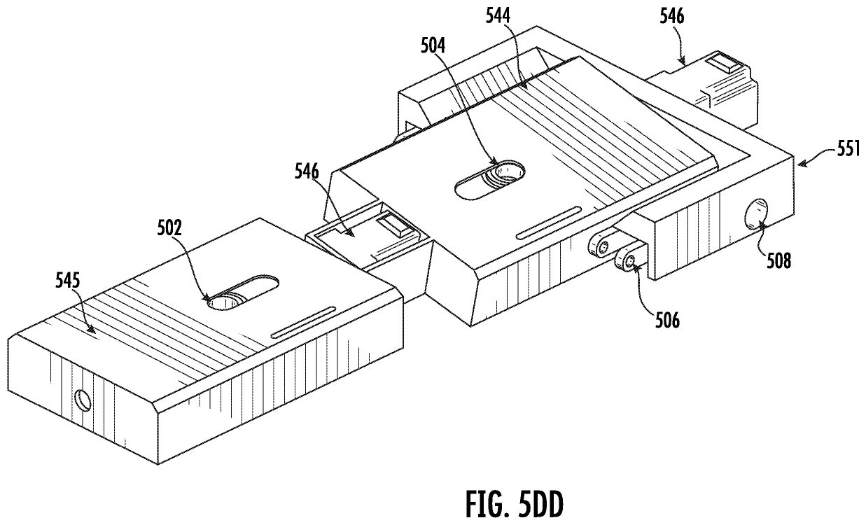

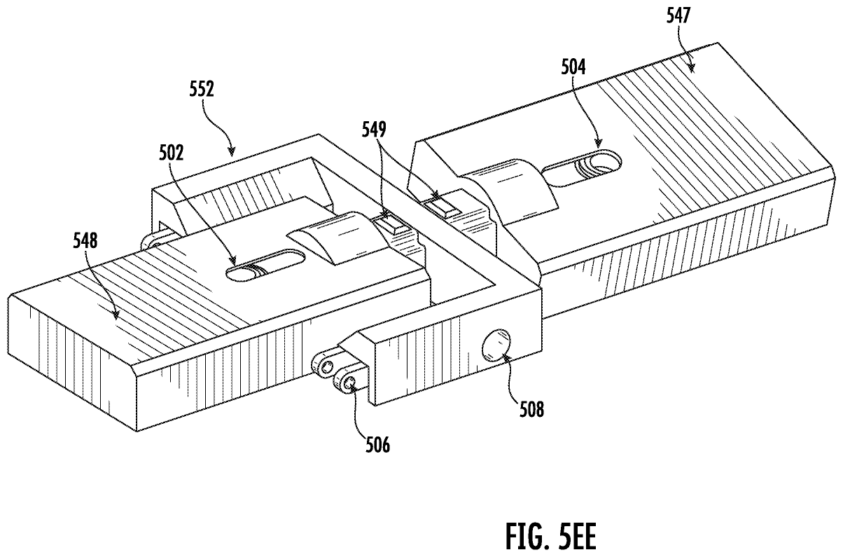

FIGS. 5A-5EE illustrate details of the table support and pivot subassembly 402. As shown in FIG. 5A, the table support and pivot subassembly 402 is coupled to the thoracic subassembly 404 via the pivot point 502, and is coupled to the lumbar, pelvis and leg subassembly 406 via the pivot point 504. Such an arrangement provides various advantages relative to conventional approaches, including conventional decompression systems. Such advantages include but are not limited to enabling therapies for increased muscle function and strength that may achieved by positioning the patient by rotating prior to decompression, using traction along the Y-axis, achieving placement of the spine of the patient in a pain-free or reduced pain position, etc. These and other benefits may be achieved, in part, through rotation of the thoracic subassembly 404 via the pivot point 502, and rotation of the lumbar, pelvis and leg subassembly 406 via the pivot point 504.

The table support and pivot subassembly 402 is coupled to the base section 201 via a tilt actuator connection 506 and a pivot point 508. It should be noted that in the embodiments shown in, for example, FIGS. 5A and 5C, the tilt actuator connection 506 and pivot point 508 are located at an end of the table support and pivot subassembly 402 proximate the pivot point 504 which attaches to the lumbar, pelvis and leg subassembly 406. In other embodiments, however, the tilt actuator connection 506 and pivot point 508 may be located at the opposite end of the table support pivot subassembly 402 proximate pivot point 502 that attaches to the thoracic subassembly 404. In still other embodiments, the tilt actuator connection 506 and pivot point 508 may be located at any desired position between the pivot points 502 and 504 (e.g., such as centered between the pivot points 502 and 504), rather than at one end of the table support and pivot subassembly 402. It should be further appreciated that, in some embodiments, the attachment of the thoracic subassembly and the lumbar, pelvis and leg subassembly to the pivot points of a table support and pivot subassembly may be reversed. FIG. 5N, for example, illustrates the lumbar, pelvis and leg subassembly 406 attached to the pivot point 502 of the table support and pivot subassembly 402′, rather than the pivot point 504. The choice of which subassemblies attached to which pivot points of a table support and pivot subassembly, as well as the choice of location for the tilt actuator connection 506 and pivot point 508, may be design considerations. In some cases, it may be desired to make the subassembly attachments modular, such that any desired subassembly may attach to any pivot point of a table support and pivot subassembly. This also permits the interchanging of different types of subassemblies to a table support and pivot subassembly (e.g., interchanging different configurations of subassemblies providing any combination of thoracic, lumbar, pelvis and leg supports).

As shown in FIG. 5B, the table support and pivot subassembly 402 includes a thoracic subassembly pivot actuator 510 and a lumbar, pelvis and leg subassembly pivot actuator 512. The pivoting functions of the thoracic subassembly 404 and the lumbar, pelvis and leg subassembly 406 are provided via the actuators 510 and 512, respectively. The actuators 510 and 512 may be electronically or hydraulically actuated. As shown in FIG. 5B, the actuators 510 and 512 include respective rotary electronic actuators and worm gears. In other embodiments, however, one or both of the actuators 510 and 512 may comprise a linear actuator, a hydraulic cylinder and lever arm, a rotary actuator, etc. FIG. 5C shows a perspective view of the table support and pivot subassembly 402, including the pivot points 502 and 504, tilt actuator connection 506 and pivot point 508. FIG. 5C further illustrates release levers 503 and 505 which may be used to engage or release the pivot points 502 and 504 so they can be translated along the Y-axis. The embodiment shown in FIGS. 5A and 5B may represent a particularly low-cost approach for implementing the table support and pivot subassembly 402. The embodiment of FIGS. 5A and 5B, however, is limited in that the pivot points 502 and 504 are fixed relative to one another along the Y-axis. The ability to adjust the pivot points 502 and 504 relative to one another as shown in other embodiments (e.g., including the embodiments shown in FIGS. 5C-5J) advantageously provides the ability for the practitioner to adjust the pivot points 502 and 504 along the Y-axis to select a desired spacing along the spine of the patient to achieve different positioning and movements of the user (e.g., such as lateral flexion in two places).

FIG. 5D shows a perspective view of the table support and pivot subassembly 402, including the pivot points 502 and 504 and associated actuators 510 and 512 and levers 503 and 505. In the FIG. 5D embodiment, the pivot points 502 and 504 slide along the Y-axis with dovetail slides 514 to achieve desired pivot point locations for a particular treatment (e.g., to accommodate differing patient height, different physical conditions, etc.). The release levers 503 and 505 may be used to manually lock the position of the pivot points 502 and 504 along the dovetail slides 514. FIG. 5E shows a detailed view of the dovetail slides 514 of FIG. 5D.

FIG. 5F shows another perspective view of the table support and pivot subassembly 402, including the pivot points 502 and 504 and associated actuators 510 and 512 and levers 503 and 505. In the FIG. 5F embodiment, the pivot points 502 and 504 slide along the Y-axis on rounded shafts 516 to achieve desired pivot point locations for a particular treatment (e.g., to accommodate differing patient height, different physical conditions, etc.). The release levers 503 and 505 may be used to manually lock the position of the pivot points 502 and 504 along the rounded shafts 516. FIG. 5G shows a detailed view of the rounded shafts 516 of FIG. 5F, as well as linear bearing slides 518.

FIG. 5H shows another perspective view of the table support and pivot subassembly 402, including the pivot points 502 and 504 and associated actuators 510 and 512. In the FIG. 5H embodiment, the pivot points 502 and 504 slide along the Y-axis on V-groove rails 520 and V-groove rollers 522 to achieve desired pivot point locations for a particular treatment (e.g., to accommodate differing patient height, different physical conditions, etc.). The release levers 503 and 505 (not shown in FIG. 5H) may be used to manually lock the position of the pivot points 502 and 504 along the V-groove rails 520. FIG. 5I shows a detailed view of the V-groove rails 520, V-groove rollers 522, as well as the locking handle 503/505.

It should be noted that the different embodiments shown in FIGS. 5C-5I represent various possible solutions that enable, among other features, the ability to adjust the relative location of the pivot points 502 and 504 along the Y-axis. The choice of which solution or embodiment to use may be based on various factors, including but not limited to the ease of and cost of manufacturing.

FIG. 5J shows another perspective view of the table support and pivot subassembly 402, including the pivot points 502 and 504 and associated actuators 510 and 512. In the FIG. 5J embodiment, the pivot points 502 and 504 slide along the Y-axis on V-groove rails 520 (and V-groove rollers 522) similar to the embodiment shown in FIGS. 5H and 5I The FIG. 5J embodiment, however, utilizes linear actuators 524 and 526 to position the pivot points 502 and 504 to desired positions on the Y-axis, rather than via manual release and locking using levers 503 and 505. It should be appreciated that while FIG. 5J illustrates the use of linear actuators 524 and 526 for positioning the pivot points 502 and 504 along the Y-axis with the use V-groove rails 520 and rollers 522 as in the embodiment of FIGS. 5H and 5I, linear actuators may also be used with the rounded shafts 516 and linear bearing slides 518 as in the embodiment of FIGS. 5F and 5G, with the dovetail-shaped slides 514 as in the embodiment of FIGS. 5D and 5E, etc., or any other type of linear slide. The solution illustrated in FIG. 5I, similar to the solutions of FIGS. 5C-5I, enable adjustment of the relative positions of the pivot points 502 and 504 along the Y-axis. The FIG. 5I solution may be more complex to implement, but advantageously provides ease of positioning of the pivot points 502 and 504 thus enabling quicker setup and positioning of the patient by a practitioner.

FIGS. 5K-5S illustrate another embodiment of a table support and pivot subassembly, denoted as table support and pivot subassembly 402′, in which the pivot points 502 and 504 (configured for attachment to the lumbar, pelvis and leg subassembly 406 and thoracic subassembly 404, respectively) have Y-axis rotation enabled through rounded tracks 528 and 530 on which plates 529 and 531 supporting the pivot points 502 and 504 slide. The center of rotation is configured to be in approximate alignment with the Y-axis or patient's spine, or another axis that is desirable for treatment. In some cases, padding may be used to account for variation in patient and/or user anthropomorphic size. This may be achieved through the use of modular support pads as described elsewhere herein (e.g., replacing the size and/or shape of pads and bolsters in a modular support pad assembly).

FIG. 5K shows a perspective view where the plates 529 and 531 centered on the rounded tracks 528 and 530. Optional rotary actuators 533 can be used to provide powered rotation about the Y-axis by engaging a pinion with a sector gear 535. The FIG. 5K embodiment may provide various clinical advantages. For example, the FIG. 5K embodiment can be used to produce simultaneous independent rotation of thoracic subassembly 404 and the lumbar, pelvis and leg subassembly 406 along the Z-axis, while enabling the leg and foot pad portions of the lumbar, pelvis and leg subassembly 406 to move as one unit during pelvis rotation along the Y-axis, which provides easier practitioner control of patient positioning in rotation along the Y-axis with the legs and feet as compared to the embodiment shown in FIG. 4E. Thus, the FIG. 5K embodiment advantageously provides automatic movement in the same rotational direction eliminating the need for separate foot release efforts.

FIG. 5L shows a bottom perspective view, again where the plates 529 and 531 are centered on the rounded tracks 528 and 530. FIG. 5L further illustrates the actuators 510 and 512 for the pivot points 502 and 504. FIG. 5M shows another perspective view where the plates 529 and 531 are slid along the tracks 528 and 530 in opposite directions. The sliding of the plates 529 and 531 along the tracks 528 and 530 enables various types of movement of the associated lumbar, pelvis and leg subassembly 406 and the thoracic subassembly 404. It should be appreciated that the pivot points 502 and 504 shown in the embodiments of FIGS. 5K-5M can be configured to translate long the Y-axis, such as using solutions similar to those described above in conjunction with FIGS. 5C-5J.

FIG. 5N shows the table support and pivot subassembly 402′ with the pivot point 502 attached to the lumbar, pelvis and leg subassembly 406. FIGS. 5O and 5P further show the table support and pivot subassembly 402′ with the pivot point 504 attached to the thoracic subassembly 404, and with rotation of the thoracic subassembly 404 utilizing pivot point 504 and associated plate 531 sliding along rounded track 530. FIGS. 5Q and 5R illustrate rotation of the lumbar, pelvis and leg subassembly 406 utilizing the pivot point 502 and associated plate 529 sliding along rounded track 528. FIG. 5Q shows lumbar, pelvis and leg subassembly 406 with the pelvis pad tilted about the X-axis relative to the leg portion thereof. FIG. 5S shows a bottom perspective view of the table support and pivot subassembly 402′ attached to the lumbar, pelvis and leg subassembly 406 and thoracic subassembly 404 via pivot points 502 and 504.

FIGS. 5T-5Y show an embodiment wherein a pelvis and leg subassembly 406′ and a lumbar subassembly 407 are separately coupled to the table support and pivot subassembly 402′. This is in contrast with FIGS. 5N-5S, wherein the lumbar section is coupled with the pelvis and leg sections in a same lumbar, pelvis and leg subassembly 406. FIG. 5T shows a side view, illustrating the separate attachment of the pelvis and leg subassembly 406′ and the lumbar subassembly 407 to the table support and pivot subassembly 402′. It should be noted that while FIGS. 5T-5X show the separate pelvis and leg subassembly 406′ and lumbar subassembly 407 being coupled to the table support and pivot subassembly 402′ of FIGS. 5K-5S, such separate attachment of a pelvis and leg subassembly 406′ and lumbar subassembly 407 may also be used for coupling to the table support and pivot subassembly 402 described elsewhere herein. FIGS. 5T and 5U show side and perspective views of the table support and pivot subassembly 402′ coupled to the thoracic subassembly 404, the lumbar subassembly 407 and the pelvis and leg subassembly 406′.

FIG. 5U shows the thoracic subassembly 404 when mounted to the pivot point 502 of plate 531, which advantageously provides for easier practitioner control of patient positioning in 3D rotation about the X-axis, Y-axis, and Z-axis with thoracic section moving in the rotational directions producing manipulations of the upper section of the body not obtainable using conventional approaches. FIGS. 5V and 5W show perspective views wherein the pelvis and leg subassembly 406′ is rotated about pivot point 502 (e.g., via the associated plate 529 sliding along rounded track 528). FIG. 5X shows a view looking up the Y-axis wherein the pelvis and leg subassembly 406′ is rotated about pivot point 502 (e.g., via the associated plate 529 sliding along rounded track 528) with part of the foot plate 1004 removed for clarity. FIG. 5Y shows a perspective view of the pelvis and leg subassembly 406′ separate from the table support and pivot subassembly 402′. The pelvis and leg subassembly 406′ shown in FIG. 5Y, when mounted to the pivot point 502 of plate 529, provides for easier practitioner control of patient positioning in 3D rotation about the X-axis, Y-axis, and Z-axis with the pelvis, leg, and feet moving in the same rotational direction producing manipulations not obtainable using conventional approaches. Rotation of the pelvis and leg of a patient may be vital for certain desired use cases, including: C-arm imaging purposes; 3D spine mimicking initial treatment parameter setup; pain management intervention for improved accessibility of injection site; spinal mobilization stretching benefits such as increased muscle function and strength; positioning prior to and during active decompression; traction along the Y-axis; placement of the spine of a user into a pain-free or reduced pain position; etc.

FIGS. 5Z-5BB show an embodiment wherein the lumbar subassembly is part of the thoracic subassembly, rather than being distinct from both the thoracic subassembly 404 and pelvis and leg subassembly 406′ as in FIGS. 5T-5Y. FIG. 5Z shows a combined thoracic and lumbar subassembly 404′ and a pelvis and leg subassembly 406′ that are coupled to the table support and pivot subassembly 402′. It should be noted that while FIG. 5Z shows the separate thoracic and lumbar subassembly 404′ and pelvis and leg subassembly 406′ being coupled to the table support and pivot subassembly 402′ of FIGS. 5K-5S, such separate attachment of a thoracic and lumbar subassembly 404′ and pelvis and leg subassembly 406′ may also be used for coupling to the table support and pivot subassembly 402 described elsewhere herein. FIGS. 5AA and 5BB illustrate head support pad 532-1, thoracic support pad 532-2 and lumbar support pad 532-3 of the combined thoracic and lumbar subassembly 404′. FIGS. 5AA and 5BB also illustrate how the lumbar support pad 532-3 may be raised or lowered by sliding arms, linkage, a four-bar mechanism, etc. along a track 534. FIG. 5AA shows the lumbar support pad 532-3 in a lowered position, while FIG. 5BB shows the lumbar support pad 532-3 in a raised position. The raising and lowering of the lumbar support pad 532-3 may be achieved manually, through a powered actuator, etc.

FIGS. 5CC-5EE show alternate embodiments of the table support and pivot assembly 402. Similar to the embodiment of FIG. 5K, the embodiments of FIGS. 5CC-5EE enable Y-axis rotation. In the embodiments of FIGS. 5CC-5EE, the Y-axis rotation is enabled through rotational actuators. FIG. 5CC shows a support frame 550, with tilt actuator connection 506 and pivot point 508. The perspective view of FIG. 5CC shows plates 541 and 542 configured to rotate about the Y-axis using rotational actuators 543. The plates 541 and 542 are coupled to the thoracic subassembly 404 via the pivot point 502 and the lumbar, pelvis and leg subassembly 406 via the pivot point 504.

FIG. 5DD shows a support frame 551 with tilt actuator connection 506 and pivot point 508. The perspective view of FIG. 5DD shows plates 544 and 545 configured to rotate about the Y-axis using rotational actuators 546. The plates 544 and 545 are coupled to the thoracic subassembly 404 via pivot point 502 and to the lumbar, pelvis and leg subassembly 406 via pivot point 504. In the FIG. 5DD embodiment, the plate 545 is counter rotated relative to plate 544 in order to remain in position as plate 544 is rotated.

FIG. 5EE shows a support frame 552 with tilt actuator connection 506 and pivot point 508. The perspective view of FIG. 5EE show plates 547 and 548 configured to rotate about the Y-axis using rotational actuators 549. The plates 547 and 548 are coupled to the thoracic subassembly 406 via pivot point 502 and to the lumbar, pelvis and leg subassembly 406 via pivot point 504.

The pivot about the Y-axis enabled in various embodiments (e.g., including the embodiments of FIGS. 5K and 5CC-5EE) provides various clinical advantages relative to conventional manual manipulation procedures. Separate motions including rotational re positioning of the lumbar spine and pelvis/hips relative to each other provides the basis for many manipulation and mobilization procedures in physical medicine. As an example, manually positioning a patient on a flat bench treatment table allows for rotation of the lumbar spine in the clockwise direction as patients are placed in a side position. Tension may then be applied to the lumbar spine and pelvis manually as a therapist rotates the upper body and spine in one rotation direction (e.g., clockwise) as the pelvis is rotated in the opposite rotation direction (e.g., counterclockwise). When adequate tension or force is applied, the musculature and vertebral interlocking facet joints are brought to the rotational limit in the normal joint range of motion-cavitation, and spinal adjustment occurs thereby increasing range of motion and decreasing pain. The action of counter rotation of pelvic and lumbar sections individually reproduces the clinical effects of hands-on manual therapeutic adjustment and associated mobilization benefits (e.g., increased tension on vertebral facet joints and other structures and components of the spine such as paraspinal muscles and discs, increased range of motion, lengthening muscles and producing non-contact spinal mobilization, etc.). The benefits of chiropractic and osteopathic lumbar/pelvic mobilization hands-on techniques are superseded by the functionality of Y-axis pivoting (e.g., such as that described in conjunction with FIGS. 5K and 5CC-5EE). Thus, direct patient contact may be reduced or eliminated, while also reducing or eliminating hard manual manipulation thrusting. Additionally, rotation of the pelvis and spine along the Y-axis is important to increase flexibility of rotation of the spine to normal limits, to lengthen muscles, to improve strength, etc.

Rotation of the pelvis and spine along the Y-axis is also important for C-arm structure ease of use in obtaining correct positioning of the spine and pelvis, imaging of facet joints, vertebral spinal foramina during imaging and easier accessibility of pain management injection-locations, etc. Such rotation of the pelvis and spine may also be used for mimicking or establishing baseline spinal postures pre-treatment, which is part of a 3D scanning baseline positioning system. Coordinates derived from a 3D scanner or other imaging device (e.g., X-ray ultrasound) may be inputted as part of patient profile parameters (e.g., in this case, degree of rotation of the pelvis and spine), and then the treatment table moves selected table actuators (e.g., lumbar rotational axis, etc.) to mimic or reproduce the degree of rotational deviance through reconfiguration of the treatment or diagnostic table. Per the various control features, and applicable to any and all movable sections of the treatment table, structural treatment of spinal deviations begins in uniquely controlled increments either manually controlled or fully automated, (e.g., 20 deg scoliosis of the lumbar spine with rotation of the lumbar vertebrae of 15 deg along the Y-axis), and subject placement and positioning on the table is incrementally altered as determined by a clinician or other practitioner as part of treatment process in combination with movement and decompression traction.

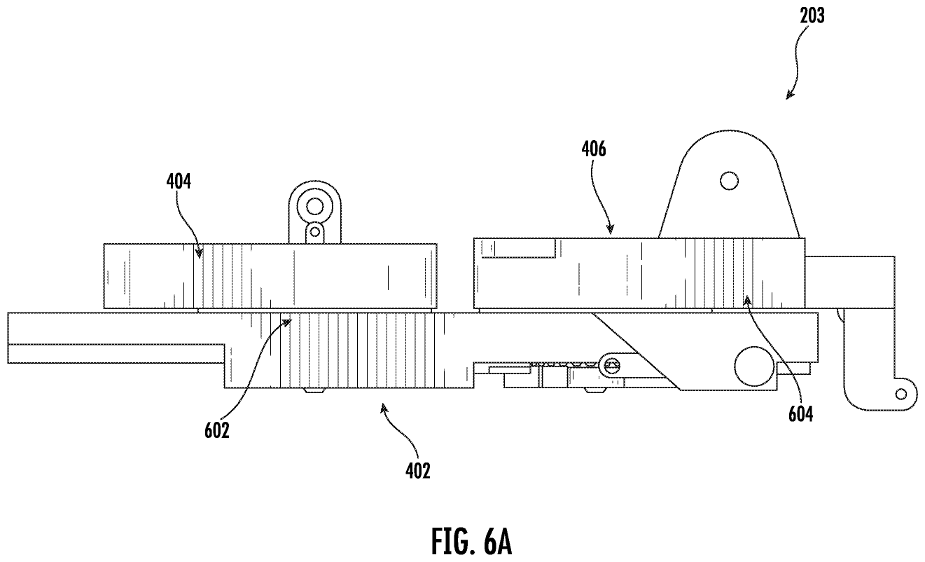

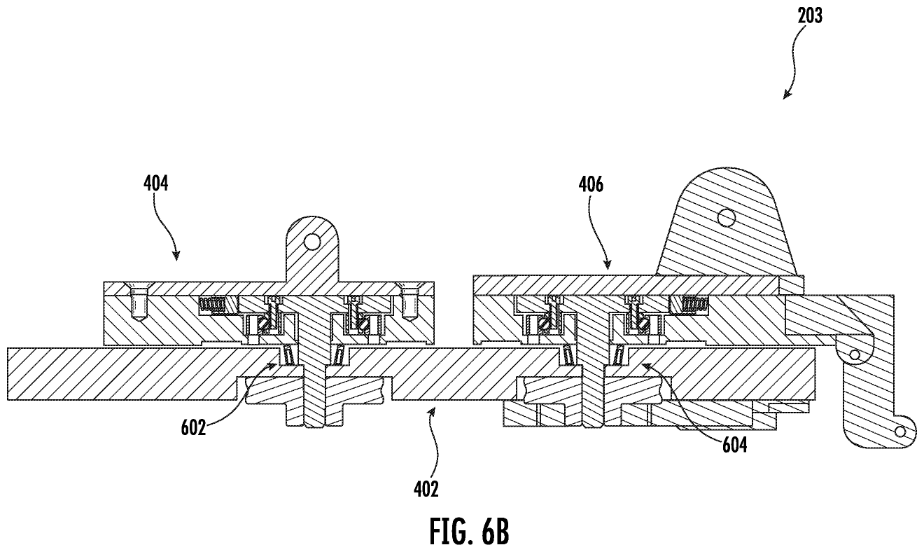

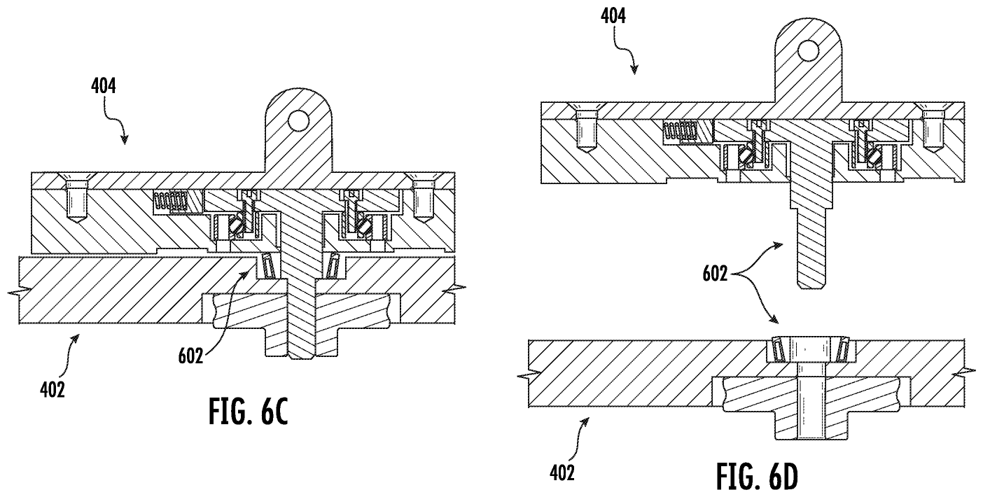

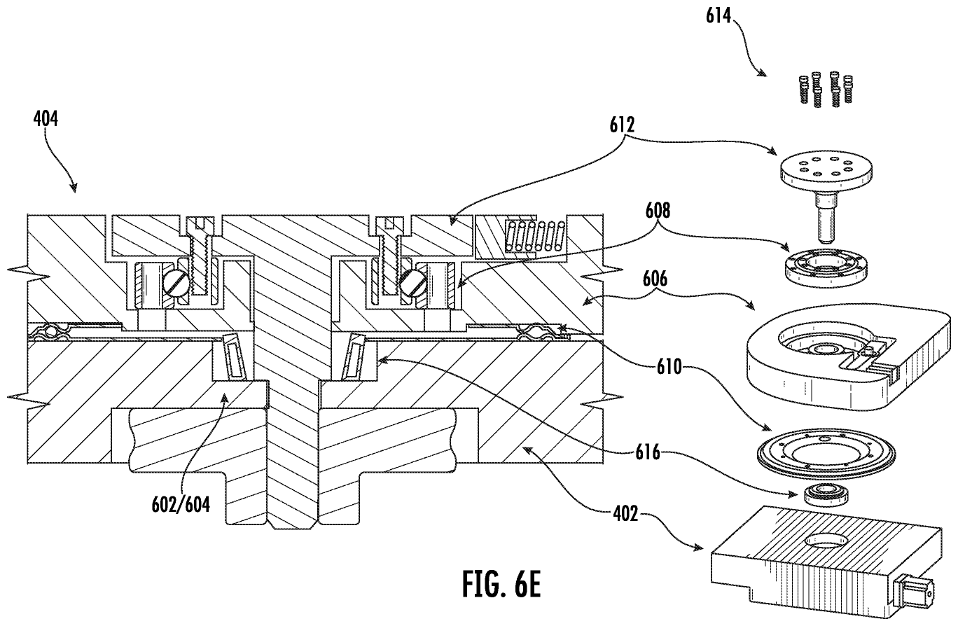

FIGS. 6A-6E shows aspects of interfaces between the table support and pivot subassembly 402, the thoracic subassembly 404, and the lumbar, pelvis and leg subassembly 406. Each of the thoracic subassembly 404 and the lumbar, pelvis and leg subassembly 406 may be removed from the table support and pivot subassembly 402 for ease of manufacturability, maintenance and upgradability, and also for ease of movement of the treatment table 200. FIG. 6A shows the table support and pivot subassembly 402, the thoracic subassembly 404, and the lumbar, pelvis and leg subassembly 406, along with a thoracic subassembly pivot control section 602 and a lumbar, pelvis and leg subassembly pivot control section 604. FIG. 6B shows a cross-sectional view illustrating the interfaces between the table support and pivot subassembly 402, the thoracic subassembly 404, and the lumbar, pelvis and leg subassembly 406, and details of the thoracic subassembly pivot control section 602 and the lumbar, pelvis and leg subassembly pivot control section 604. FIG. 6C shows a detailed view of the thoracic subassembly pivot control section 602, and FIG. 6D shows a detailed view of the thoracic subassembly pivot control section 602 when the table support and pivot subassembly 402 and thoracic subassembly 404 are separated from one another.

FIG. 6E shows a detailed cross-sectional view of a pivot control section, which may be either the thoracic subassembly pivot control section 602 or the lumbar, pelvis and leg subassembly pivot control section 604. A pivoting plate 606 is sandwiched between an upper turntable 608 and a lower turntable 610 to support the moment forces. The upper turntable 608 restrains the pivoting plate onto the rotation axis. A gear-like wheel on a shaft 612 is secured to the upper turntable 608 via fasteners 614. A bearing 616 is provided between the lower turntable 610 and the table support and pivot subassembly 402.

The embodiments of FIGS. 6A and 6B enable the table support and pivot subassembly 402, as one unit, to allow independent rotation of the thoracic and lumbar assemblies along the Z-axis. In comparison, the embodiments of, for example, FIGS. 5K and 5CC-5EE enable simultaneous independent rotation of the thoracic and lumbar pelvic subassemblies along the Z-axis, while enabling the leg and foot pad subassemblies to move as one unit during lumbar pelvic subassembly rotation along the Y-axis as illustrated in FIG. 5W. In the embodiment of FIG. 5EE, the leg and pelvis subassembly moves together. Such embodiments enable easier practitioner control of patient positioning in rotation along the Y-axis, with legs and feet automatically moving in the same rotational direction eliminating separate foot release efforts. Part of a 3D spine positioning system is to mimic structural distortion described in 3D scanning as input to an initial table platform cushion configuration, as well as subsequent changes to such parameters as treatment and spinal correction occurs in a specific and controlled manner. This is applicable to all motions of treatment tables described herein. All table motions may be important for placement of a patient during C-arm imaging of the spine and pain management considerations. In some embodiments, the pelvic cushion provides the primary function of spinal rotation, with the leg and foot assembly remaining in a current, non-rotated plane.

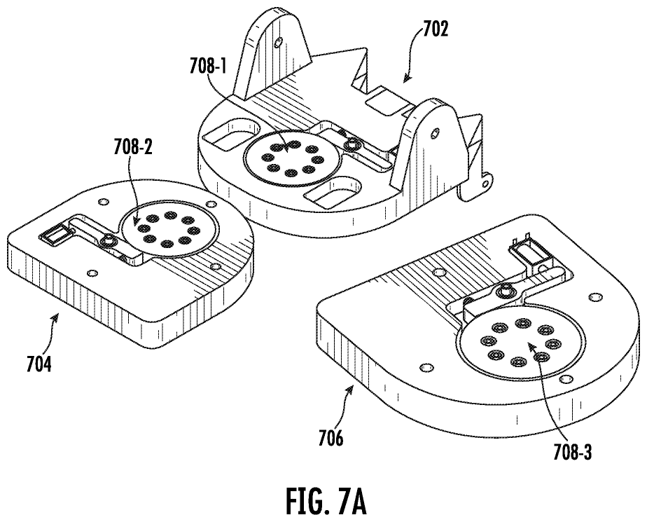

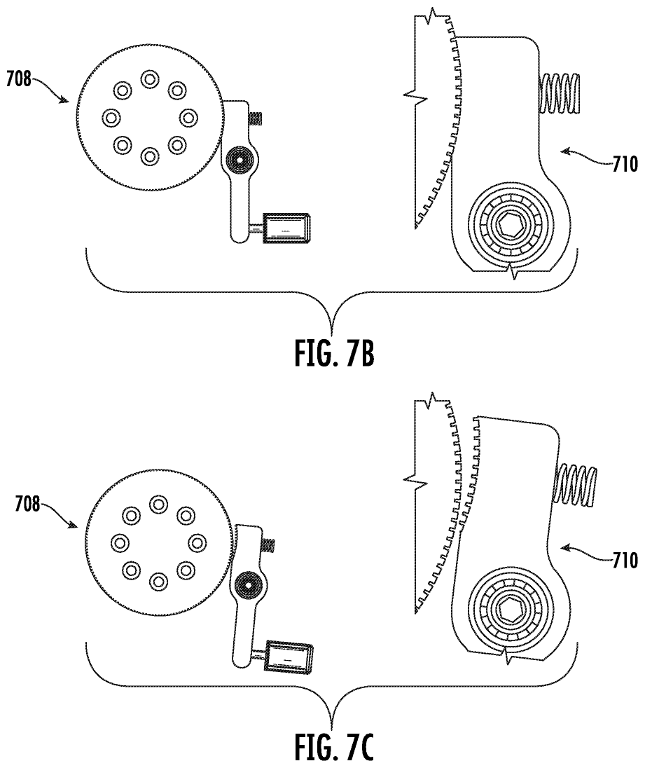

FIGS. 7A-7C show two separate and distinct pivot control sections for the table support and pivot subassembly 402, the thoracic subassembly 404 and the lumbar, pelvis and leg subassembly 406. More particularly, FIG. 7A shows rotation subassemblies 702, 704 and 706 with covers removed illustrating respective control mechanisms 708-1, 708-2 and 708-3 (collectively, control mechanisms 708). Each of the control mechanisms 708 provides an override that allows the practitioner to reposition both the thoracic subassembly 404 pivot position and the lumbar, pelvis and leg subassembly 406 pivot position. In other embodiments, the override may not be included. As illustrated in FIGS. 7B and 7C, each of the control mechanisms 708 may comprise a solenoid actuated lever that meshes into a gear-like wheel. The gear-like wheel can be a full circle as shown in FIGS. 7A-7C, or may be a sector thereof. Additionally, the meshing (e.g., of gears) may be replaced with a friction element in some embodiments. In some embodiments, the friction element can be partially released to have some amount of resistance to movement, which gives some force feedback to the practitioner for improved treatment. The solenoid lever can also be replaced by a hand lever in some embodiments. A hand lever may also be used as an override for the solenoid in some embodiments. The hand lever can also be replaced by a translational mechanism along a radial line from the wheel. FIG. 7B shows the lever 710 that can be actuated to achieve rotation override, and FIG. 7C shows the lever 710 in the actuated position to achieve rotation override. In some embodiments, sensors are provided to sense the rotational position of the control mechanisms 708, so that a control interface of the treatment table is aware of the override position and can return the control mechanisms 708 to normal positions upon command.

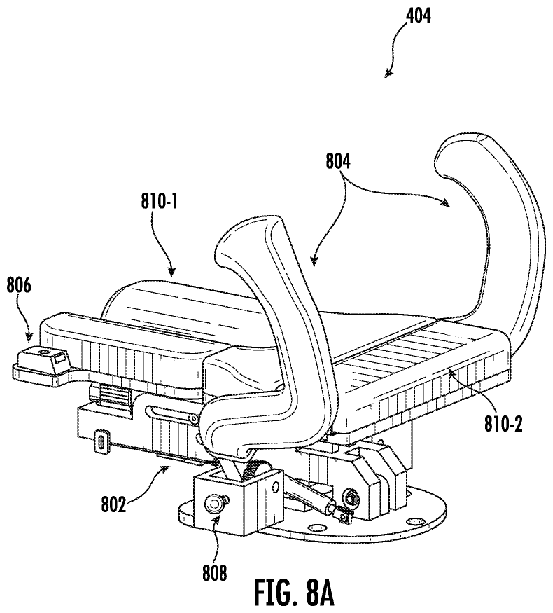

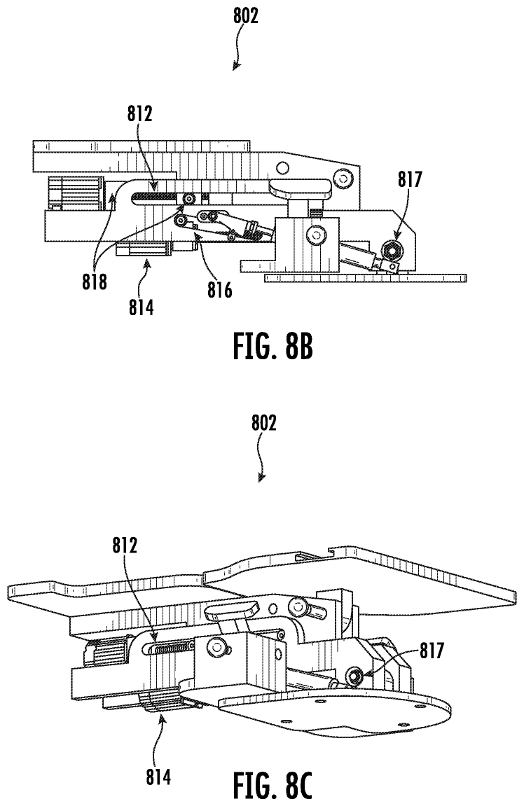

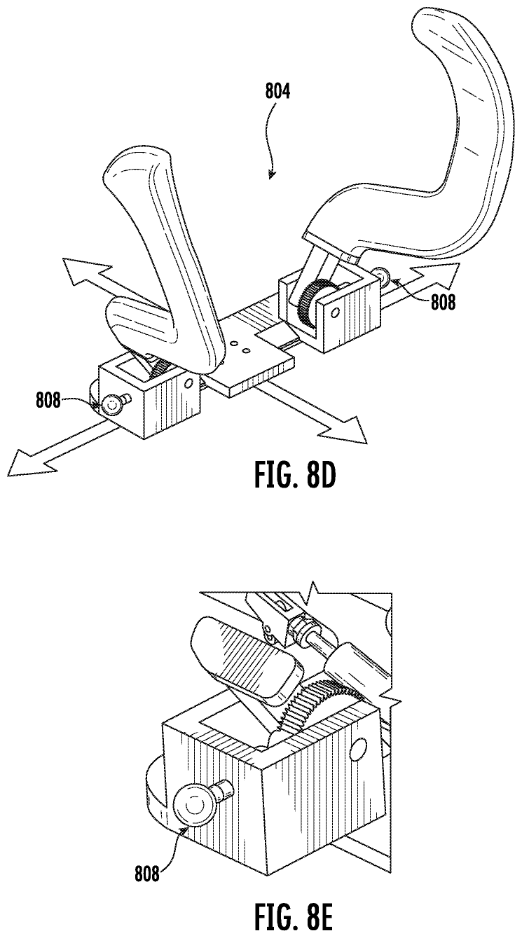

FIGS. 8A-8E show the thoracic subassembly 404. FIG. 8A shows a thoracic support platform 802, underarm supports 804, a belt clip 806 for a harness, controls 808, a head cushion 810-1 and a thoracic cushion 810-2 (collectively, thoracic support cushions 810). The thoracic support platform 802, as illustrated in FIGS. 8B and 8C, includes a linear actuator 812 to provide traction in the thoracic section and a linear actuator 814 to tilt the thoracic section along ramp 816. Thoracic disc herniations occur, and traction elongation of the thoracic spine is necessary to decompress and release pressures on spinal structures causing pain. The 3D positioning of the thoracic section (e.g., thoracic subassembly 404) as described herein positions the thoracic spine in the optimal pain-free or reduced pain orientation to perform traction that is not attainable using conventional strictly axial non-3D approaches. Additionally, the combination of using thoracic traction elongation simultaneously with lumbar traction via the leg assembly 1000 traction capability described elsewhere herein produces greater force and clinical effect than either system used singularly. These motions may be powered or manually released and controlled. As the linear actuator 814 pushes a bushing or roller along the ramp the thoracic support cushions 810 will pivot about the pivot point 817 illustrated in FIGS. 8B and 8C. The thoracic section is further configured for rotation about the Y-axis. The thoracic section provides traction which can be applied by actuator 812 at different angles by pivoting the thoracic subassembly 404 at different angles utilizing actuator 814. As an alternate embodiment, a force sensor 818 is installed on the actuator mount or lead screw nut to provide feedback to the control system. Force can also be derived by direct torque measurement in the actuator.

The underarm supports 804, shown separately in FIG. 8D, are configured with a funnel-like shape to provide partial support on a chest of a patient. The underarm supports 804 additionally provide the ability to apply and deliver the Y-axis decompression force or traction effect as the entire arm section is elongated. In other embodiments, the underarm supports 804 may be cylinder shaped. The underarm supports 804 can be ratcheted into the body of the patient using ratchet controls 808, and can additionally be adjusted along the Y-axis as indicated. In some embodiments, the underarm supports 804 are configured in a generally cone-shaped geometry to hold on the chest of a patient which tends to broaden from the lumbar area to the underarm area. The underarm supports 804 may also have hand grips for a patient to hold (e.g., during supine treatments). The hand grips may be integrated into the underarm supports 804, or may be removably attachable thereto as an added option. Additionally, the underarm supports 804 may be configured with controls (e.g., buttons, joysticks, triggers, touchpads or touchscreens, push bars, etc.) so that the patient can self-treat (e.g., if enabled by a practitioner). Such controls may also include an emergency stop enabling the patient to stop treatment being carried out by a practitioner. The emergency stop may be located elsewhere on the unit where it is easily reached by the patient. The unit may also include multiple emergency stops if desired. The underarm supports 804 may further include features for adjusting the width of the arm locations along the X-axis. FIG. 8E shows a detailed view of the ratchet controls 808. The underarm supports 804 may also be easily removed from the thoracic subassembly 404.

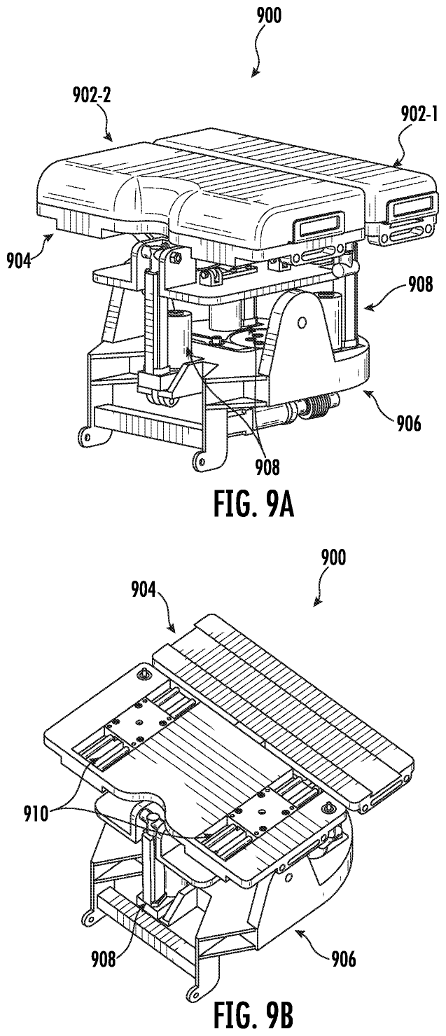

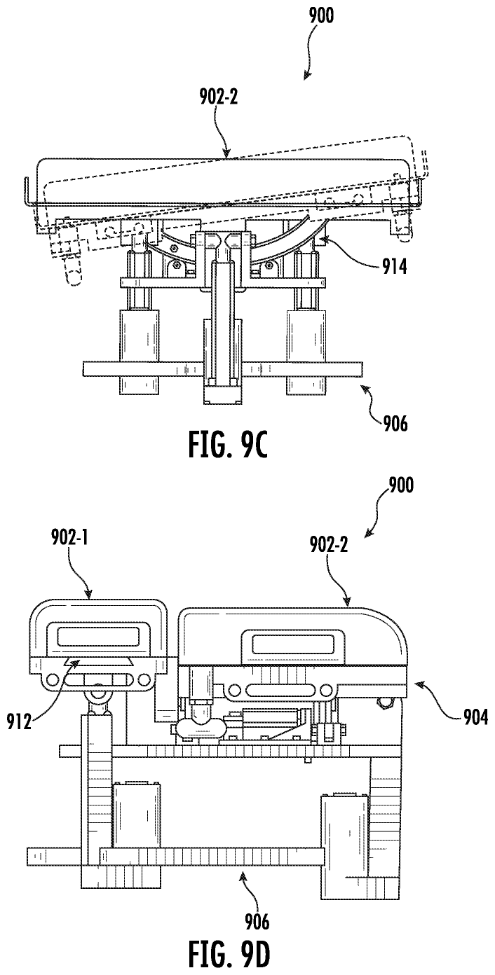

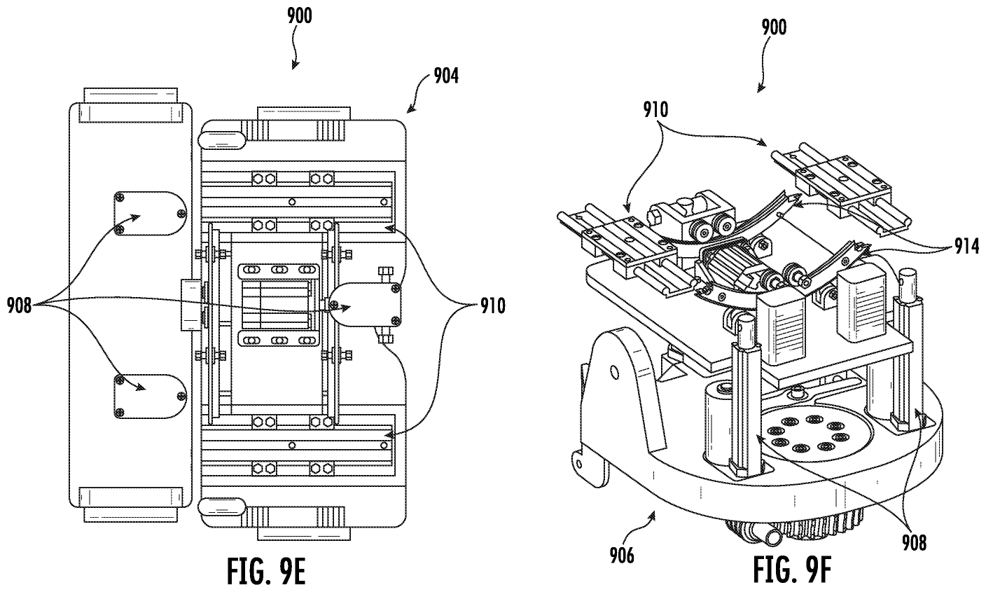

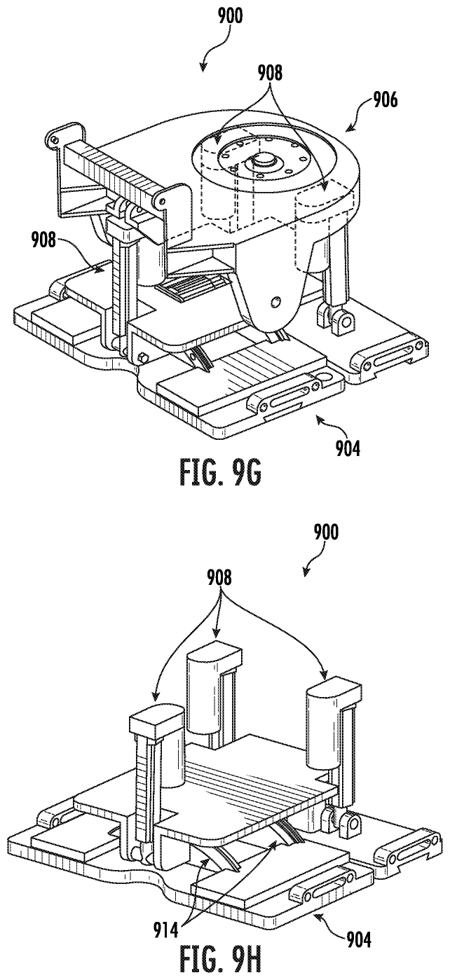

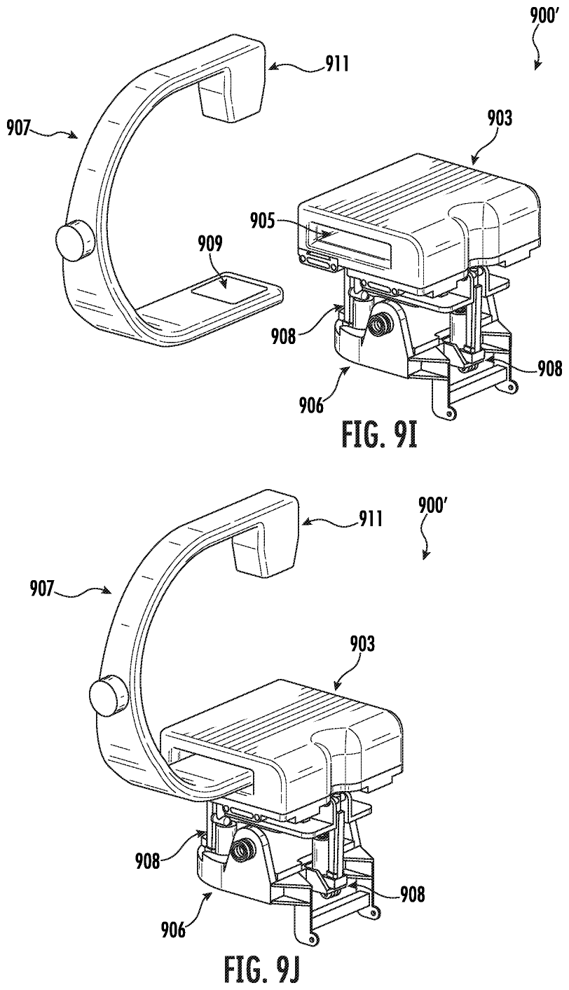

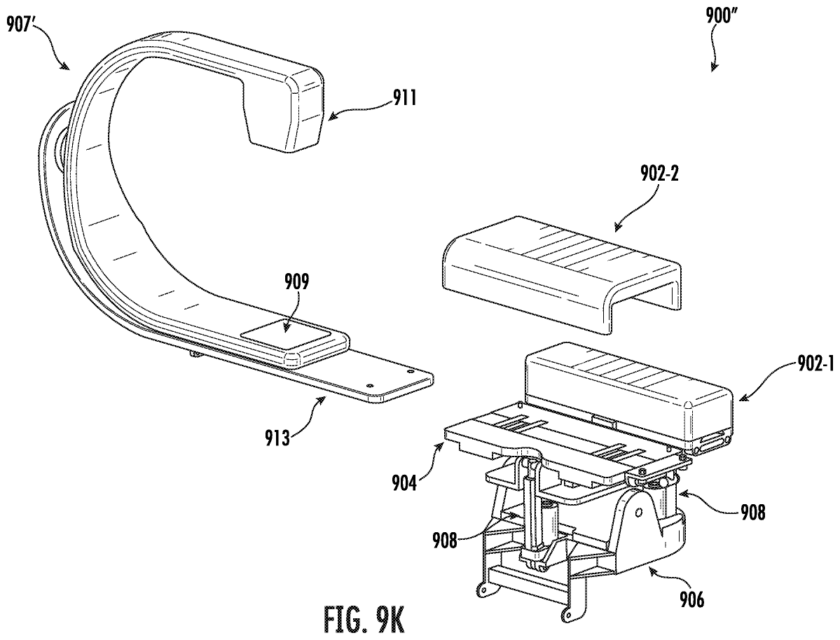

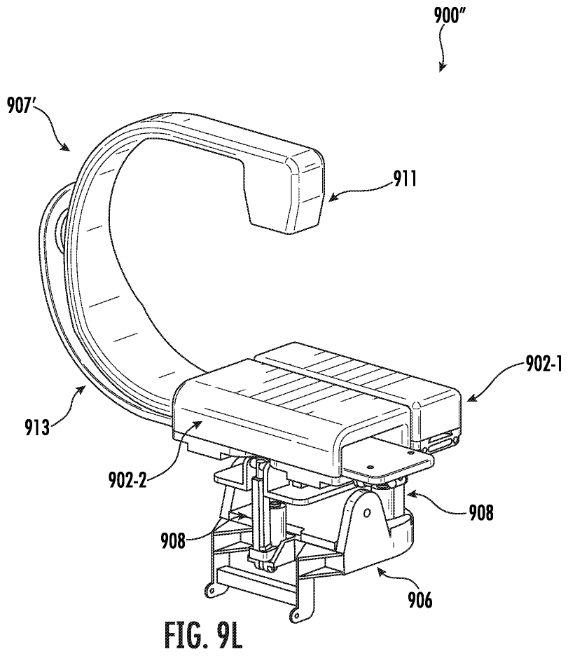

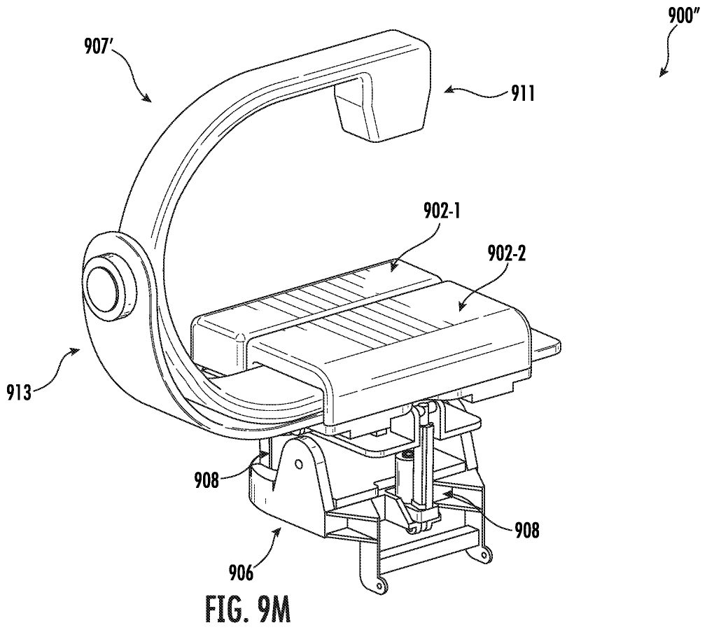

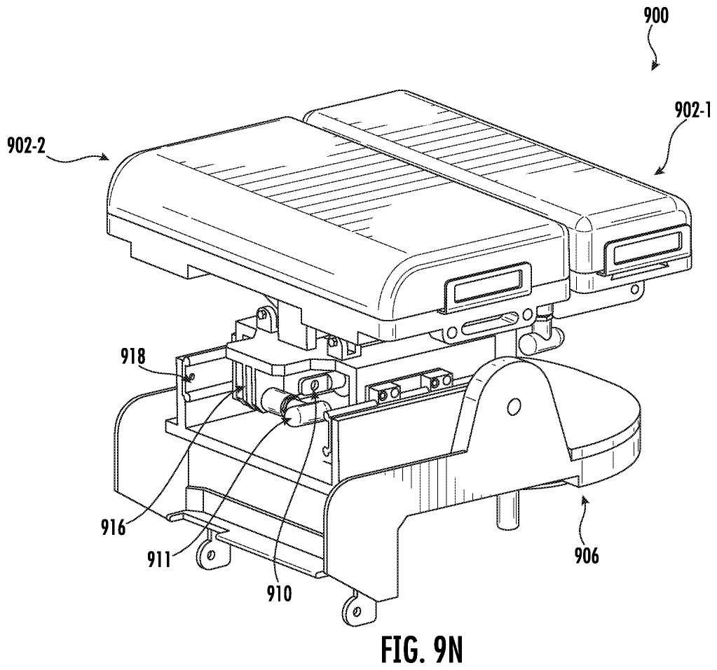

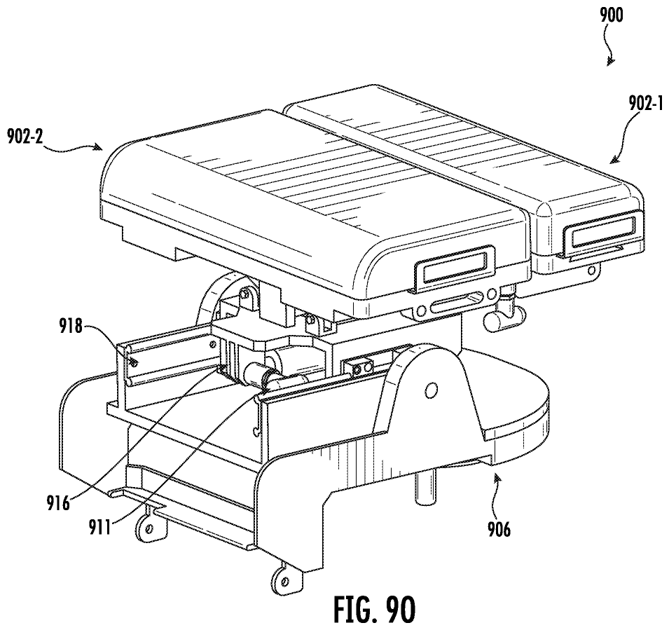

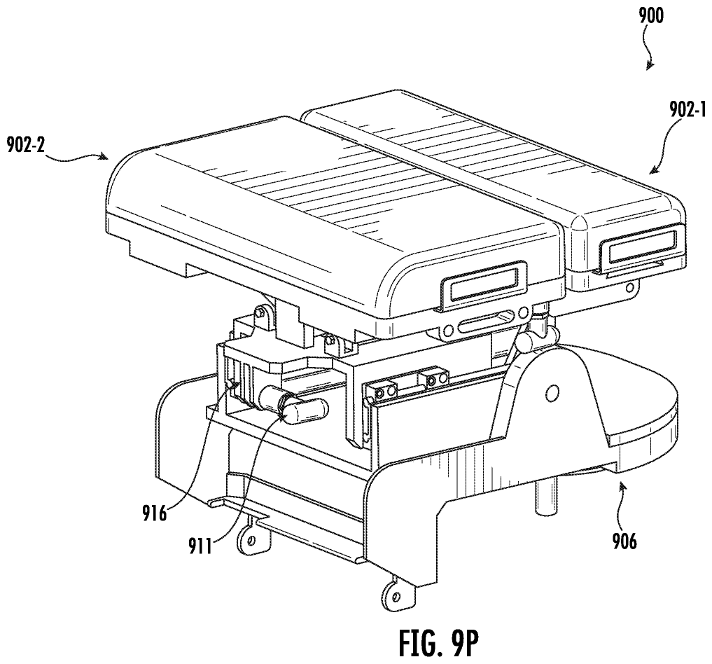

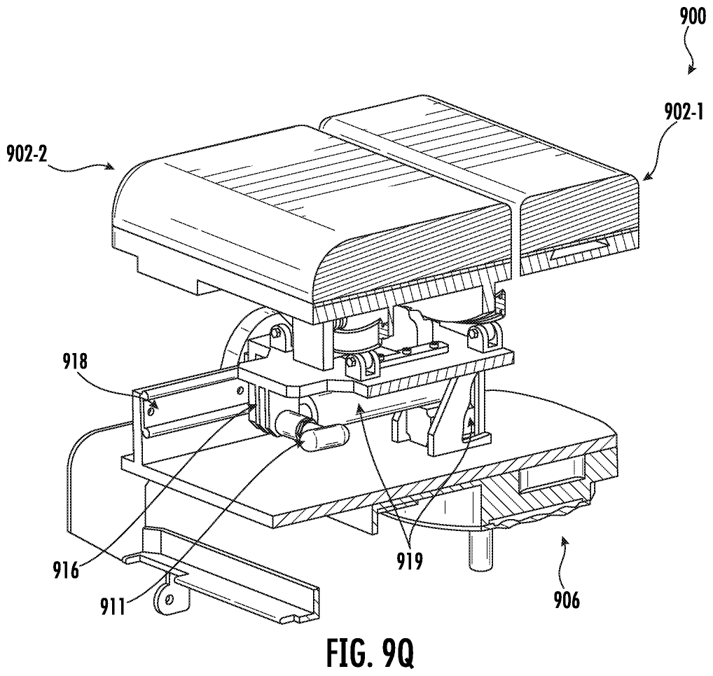

FIGS. 9A-9H show aspects of a lumbar and pelvis section 900 of the lumbar, pelvis and leg subassembly 406. The lumbar and pelvis section 900 includes separate lumbar and pelvis pads 902-1 and 902-2 (collectively, lumbar and pelvis pads 902) and associated pad support plates 904, a lumbar and pelvis support platform 906, Z-direction lumbar and pelvis actuators 908, Y-direction sliding mechanisms 910, and X-direction sliding mechanisms 912, shown in FIG. 9D as a dovetail-shaped slide. It should also be appreciated that the pelvic cushion can be similarly translated in the X-direction. Various other slide mechanisms may be used in other embodiments. FIG. 9A shows a perspective view of the lumbar and pelvis section 900. FIG. 9B shows a perspective view of the lumbar and pelvis section 900 with the lumbar and pelvis pads 902 removed. FIG. 9C illustrates rotation of the pelvis pad, and FIG. 9D shows a side view of the pelvis and lumbar section 900. It should be appreciated that a separate lumbar pad can be similarly rotated on its own pivot mechanism similar to 914 shown in FIG. 9H. FIG. 9E shows a bottom-up view of the pad support plate 904 illustrating connection of the Z-direction lumbar and pelvis actuators 908 and Y-direction sliding mechanisms 910. FIG. 9F shows a perspective view of the lumbar and pelvis section 900 with the lumbar and pelvis pads 902 and the pad support plate 904 removed. FIGS. 9G and 9H illustrate additional perspective view of a bottom of the pad support plate 904.

The lumbar and pelvis pads 902 are rotatable about the Y-axis. The rotation is above the pads near a centerline of the patient's spine. The rotation is enabled by an arced sector track 914 highlighted in FIGS. 9C, 9F and 9H. Although FIG. 9C illustrates rotation of the pelvis pad 902-2 only, it should be appreciated that the lumbar pad 902-1 is also rotatable (e.g., independent of the pelvis pad 902-2 rotation, together with the pelvis pad 902-2, etc.). Such rotation of the lumbar and pelvis pads 902 may be powered or manual. The rotation center of the lumbar and pelvis pads 902 is above the pads near a centerline of the patient's spine. Any combination of lumbar and pelvis pad rotation may be achieved, including rotating one clockwise and the other clockwise, rotating both in the same direction, rotating one while keeping the other stationary, etc.

The lumbar and pelvis pads 902 are further free to move along the Y-direction by the practitioner releasing a translation lock to allow movement along the Y-direction slide mechanisms 910. This allows the ability to permit free sliding (e.g., friction-free) of the lumbar and pelvic pads during leg system elongation traction motion, reducing any frictional resistance during therapeutic decompression in the Y-axis direction. It also enables repositioning of the lumbar pelvic support cushions manually to adjust the location of support pads to the correct anatomical locations along a subject's spine. This is further important for C-arm protocols in order to locate subject under desired C-arm cathode location.

In some embodiments, the lumbar and pelvis pads 902 can be free to translate along the Y-direction independent of one another, or they may be locked either together or independently. The lumbar pad 902-1 is also configured to release and slide along the X-axis via X-direction slide mechanism 912. The lumbar pad 902-1 can be locked anywhere along the translational axis. In some embodiments, a belt is added to hold the patient in place. In some embodiments, the pelvis pad 902-2 is also configured to release and slide along the X-axis via an X-direction slide mechanism similar to the Y-direction slide mechanisms 910. The pelvis pad 902-2 can be locked anywhere along the translational axis. In some embodiments, a belt is added to hold the patient in place. Any elements of lumbar or pelvic pads 902 that can be released to move freely can also be partially released to provide resistance to be used as feedback by the practitioner.

FIGS. 9A-9H show an embodiment with three Z-direction actuators 908, though it should be appreciated that embodiments may more generally utilize two or more Z-direction actuators in the lumbar and pelvis section 900 of the lumbar, pelvis and leg subassembly 406. Various combinations of the three Z-direction actuators 908 may be engaged to create different height and angle positions of the lumbar and pelvis pads 902. Ball joints in the actuator shaft end can be added to facilitate multi axis positioning. Further, in some embodiments the lumbar and pelvis pads 902 may be moved independently of one another.

FIGS. 9I and 9J show an embodiment where a C-arm structure 907 is positioned on or attached to a lumbar and pelvis section 900′ of the lumbar, pelvis and leg subassembly 406. The lumbar and pelvis section 900′ shown in FIGS. 9I and 9J includes a combined lumbar and pelvis support pad 903, as well as the pelvis support platform 906 and the actuators 908. The C-arm structure 907 includes a section 909 that is configured for insertion into a slot of the combined lumbar and pelvis pad 903. FIG. 9I shows the C-arm structure 907 outside the combined lumbar and pelvis pad 903, while FIG. 9J shows the C-arm structure 907 inserted into the combined lumbar and pelvis pad 903. The C-arm structure 907 includes a functional feature 911. In some embodiments, the functional feature 911 comprises an imaging device, such as a camera, an X-ray device, etc. The C-arm functional feature 911, in some embodiments, is configured with an X-ray generator and detector. When the C-arm structure 907 is installed with such a functional feature 911, this enables the practitioner to view the patient's spine shape and spacing. The C-arm structure 907 attachment, in conjunction with treatment table positioning, can aid in correct anatomical placement of the spine, pelvis and hips of the patient for the administration of pain management, for epidural and other injections to provide improved accuracy of the injection site, for facilitating pain management, etc.

The C-arm structure 907 may be selectively attached to the combined lumbar and pelvis pad 903 as desired when a practitioner seeks to image a patient positioned on the treatment table.

It should be noted that although FIGS. 9I and 9J illustrate the C-arm structure 907 being inserted and removed from a combined pelvis and lumbar pad 903, the C-arm structure 907 may more generally be configured for insertion and removal into any support pad of a treatment table described herein which is suitably modified with a slot or cavity (e.g., similar to slot 905) in which the section 909 may be inserted. The slot 905 or other cavity is in some embodiments may sufficiently large to allow multiple orientation or position of an inserted C-arm structure 907, and permit and enable motions of the lumbar and pelvic cushions, leg motions in extension, flexion, lateral flexion, rotation, traction, combinations thereof, etc. This enables the functional feature 911 of the C-arm structure 907 (e.g., an imaging device such as an X-ray generator and detector) to view the spine of the patient from all desired angles. It should also be appreciated that the section 909 of the C-arm structure 907 need not be inserted into a slot that is part of a support pad of a treatment table. In other embodiments, another portion of a treatment table may include a slot or cavity configured to receive the section 909 for coupling of the C-arm structure 907 to the treatment table. For example, the pelvis support platform 906 may be configured with a slot that the C-arm structure 907 is inserted into, rather than or in addition to the C-arm structure 907 being configured for insertion into slot 905 of the combined pelvis and lumbar support pad 903.

FIGS. 9K-9M show another embodiment of a C-arm structure 907′ that is configured for attachment to a treatment table. In the embodiment of FIGS. 9K-9M, the lumbar and pelvis section 900″ includes a separate lumbar pad 902-1 and pelvis pad 902-2. The C-arm structure 907′ is configured for mounting to the pelvis support platform 906 below the pelvis pad 902-2, which is itself removably coupled to the pelvis support platform 906. The C-arm structure 907′ includes an arm plate 913 that is coupled to section 909, and which attached to the pelvis support platform 906. The C-arm structure 907′ also includes a functional feature 911 as described above. FIG. 9K shows the C-arm structure 907′ and pelvis support pad 902-2 removed from the pelvis support platform 906. FIGS. 9L and 9M show perspective views of the C-arm structure 907′ mounted to the pelvis support platform 906 and the pelvis pad 902-2 affixed to the pelvis support platform 906 over the C-arm structure 907′.

It should be noted that although FIGS. 9K-9M illustrate the C-arm structure 907′ being inserted and removed from below pelvis pad 902-2, the C-arm structure 907′ may more generally be configured for insertion and removal from below any support pad of a treatment table described herein, including but not limited to the lumbar pad 902-1 shown in FIGS. 9K-9M. It should further be appreciated that the C-arm structure 907′ may also be configured for mounting to other sections of a treatment table instead of below or being sandwiched between a support pad and an associated support platform on which the support pad is mounted.

It should be noted that obtaining correct positioning of the spine and pelvis to image facet joints, vertebral spinal foramina, and accessibility is important when using a C-arm scanner or other functional feature 911 for pain management injections. Rotation of the legs and pelvis may also be vital for 3-D mimicking initial treatment parameter setup for pain management imaging with a C-arm scanner or other functional feature 911. The stretching while imaging by applying traction along the Y-axis aids placement of the spine into a position to more accurately inject pain management therapies. Additionally, some conditions or ailments that the patient has can be better evaluated when the desired patient positioning is achieved through the positioning features of the frame positioning devices described herein. The C-arm functional features 911, in some embodiments, can image which particular structures and spinal joints are dysfunctional and hypo-mobile, hyper mobile and fixated during motion of the subject under fluoroscope via the device's capable movements in the C-Arm's line of sight imaging field during motions of the lumbar and pelvic cushions, leg motions in extension, flexion, lateral flexion, rotation, traction, combinations thereof, etc.

FIGS. 9N-9Q show an embodiment wherein the lumbar and pelvis section 900 includes movable powered traction and release of the lumbar pad 902-1 and pelvis pad 902-2. FIG. 9N shows the lumbar and pelvis section 900, wherein the lumber pad 902-1 and pelvis pad 902-2 are mounted to a sliding mechanism 916 configured to slide along tracks 918 in the pelvis support platform 906. The sliding mechanism 916 may include a manual or powered actuator. FIG. 9N shows the lumbar pad 902-1 and pelvis pad 902-2 in a free sliding state enabled by releasing the sliding mechanism 916 from the actuator 910 by releasing the connection 911 thereby providing a friction-free effect on the lumbar and pelvis spine during leg mediated decompression, while FIG. 9O shows the lumbar pad 902-1 and pelvis pad 902-2 power retracted along tracks 918 via the sliding mechanism 916 and FIG. 9P shows the lumbar pad 902-1 and pelvis pad 902-2 power extended along tracks 918 via the sliding mechanism 916. FIG. 9Q shows a sectional view of the sliding mechanism 916 and tracks 918. Force sensors 919 are attached to the to the base or shaft of the of the actuator.

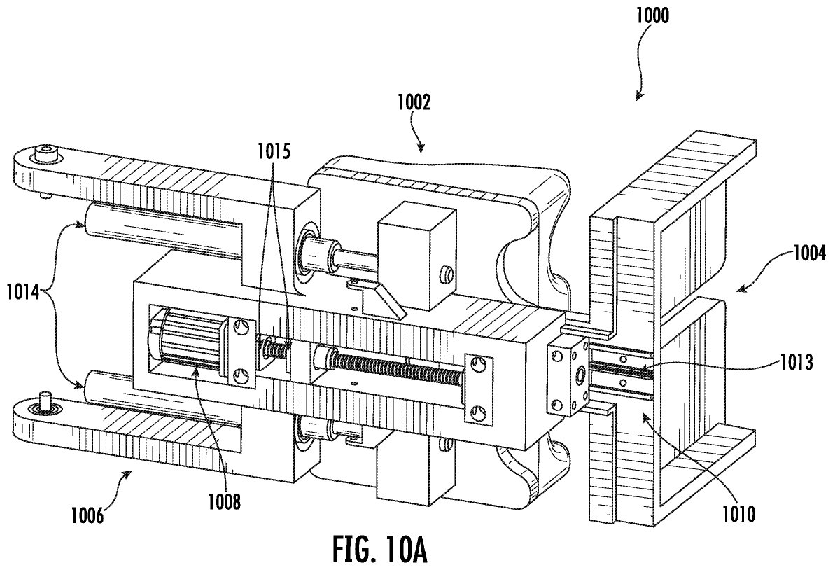

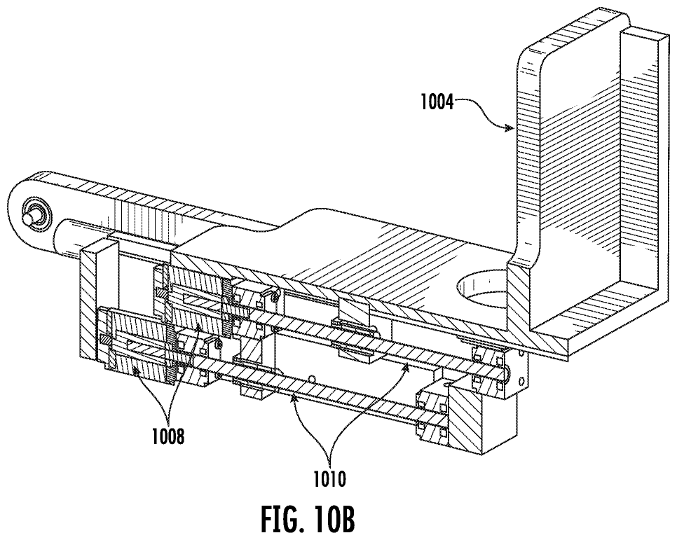

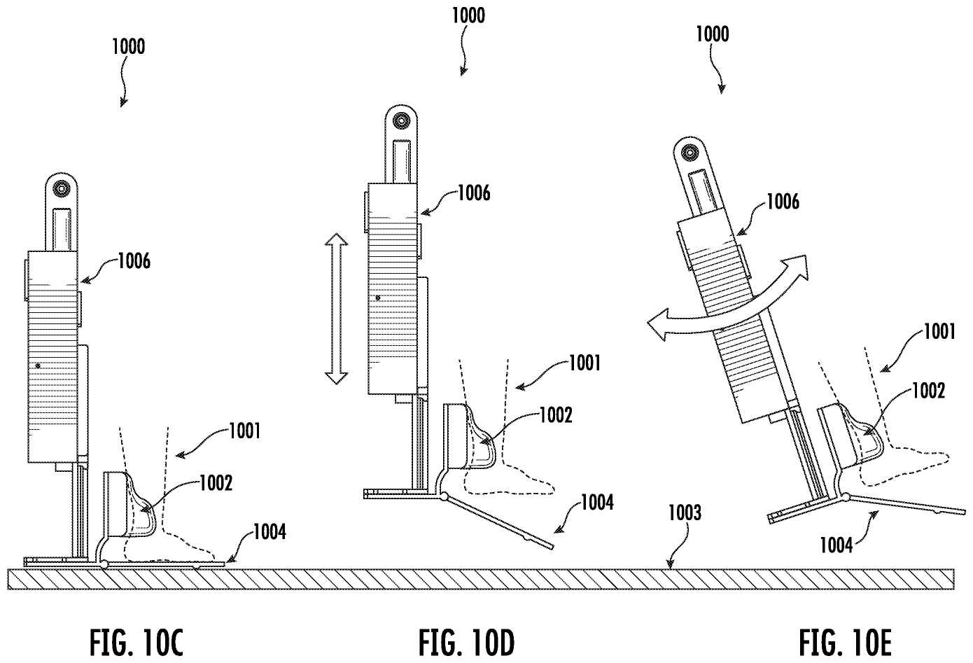

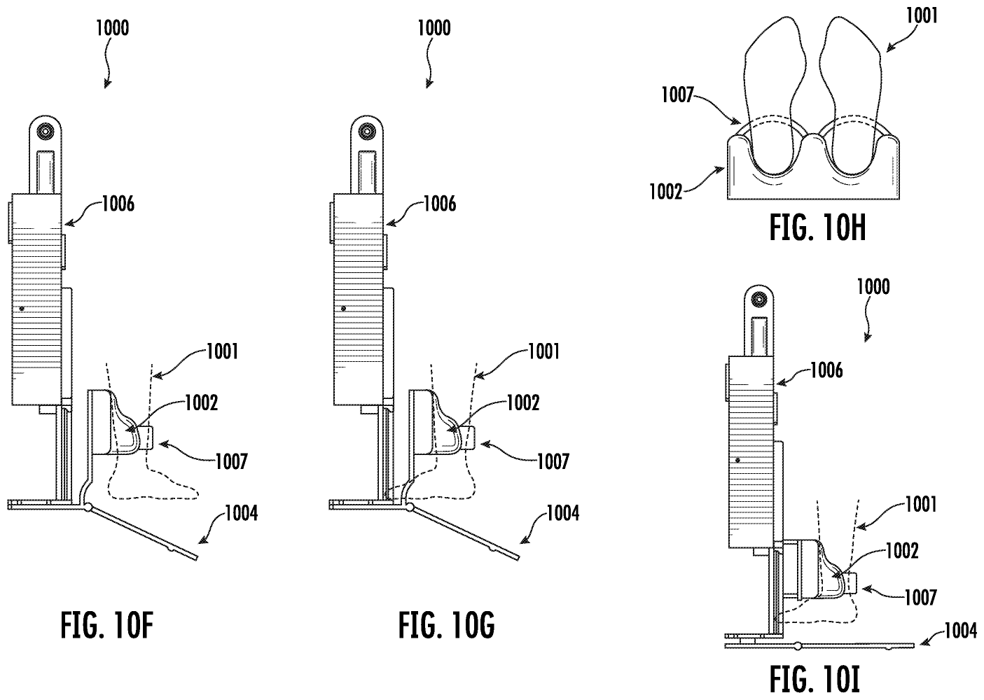

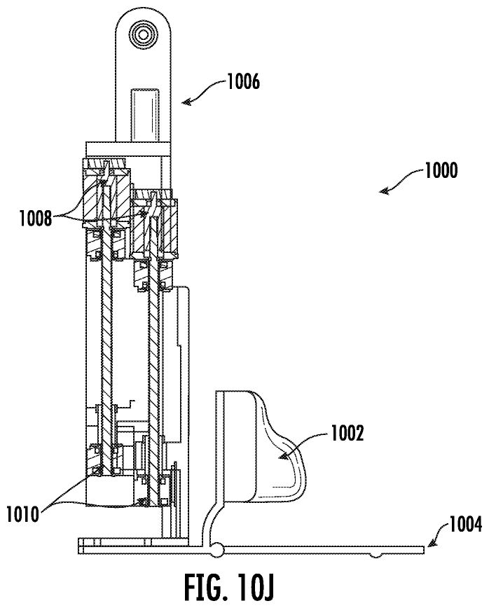

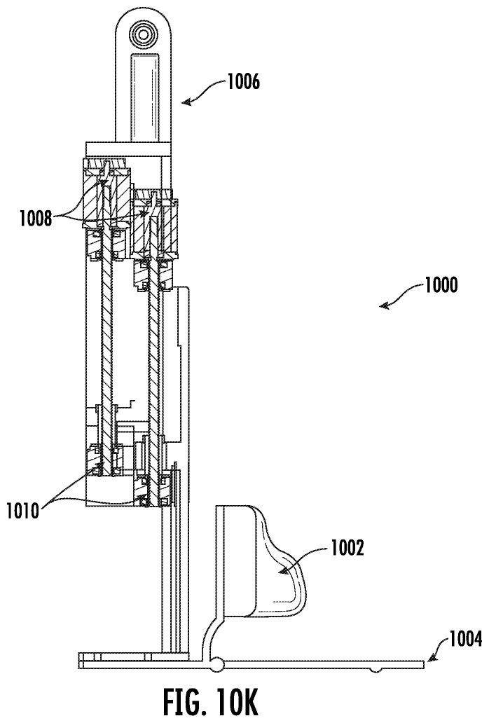

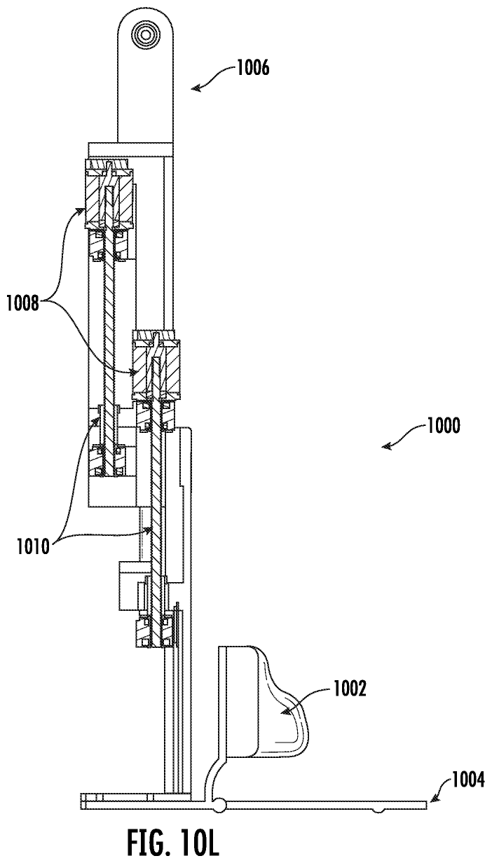

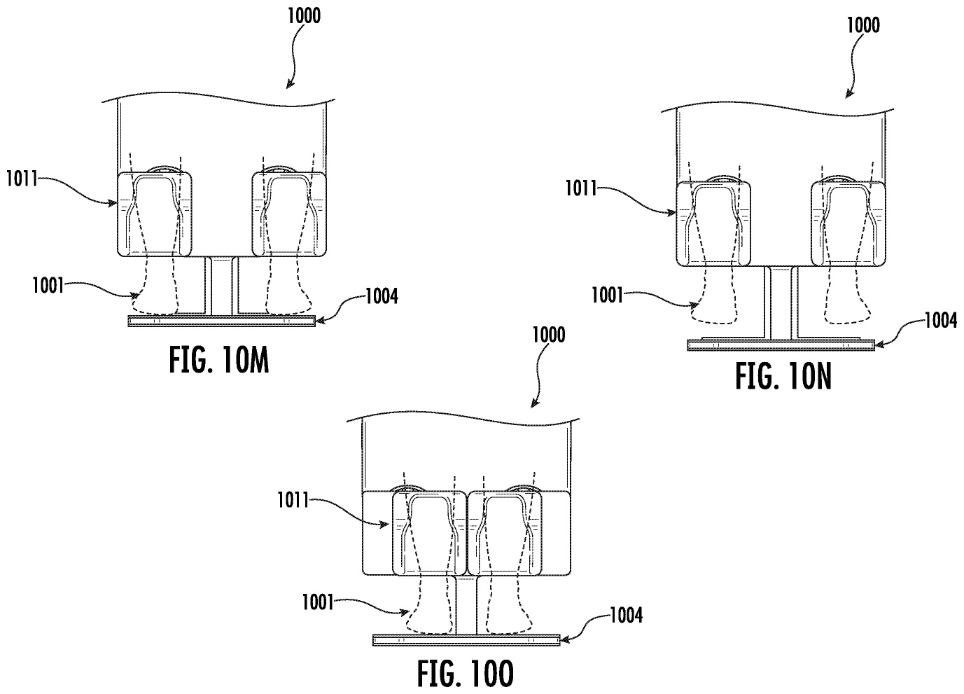

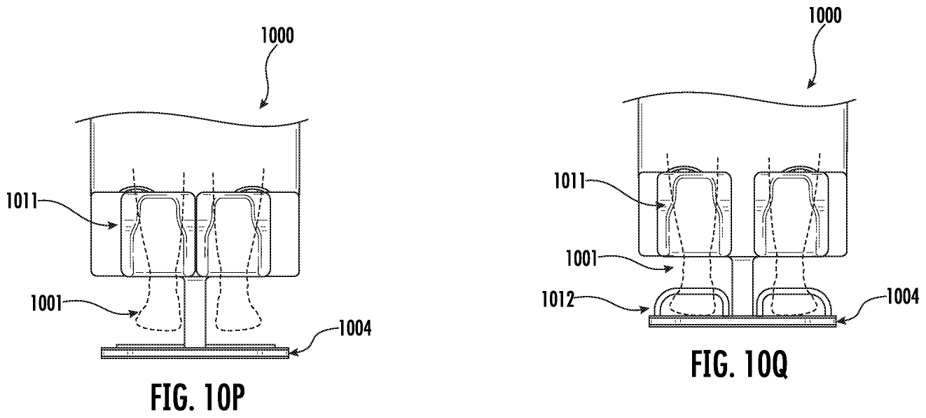

FIGS. 10A-10Q show a leg section 1000, removed from an associated pivot attachment point that couples the leg section 1000 to lumbar and pelvis sections of the lumbar, pelvis and leg subassembly 406. The leg section 1000 includes leg support pads 1002, a folding step platform 1004, a leg support base 1006, and leg extension actuators 1008. FIG. 10A shows a perspective view of an underside of the leg section 1000, while FIG. 10B shows a sectional view of a portion of the folding step platform 1004 and leg extension actuators 1008. The leg extension actuators 1008 extend the folding step platform 1004 along lead screws 1010 which move the leg section 1000 along sliding tracks 1013 (e.g., which may be implemented using any desired type of track), the leg extension actuators 1008 being further supported by bilateral cylinder guides 1014 on opposing sides of the leg support base 1006 in some embodiments. Two actuators and lead screws are shown in series to increase the amount of extension provided to accommodate patients of different height and desired amount of traction. In other embodiments, only one actuator and lead screw may be used, or more than two actuators and lead screws may be used in series. The leg extension actuators 1008 may be powered. In some embodiments, a force sensor 1015 is installed on the actuator mount or lead screw nut to provide feedback to the control system. Force can also be derived by direct torque measurement in the actuator.

FIGS. 10C-10I show a patient securing their legs 1001 to the leg support pads 1002, such as using straps 1007, grips, etc. The leg support pads 1002 may be movable to allow for different positioning for different sized patients, or to facilitate different positioning (e.g., prone, supine, etc.) of a patient. The folding step platform 1004 can be released, moved, or removed to ensure that the bottom of the feet of the patient are free during traction. FIG. 10C shows the leg section 1000 in a vertical position, resting on a floor 1003 of a treatment center or other facility. FIG. 10D shows the leg section 1000 in a vertical position, but lifted off the floor by lofting the leg support base 1006 as shown. The elevation lift can be achieved by lifting the table 106 using any combination of lifting using the four-bar mechanism 104 and rotating the table 106 by using the table support platform actuator 310. FIG. 10D also illustrates the release of the folding step platform 1004. The release may be manual, actuated electronically, etc. The release allows for the feet to be free and clear during treatments. The folding step platform 1004 can be returned to the position that supports the feet (e.g., actuated either manually or electronically) in order to provide a smooth transition of the patient 1001 from the treatment position to the vertical position to enter and exit the unit. FIG. 10E shows the leg section 1000 lifted off the floor by rotating the leg section 1000, the lumbar, pelvis and leg subassembly 406, the table support and pivot subassembly 402, or by rotating the entire patient support platform (e.g., 306 in FIGS. 3A-3H) by activation of cylinders (e.g., 310 in FIGS. 3A-3H).

FIGS. 10F and 10G show feet of the patient 1001 secured to the leg support pads 1002 via straps 1007 when backed in and when facing the treatment table, respectively, with the folding step platform 1004 lowered. FIG. 10H shows a bottom view illustrating the straps 1007 securing the feet of the patient 1001 to the leg support pads. FIG. 10I shows the feet of the patient 1001 secured to the leg support pad 1002 via straps 1007 with the folding step platform 1004 lowered and locked in its 90 degree position. In some embodiments, the folding step platform 1004 is configured to translate away from the feet of the patient 1001, rather than or in addition to being configured to rotate away up and down as illustrated in FIGS. 10F, 10G and 10I. Additionally, the folding step platform 1004 can both rotate and translate away from the feet of the patient 1001. This may be more effective, for example, when the patient 1001 is in the prone position.

FIGS. 10J-10L show retraction and extension of the leg section 1000 of the lumbar, pelvis and leg subassembly 406 of treatment table 200. FIG. 10J shows the leg section 1000 fully retracted, FIG. 10K shows the leg section 1000 partially extended, and FIG. 10L shows the leg section 1000 fully extended. This extension is achieved using the leg extension actuators 1008, which include an upper and a lower actuator as illustrated. The use of two separate actuators allows for a large amount of extension while keeping the overall leg section 1000 unit compact. For example, the partial extension shown in FIG. 10K is achieved by fully extending the upper one of the leg extension actuators 1008 while the lower one of the leg extension actuators 1008 is fully retracted, or vice versa. The full extension shown in FIG. 10L is achieved by fully extending both the upper and lower ones of the leg extension actuators 1008. It should be appreciated, however, that in other embodiments partial extension may be achieved using a combination of the upper and lower ones of the leg extension actuators 1008, rather than using the upper one of the leg extension actuators 1008 first followed by the lower one of the leg extension actuators 1008 as illustrated in FIGS. 10J-10L.

FIGS. 10M-10P show a patient 1001 securing their legs to a pair of leg support pads 1011, such as using straps 1007, grips, etc. The pair of leg support pads 1011 may be movable to allow for different positioning for different sized patients and different treatment protocols, or to facilitate different positioning (e.g., prone, supine, etc.) of the patient 1001. FIG. 10M shows the pair of leg support pads 1011 separated to spread the legs apart with the feet of the patient 1001 resting on the folding step platform 1004 (also referred to as a leg support platform 1004). FIG. 10N shows the pair of leg support pads 1011 separated to spread the legs apart with the feet of the patient 1001 released from the folding step platform 1004 by being translated away from the feet of the patient 1001. FIG. 10O shows the pair of leg support pads 1011 moved inward to hold the legs close together with the feet of the patient 1001 resting on the folding step platform 1004. FIG. 10P shows the pair of leg support pads 1011 moved inward to hold the legs close together with the feet of the patient 1001 released from the folding step platform 1004 by being translated away from the feet of the patient 1001.

FIG. 10Q shows an alternate embodiment where the patient 1001 secures their legs 1001 to the folding step platform 1004 with straps 1012 while using the pair of leg support pads 1011 to guide the legs.

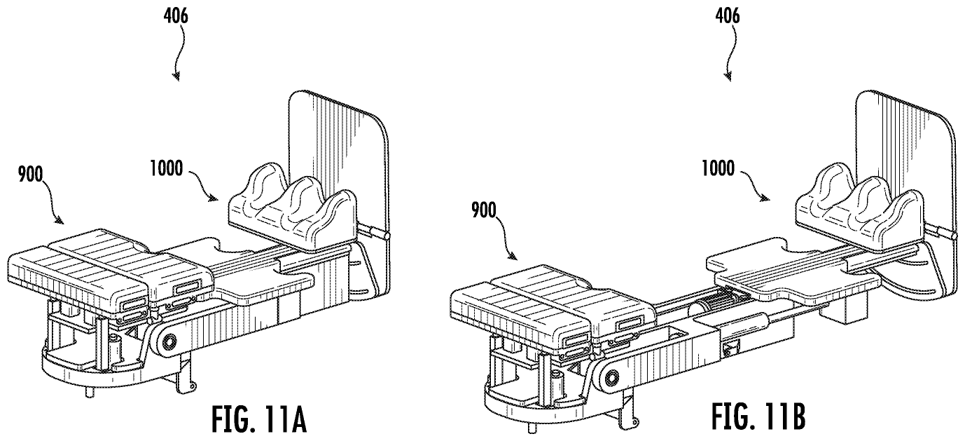

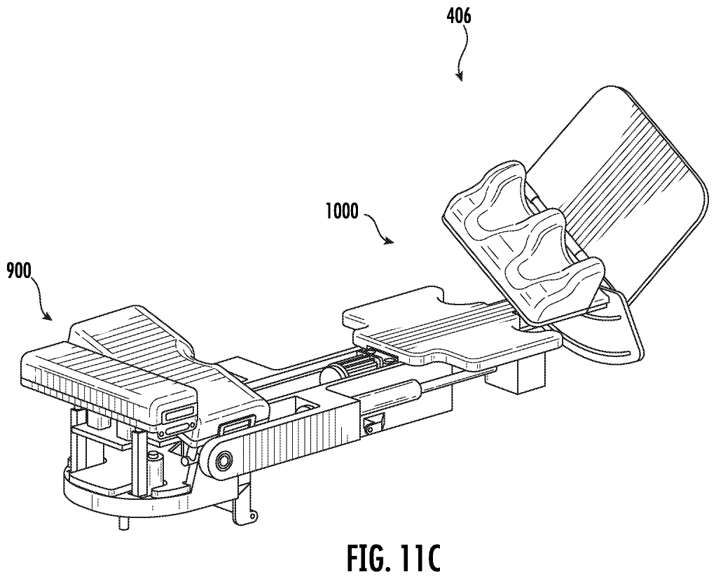

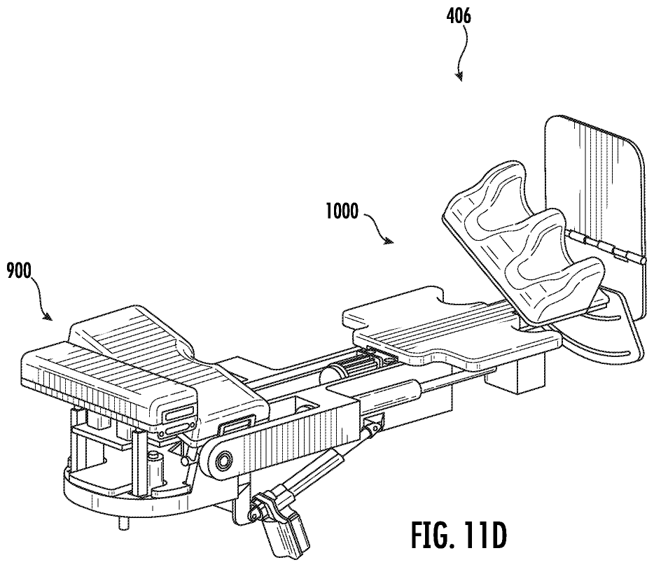

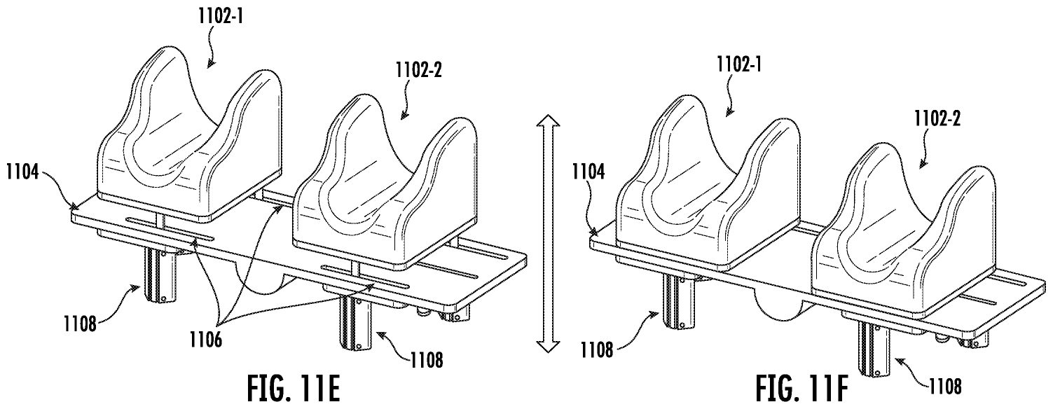

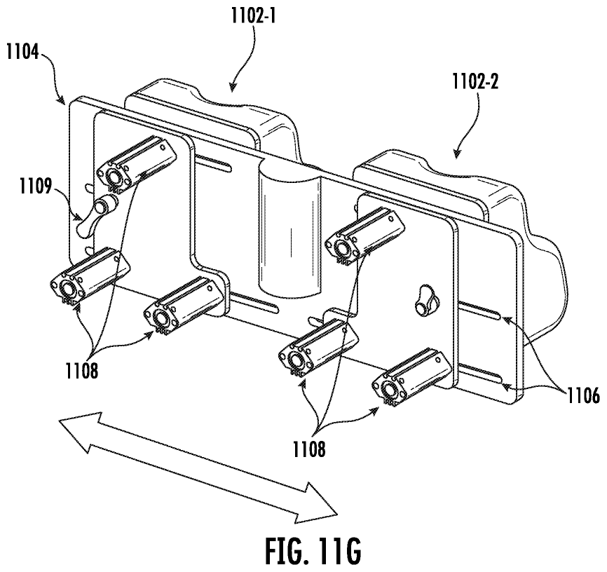

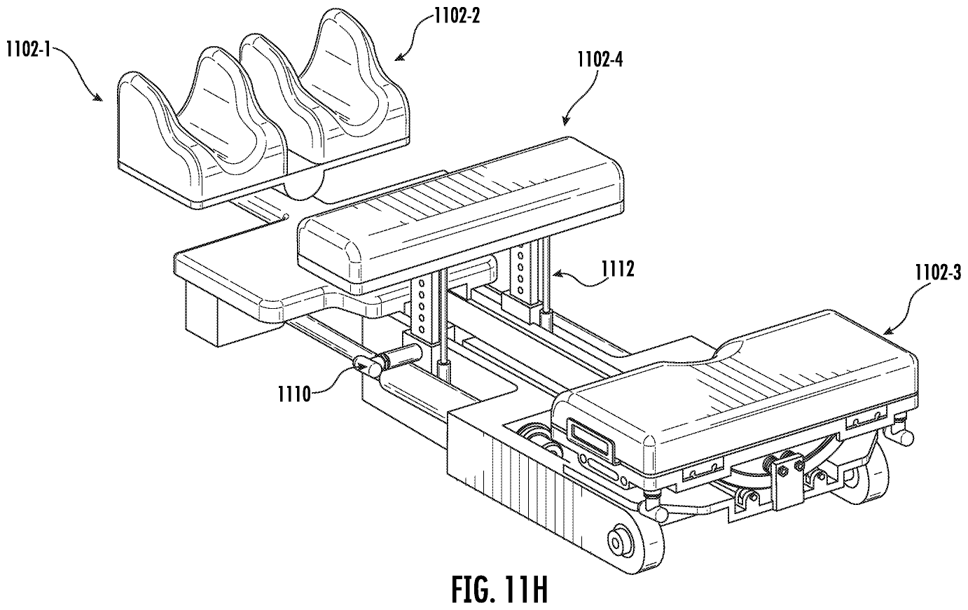

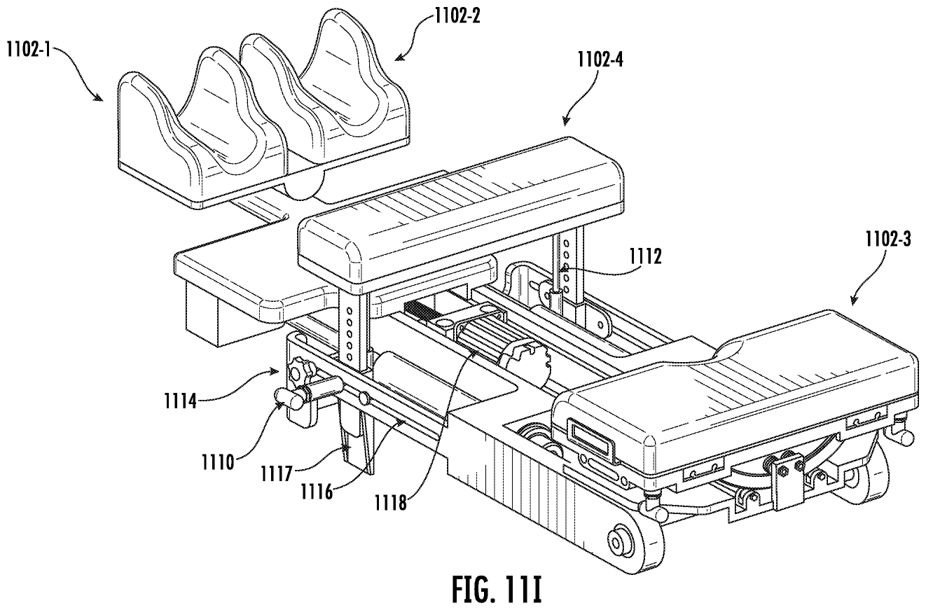

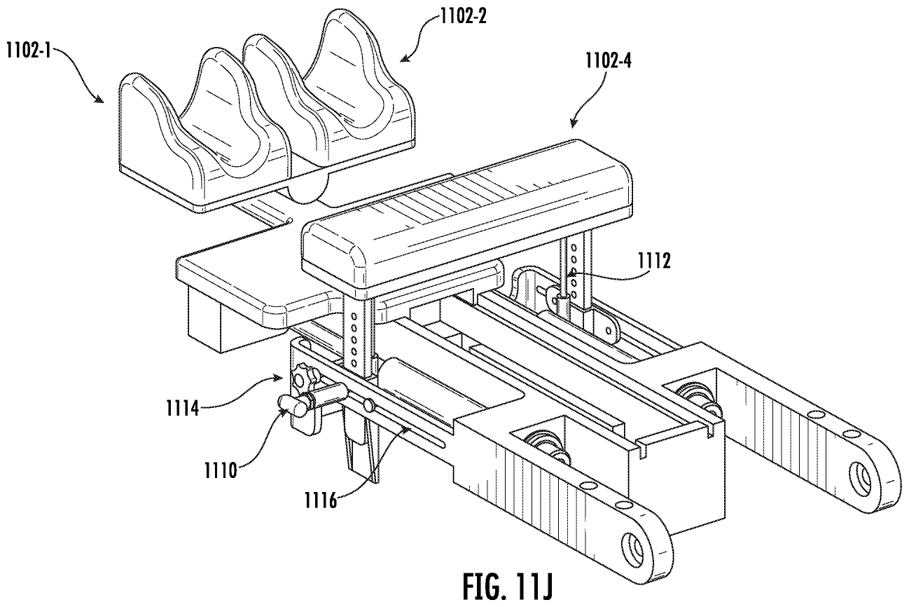

FIGS. 11A-11D show the lumbar, pelvis and leg subassembly 406, illustrating retraction, extension and tilt of portions thereof. FIG. 11A shows the leg section 1000 in a fully retracted position relative to the lumbar and pelvis section 900, while FIG. 11B shows the leg section 1000 in a fully extended position relative to the lumbar and pelvis section 900. The leg section 1000 of the lumbar, pelvis and leg subassembly 406 extends to adjust for patient height, and to provide repetitive motion and traction. As shown in FIG. 11C, both the lumbar and pelvis section 900 and the leg section 1000 may tilt along the Y-axis to reduce torque on the legs of the patient. More particularly, FIG. 11C illustrates tilt of the pelvis portion of the lumbar and pelvis section 900. It should be appreciated, however, that in other embodiments the lumbar portion of the lumbar and pelvis section 900 may also tilt, either together with or independent of the pelvis portion. The lumbar and pelvis portions may also counter rotate in opposite directions. The foot portion of the leg section 1000 can be fixed on the Y-axis, or may be allowed to freely rotate along the Y-axis depending on the desired treatment. The rotation of the foot portion may be manual or powered. In FIG. 11C, the folding step platform rotates with the foot piece (e.g., with the foot cushions or pads). In other embodiments, however, the foot piece may rotate while the folding step platform remains stationary. In some embodiments, the leg support pads can rotate as shown in FIG. 11D. The leg restraints or support pads in the FIG. 11D embodiment are configured to independently rotate about the Y-axis while the folding step platform remains fixed and does not rotate. In other embodiments, both the leg support pads and the folding support platform are configured to rotate independent of one another. One or more manual or electronic actuators can be used to release or fix the rotation of the foot portion of the leg section 1000. A mechanism like the one that controls the override of the control mechanisms 708 in conjunction with 710 can be used to effect the release of the foot portion of the leg section 1000.

FIG. 11D also illustrates individual and separate leg or foot support pads, as compared with FIGS. 11A-11C which illustrates unified or combined leg or foot support pads. FIGS. 11E-11G illustrate how such separate leg or foot pads 1102-1 and 1102-2 may be adjusted in multiple directions. FIGS. 11E and 11F show foot pads 1102-1 and 1102-2 which are raised and lowered relative to foot pad support plate 1104. The foot pads 1102-1 and 1102-2 are further permitted to slide along tracks 1106 in the foot pad support plate 1104. Actuators 1108 may be used to effect the raising and lowering of the foot pads 1102-1 and 1102-2, as well as the translation along tracks 1106. It should be appreciated that although FIGS. 11E and 11F show the foot pads 1102-1 and 1102-2 moving in tandem with one another (e.g., both raised in FIG. 11E, both lowered in FIG. 11F) this is not a requirement. The foot pads 1102-1 and 1102-2 may be separately actuated to raise or lower each leg of a patient or user of a treatment table. FIG. 11G shows a bottom underside view further illustrating the foot support plate 1104, tracks 1106, actuators 1108, and release knobs 1109 for manual translation of such separate leg or foot pads 1102-1 and 1102-2 along tracks.

FIGS. 11H-11J illustrate an adjustable knee support that may be used as part of a lumbar, pelvis and leg subassembly 406. As described elsewhere herein, the lumbar section may be part of the thoracic subassembly 404 or may be configured for separate attachment to the table support and pivot subassembly. FIGS. 11H-11J more particularly illustrate an arrangement wherein the lumbar section is not part of the pelvis and leg subassembly. As shown in FIG. 11H, the pelvis and leg subassembly includes separate foot pads 1102-1 and 1102-2, along with a pelvis pad 1102-3 and knee support pad 1102-4. The knee support pad 1102-4 is configured to adjustment in a Z-direction using a Z-direction release mechanism 1110 and optional gas spring assists 1112. The Z-direction release mechanism 1110 when disengaged enables the knee support pad 1102-4 to be raised and lowered by the practitioner. The gas spring 1112 compensates for the weight of the knee support pad 1102-4 making it easier for the practitioner to raise and lower the knee support pad 1102-4.

FIGS. 11I and 11J illustrate that the knee support pad 1102-4 may be further configured for adjustment in both the Z-direction (e.g., using Z-direction release mechanism 1110 and gas spring assists 1112) and in a Y-direction using a Y-direction release mechanism 1114 permitting adjustment along tracks 1116. FIG. 11I also shows an actuator 1118 which may be used to effect movement of the foot pads 1102-1 and 1102-2. FIG. 11J shows a simplified view of the structure of FIG. 11I, with the pelvis pad 1102-3 removed along with the actuator 1118 for ease of illustration of the Y-direction release mechanism 1114 and tracks 1116.

The table support and pivot subassembly 402, thoracic subassembly 404, and lumbar, pelvis and leg subassembly 406 of the table section 203 of treatment table 200 enable various motions of a patient.

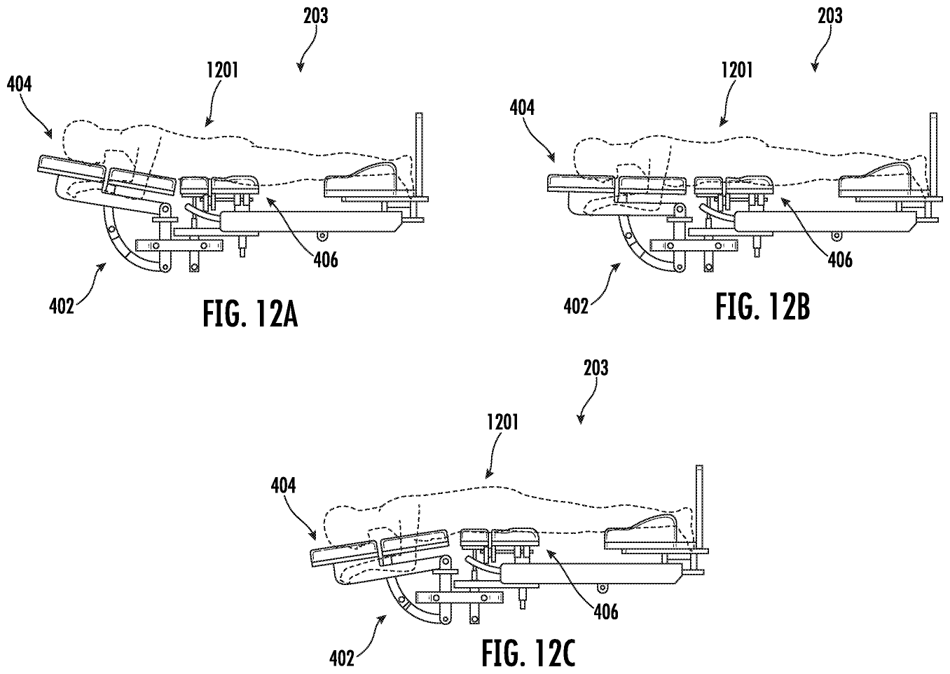

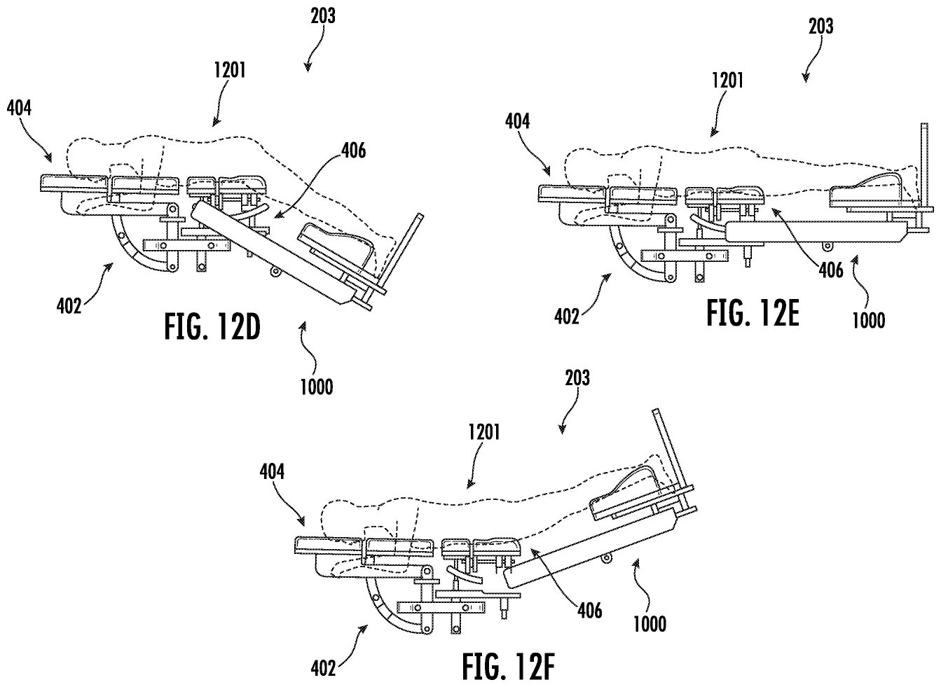

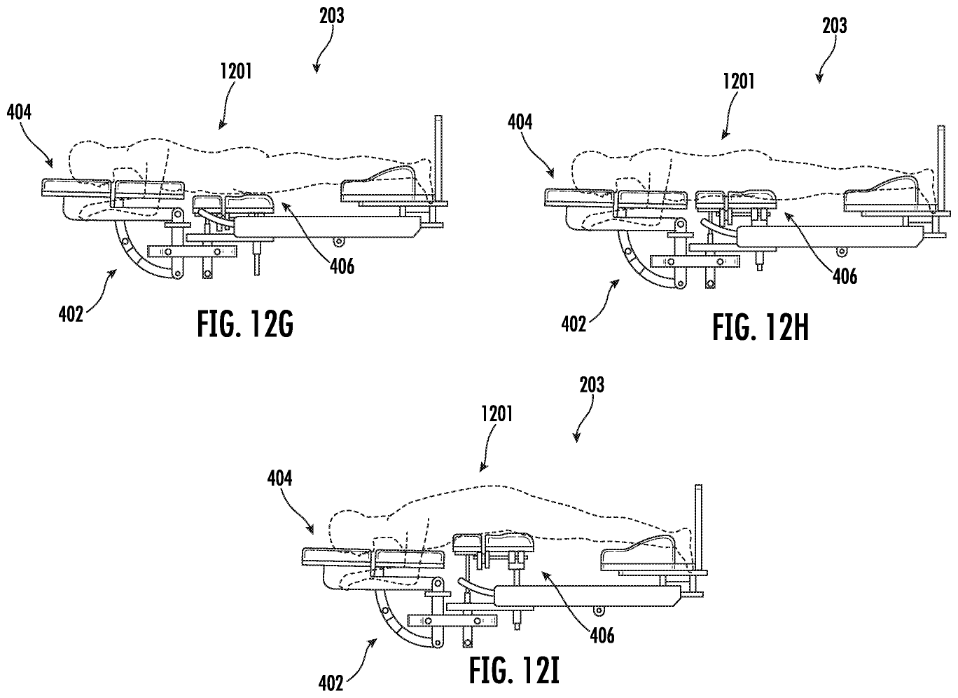

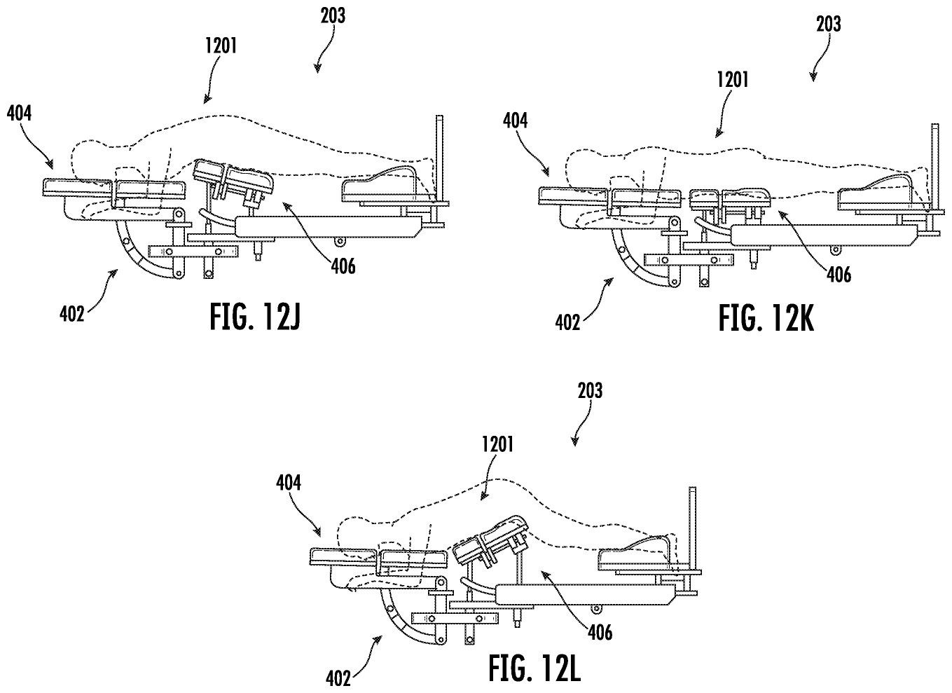

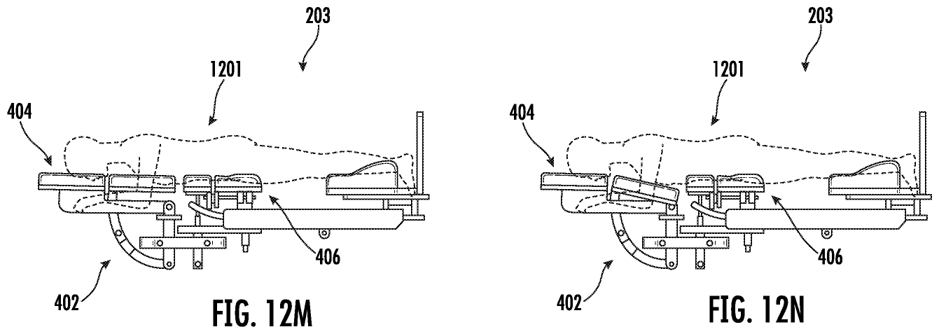

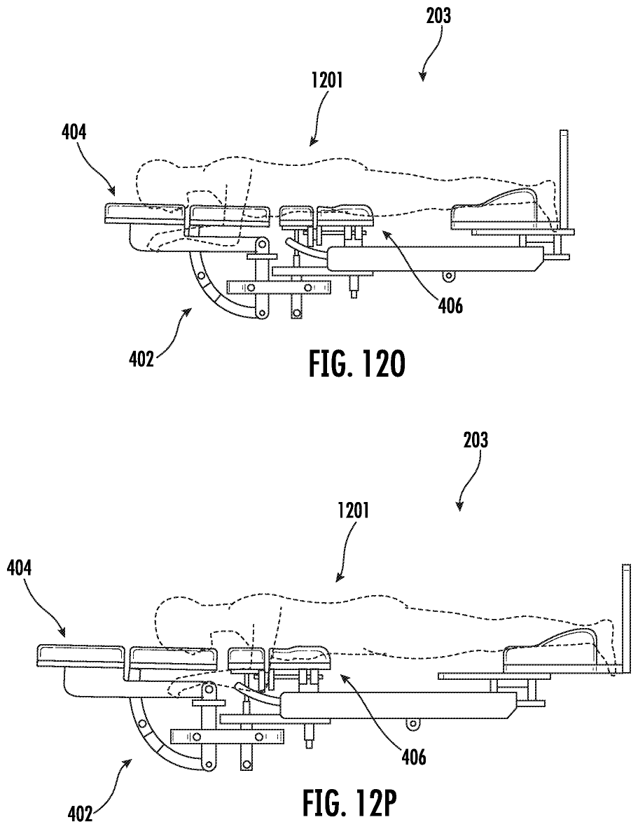

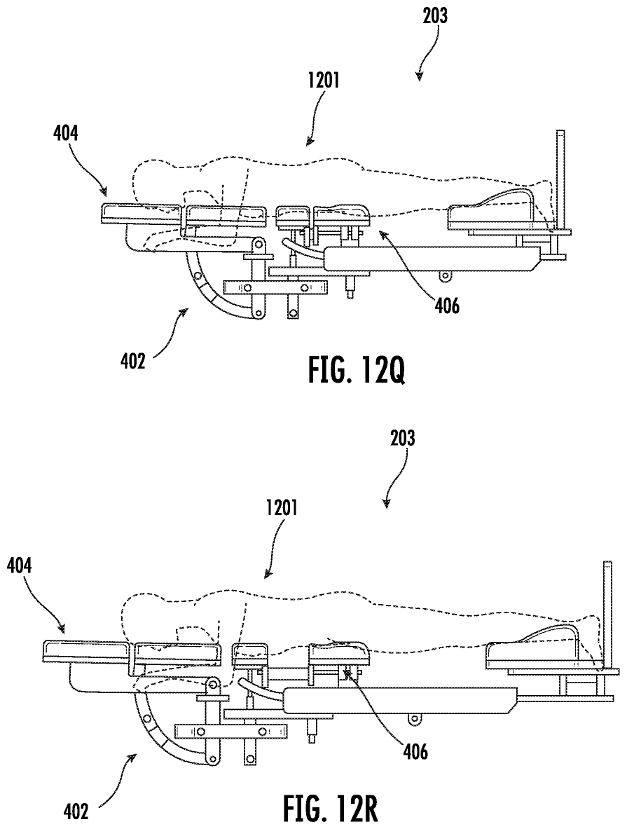

FIGS. 12A-12R illustrate a patient 1201 utilizing the table section 203 to achieve examples of such motions. FIGS. 12A-12C show thoracic extension and flexion by pivoting the thoracic subassembly 404. FIGS. 12D-12F show leg rotation about the X-axis in flexion (elevation) and extension (lowering) by pivoting the leg portion of the lumbar, pelvis and leg subassembly 406. This may be used for moving the spine into flexion or extension, which is important for various treatment procedures as well as 3D spine pre-treatment positioning derived from input from 3D scanner sources. FIGS. 12G-12I show up and down motion of the lumbar and pelvis by changing the elevation of the lumbar and pelvis portions of the lumbar, pelvis and leg subassembly 406. FIGS. 12J-12L show lumbar and pelvis rotation, also referred to as pelvic tilt, via independent elevation of lumbar and pelvis portions of the lumbar, pelvis and leg subassembly 406. FIGS. 12M and 12N show chest plate abduction or lowering, by rotation of the table support and pivot subassembly 402, release of a thoracic cushion by rotation of a chest portion of the thoracic subassembly 404, unlocking a cushion support sub-frame, etc. FIGS. 12O and 12P show traction applied by extension of the thoracic subassembly 404. FIGS. 12Q and 12R show traction applied by extension of the leg section of the lumbar, pelvis and leg subassembly 406.

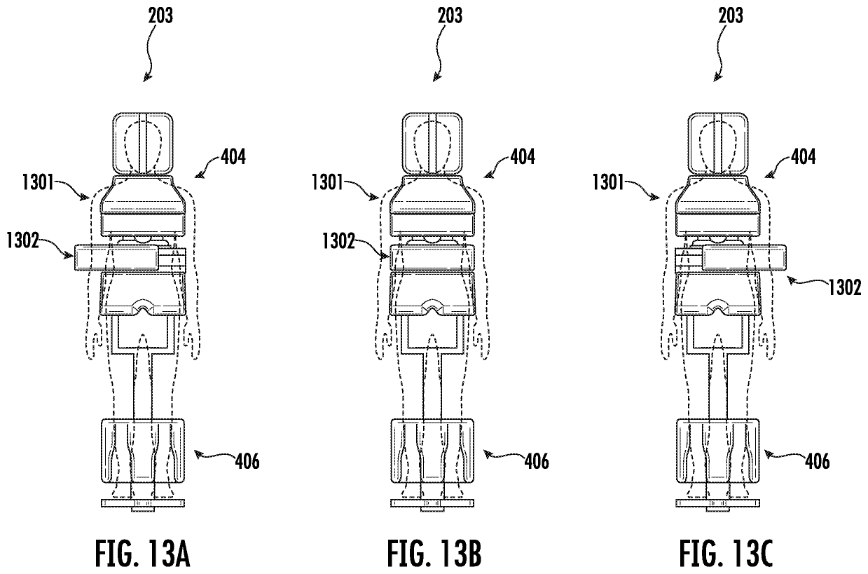

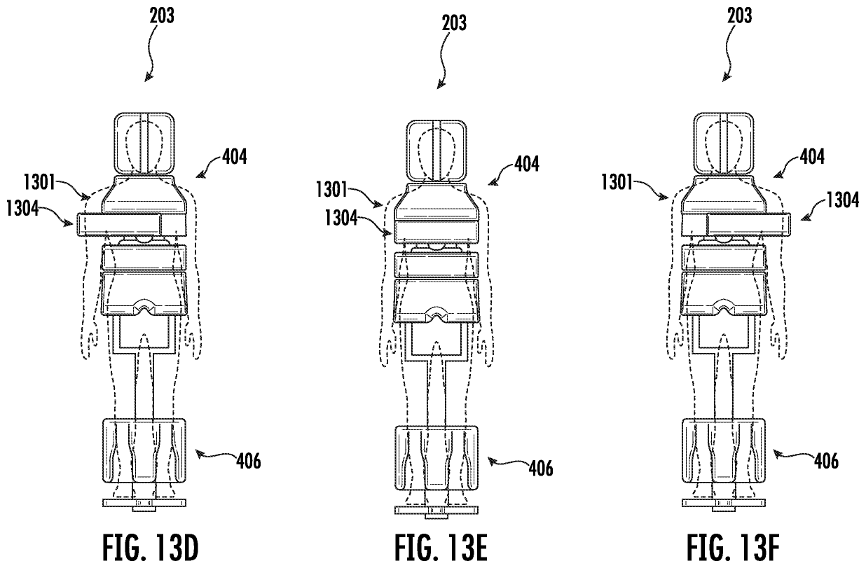

FIGS. 13A-13I illustrate a patient 1301 utilizing the table section 203 to achieve additional examples of such motions. FIGS. 13A-13C show lumbar lateral slide by shifting a lumbar support cushion 1302 left and right to accommodate and/or correct scoliosis curvature of the patient 1301. FIGS. 13D-13F show thoracic lateral slide by shifting a thoracic support cushion 1304 left and right to accommodate and/or correct scoliosis curvature of the patient 1301. The head and thoracic sections of the thoracic subassembly 404 may be configured to rotate and translate independent of one another. As shown in FIGS. 13D-13F, for example, the thoracic support cushion 1304 is configured to translate left and right independent of head cushions of the thoracic subassembly 404. FIGS. 13G-13I show lateral leg rotation by rotating the lumbar, pelvis and leg subassembly 406 of the table section 203. While FIGS. 13G-13I illustrate the leg section of the lumbar, pelvis and leg subassembly 406 moving together with the lumbar and pelvis section where the lumbar pad 1306, pelvis pad 1308 and leg pad 1310 move together, it should be appreciated that in other embodiments the leg section (e.g., leg pad 1310) may be configured for rotation independent of the lumbar and pelvis section (e.g., lumbar pad 1306 and pelvis pad 1308). Further, the lumbar section and the pelvis section may move independent of one another during lateral leg rotation (e.g., the pelvis section including pelvis pad 1308 may move together with the leg section including leg pad 1310, each of the lumbar, pelvis and leg sections including lumbar pad 1306, pelvis pad 1308 and leg pad 1310 may move independent of one another, etc.). It should be appreciated that the lateral leg rotation, in some embodiments, may be accompanied by simultaneous lumbar and pelvis support pad rotation (e.g., of the lumbar pad 1306 and pelvis pad 1308) to effect a greater therapeutic effect and promote ease of spine bending. Such lateral shifting of the cushions or support pads shown in FIGS. 13A-13I may be enabled by multiple sections or slides of each cushion or pad (e.g., 1302, 1304, 1306, 1308, 1310), and may include any combination of thoracic, lumbar and pelvic sections of a patient support frame.

X-axis translation of pads are part of solutions for scoliosis reduction systems and sciatic scoliosis side shifting phenomenon associated with pain and disc herniation. Manual therapies used to treat scoliosis involve hand placing blocking on the floor or flat treatment tables. These traditional blocking techniques are imprecise and difficult to repeat. The X-axis translation shown in FIGS. 13A-13I are controlled to be positionally accurate and repeatable by a control system as described elsewhere herein. Sensors or indicators may be used to identify the degree of lateral shifting during right or left X-axis translation of the cushion assemblies, including cushions of the thoracic subassembly. The degree of lateral shifting may be provided as input to a control system (e.g., automated or manual input). This is useful for 3D scanning protocols, which allow mimicking of spinal distortion pretreatment. This is also useful for structural spinal distortion reductions of lateral scoliosis adherent curvatures, as reducing the degree of lateral shift in precise incremental and measurable degrees accompanied by simultaneously applied decompression and mobilization through additional table assembly motions.

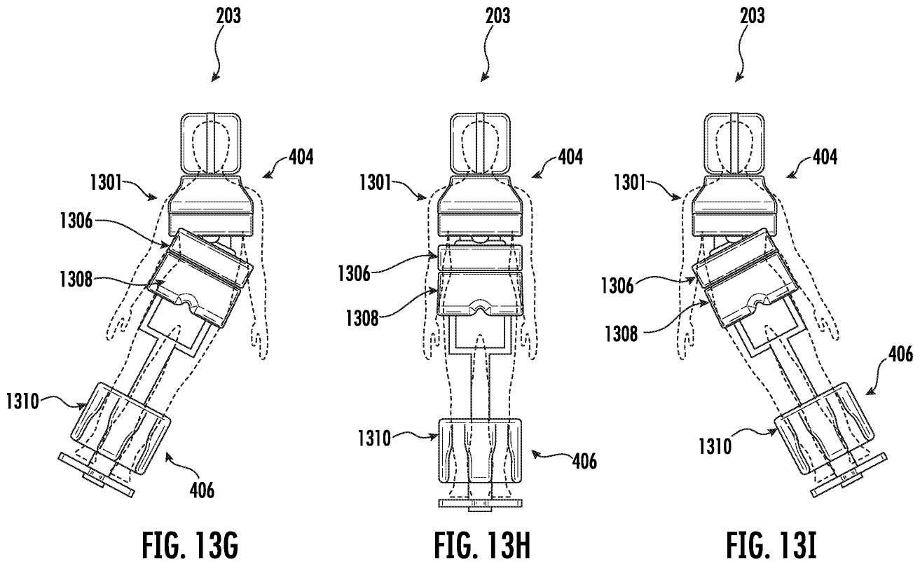

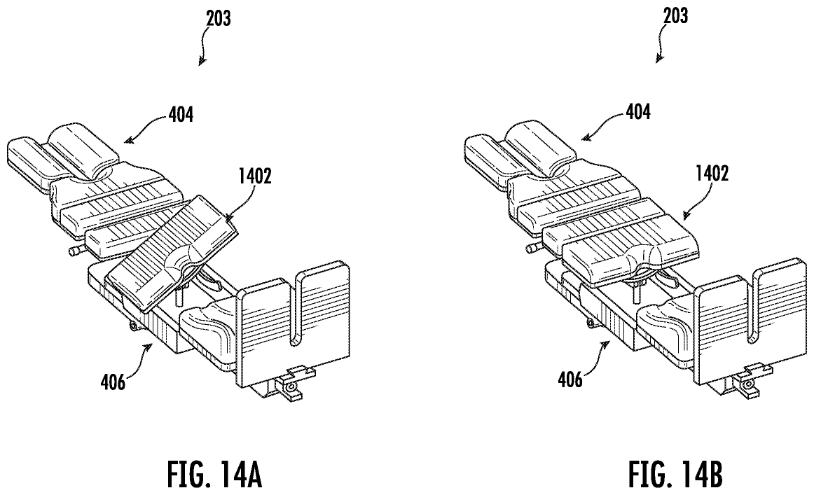

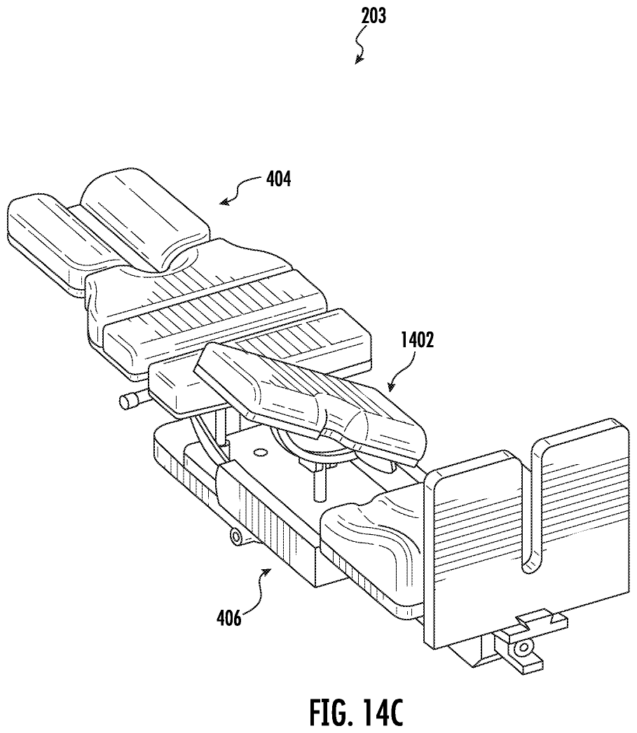

FIGS. 14A-14C illustrate utilizing the lumbar, pelvis, and leg subassembly 406 of the table section 302 to achieve rotation of the spine of the patient along the Y-axis. More particularly, FIGS. 14A-14C show pelvis rotation by rotating a pelvis support pad 1402 as illustrated. It should be appreciated that various combinations of the movements shown in FIGS. 12A-12R, 13A-13I and 14A-14C, as well as other movements described elsewhere herein, may be combined with one another so as to effect a desired treatment.

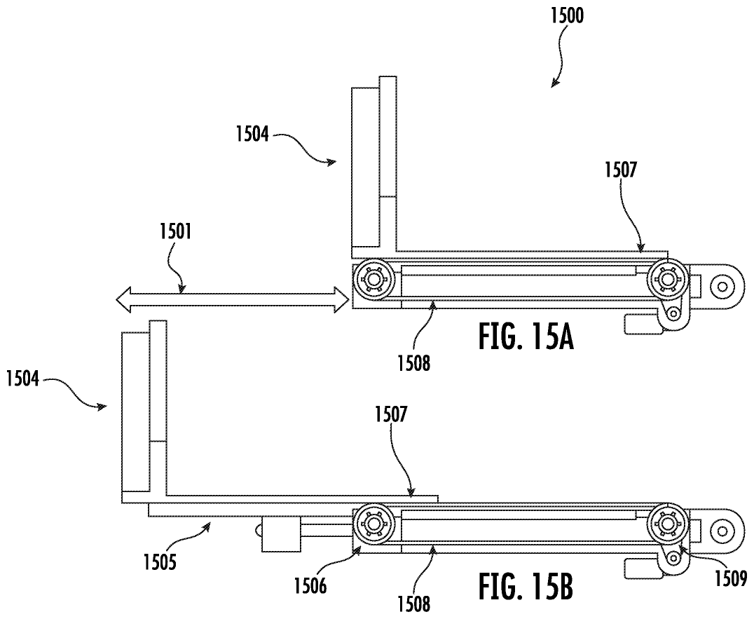

FIGS. 15A and 15B show extension of a leg section 1500 of a lumbar, pelvis and leg subassembly, such as the lumbar, pelvis and leg subassembly 406 suitably modified to replace leg extension actuators 1008 with a leg extension belt 1508 for achieving extension 1501 (e.g., up to or exceeding 21 inches in length in some embodiments) of a folding step platform 1504 and leg or foot pads 1102-1 and 1102-2, which is similar to the folding step platform 1004 described above.

In some embodiments, the leg extension belt 1508 is attached to the folding step platform 1504 at an attachment point 1507. As the leg extension belt 1508 is translated due to counterclockwise rotation of a drive pulley 1509, the folding step platform 1504 is extended due to the translation of the attachment point 1507.

In other embodiments, the folding step platform 1504 has a rack gear along surface 1505. As a pinion gear on the shaft of the pulley 1506 rotates counterclockwise due to counterclockwise rotation of the drive pulley 1509, the folding step platform 1504 is extended.

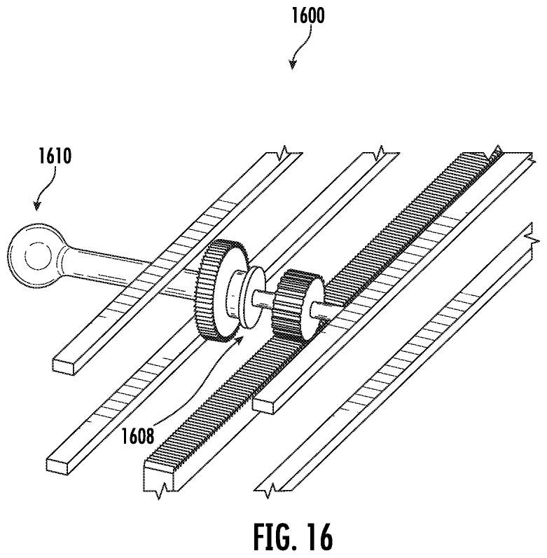

FIG. 16 shows another alternative to the leg extension actuators 1008 described above. In the FIG. 16 embodiment, a leg section 1600 includes a rack and pinion driven mechanism 1608 for providing extension of a foot rest platform (not shown). The rack and pinion drive extension mechanism 1608 includes a manual release 1610 to allow for manual adjustment of the leg position. The manual release can be used in other embodiments having pinion gears.

Treatment tables described herein may undergo various motions for applying treatment or therapy to a patient. Provided below are examples of such therapies, along with details regarding associated type, extent (e.g., range of motion), method of actuation, controls, etc. It should be appreciated, however, that these are just examples, and that treatment tables are not limited to use solely with these specific therapies or with these particular parameters (e.g., ranges of motion). In the below examples, the Y-axis reference point is the center of the lumbar pad, which is assumed to be aligned with the L3 lumbar spine vertebrae area of the patient. Lateral translation or shift is relative to the centerline (e.g., X-axis reference). The Z-axis reference is the patient platform plane (e.g., defined by the torso pad in a neutral position, with lumbar and pelvic pads retracted “in” and leg supports at 0 deg). Angles are measured relative to the patient platform plane.

Lower body therapy motions include leg decompression (e.g., including leg length adjustment), friction free pelvis slide (e.g., to accommodate leg decompression), leg flexion and extension (e.g., up and down), leg lateral flexion and extension, pelvis rotation, pelvic lateral shift, lumbar in and out, pelvic and lumbar tilt, lumbar rotation, and lumbar lateral shift.

Leg decompression includes translation along the Y-axis, to an extent of about 21 inches (in). Leg decompression may be power actuated with an optional manual override. The leg decompression may be set up for a nominal patient length.

Pelvis slide includes translation along the Y-axis, to an extent of about 6 in (from neutral). Pelvis slide may be passively actuated with a low resistance automatic return.

Leg flexion and extension includes rotation about the X-axis, to an extent of about 20 deg up and about 30 deg down. Leg flexion and extension may be power actuated.

Leg lateral flexion and extension includes rotation about the Z-axis, to an extent of about 45 deg plus and minus. Leg lateral flexion and extension may be power actuated, or power actuated with a manual override. During lateral flexion and extension, the pelvic and lumbar pads rotate with the legs about the Z-axis.

Pelvic rotation includes rotation about the Y-axis, to an extent of about 20 to 30 deg plus and minus. Pelvis rotation may be power actuated, or power actuated with a manual override.

Pelvic lateral shift includes translation along the X-axis, to an extent of about 4 in plus and minus. Pelvic lateral shift may be non-powered actuated in steps or increments (e.g., 0.25 in steps) with a manual release (e.g., on one or both sides of the patient) and capable of being locked into desired position.

Lumbar in and out movement includes translation along the Z-axis, to an extent of about 0 in in and 3.5 in out. Lumbar in and out movement may be power actuated.

Pelvic and lumbar tilt includes rotation about the X-axis, to an extent of about 30 deg up. Pelvic and lumbar tilt may be power actuated. The pelvic and lumbar tilt may be “up-tilt” only (e.g., lower edge), in some cases with lumbar in.

Lumbar lateral shift includes translation along the X-axis to an extent of about 4 in plus and minus. Lumbar lateral shift may be power or non-power actuated in steps (e.g., 0.25 in steps) with a manual release (e.g., on one or both sides of the patient).

Upper body therapy motions include thoracic decompression, torso flexion and extension (e.g., up and down), torso lateral flexion, torso lateral shift, arm support height motion, arm support rotation (e.g., “clamp”), and overhead support height motion.

Torso decompression includes translation along the Y-axis. Torso decompression may be power or manual actuated.

Torso rotation includes rotation about the Y-axis. Torso rotation may be power or manual actuated.

Torso flexion and extension includes rotation about the X-axis, to an extent of about 10 deg up and 10 deg down. Torso flexion and extension may be non-power actuated in steps (e.g., 5 deg steps). The actuation of torso flexion and extension may be controlled with a manual spring pin.

Torso lateral flexion and extension includes rotation about the Z-axis, to an extent of about 30 deg plus and minus. Torso lateral flexion and extension may be power actuated with a manual override to provide a pivot about 10 in from a leg pivot location.

Torso lateral shift includes translation along the X-axis, to an extent of about 4 in plus and minus. Torso lateral shift may be non-power actuated in steps (e.g., 0.25 in steps) with a manual release (e.g., on one or both sides of the patient).

Arm support height motion includes translation along the Y-axis, to an extent of about 4 in (e.g., 15-19 in height from the base). Arm support height motion may be power actuated with patient setup parameters.

Arm support rotation includes rotation about the Y-axis, to an extent of “open” (forward) and “closed.” Arm support rotation may be non-power actuated in steps using a manual ratchet pawl control. The arm support rotation may be independent for each arm of the patient.

Overhead bar or support height motion includes translation along the Y-axis, to an extent of about 9 in (e.g., over a range that includes the arm support height). The overhead support height motion may be non-power actuated in steps (e.g., 0.5 in steps) using a manual spring pin control.

It should be noted that in some embodiments, it is desired to have the overhead support height motion (and other ones of the upper and lower body motions described as being non-power actuated) be power actuated for convenience, though at added complexity (e.g., in weight, cost, relative ease of manufacturability, etc.). In other embodiments, it may be desired to have various of the upper and lower body motions described as power actuated be non-power actuated to lower complexity.

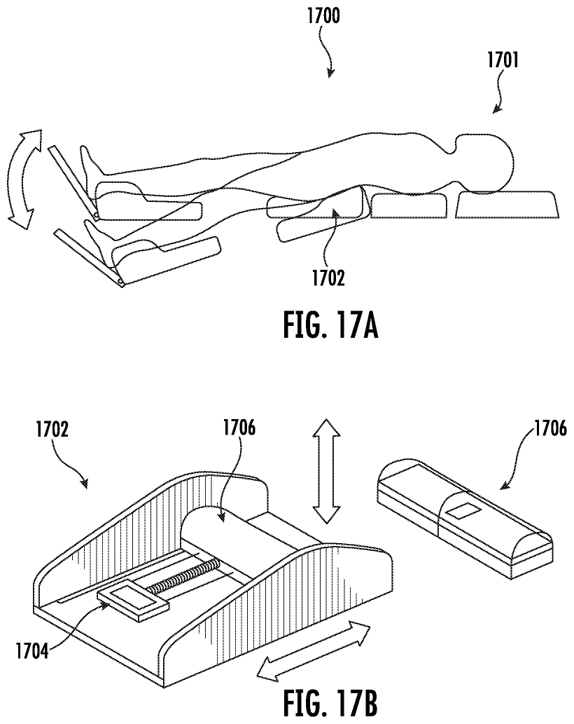

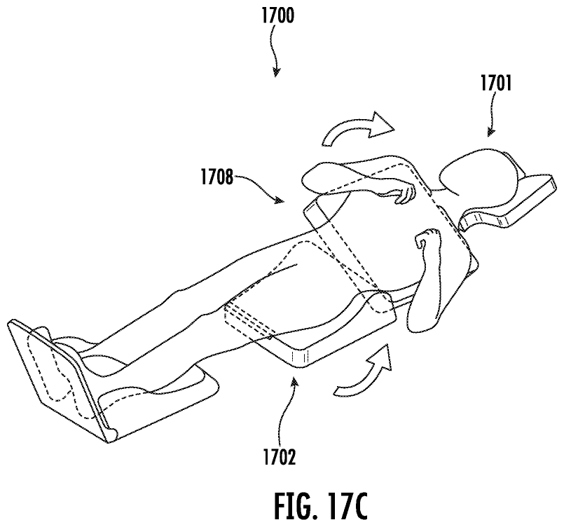

FIGS. 17A-17C show modular lumbar and pelvic support pads or cushions of a treatment table 1700, along with rotation of portions of the treatment table 1700. FIG. 17A shows a user 1701 on the treatment table 1700. More particularly, FIG. 17A illustrates how support pads or cushions of the treatment table 1700 may be modular. For example, FIG. 17A shows a transparent view of a pelvis support pad or cushion 1702 that is movable in any or all of six degrees of freedom providing rotation (e.g., up and down) of the legs of the patient 1701. As shown in FIG. 17B, the pelvis support pad 1702 may include a track mechanism 1704 to facilitate such movement. Further, the pelvis support pad 1702 is configured with removable or modular cushions 1706. The modular cushions 1706 shown in a transparent view may have internal movable parts to allow varying levels of support. Internal movable parts of the modular cushions 1706 may also be replaced or supplemented with a unit that provides additional functionality, such as a heat source, infrared, vibration, shiatsu massage, deep tissue massage, etc. These additional functionalities may be controlled by a control system of the treatment table 1700 to be sequenced as the practitioner or patient chooses. Other support pads or cushions of the treatment table 1700 may similarly be modular, and include internal parts supplemented to provide heat, infrared, vibration, massage elements, etc. FIG. 17C, for example, illustrates a thoracic pad 1708 that is modular and rotatable (e.g., independent of other cushions or support pads of the thoracic subassembly 404, independent of cushions or support pads of the lumbar, pelvis and leg subassembly 406, etc.). It should be further noted that modular support pads or cushions may be utilized with any of the treatment tables described herein. More generally, it should be appreciated that any feature described with respect to a particular figure or embodiment may be combined or utilized in any other embodiment unless otherwise noted.

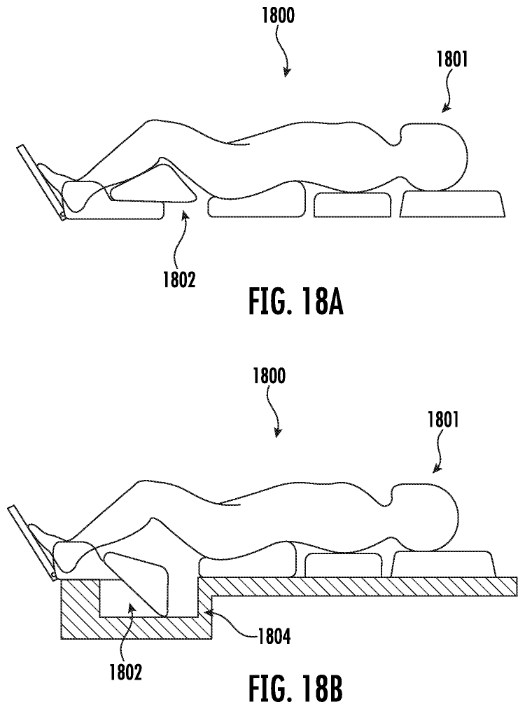

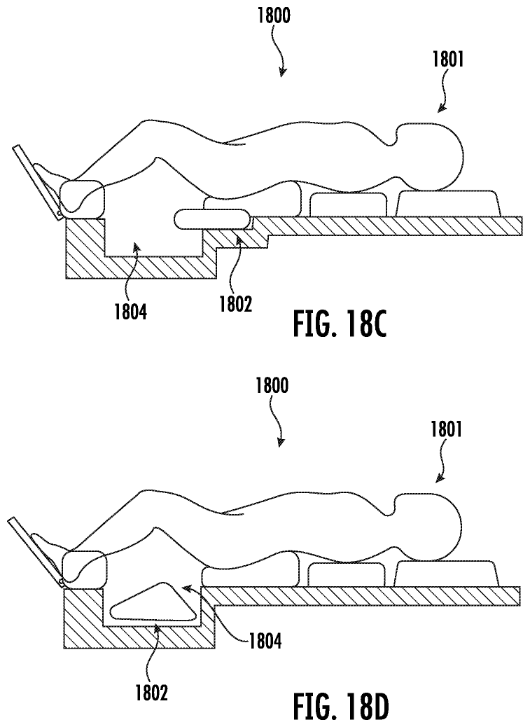

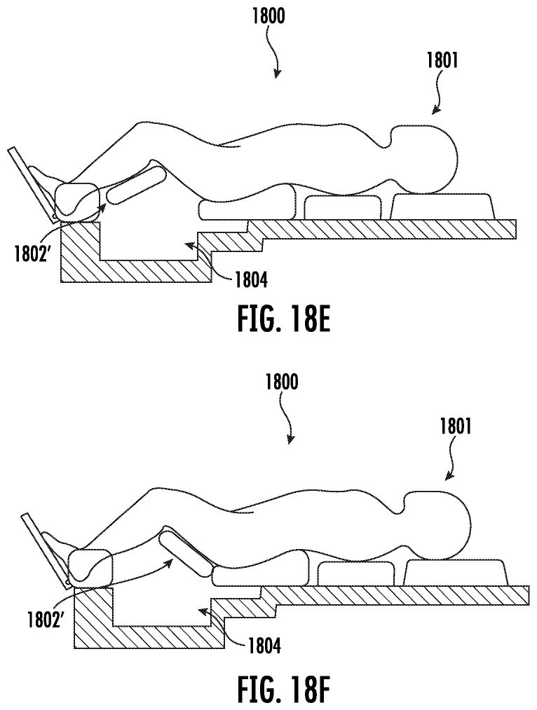

FIGS. 18A-18G show an insertable cushion that may be used with a treatment table 1800. FIGS. 18A-18G show a user 1801 on the treatment table 1800, with the insertable cushion, where the insertable cushion is shown as a wedge-shaped cushion 1802 (e.g., in FIGS. 18A-18D) or a substantially flat cushion 1802′ (e.g., in FIGS. 18E-18G), at different positions. As shown in FIG. 18A, the wedge-shaped cushion 1802 is used for knee rest or support of the user 1801. The wedge-shaped cushion 1802 may be removable, or may be integrated within a recess 1804 of the treatment table 1800 so that it can be lowered, hinged or slid out of the way for treatments that do not utilize the wedge-shaped cushion 1802 for support as shown in FIGS. 18B-18D. The wedge-shaped cushion 1802 may be selectively positioned to elevate the knees and/or thighs of the patient. FIGS. 18E-18G show the substantially flat cushion 1802′ raised or slid out of the recess 1804 and positioned for different treatments. The knee support pad 1102-4 shown in FIGS. 11I and 11J may be shaped and deployed as shown in FIGS. 18A-18G.

FIGS. 19A and 19B show a treatment table 1900. As shown in FIG. 19A, the treatment table 1900 includes underarm supports 1902 and a control system 1904. The underarm supports 1902 can translate 1906 and swing away 1908, either independently or in unison with one another. The control system 1904 is configured to swing out 1910 about an axis, and to telescope 1912. The control system 1904 is illustratively shown as a display (e.g., providing a touchscreen control interface) that is attached to a telescoping arm that can also swing out. FIG. 19B shows an alternative control system 1904′ (also in the form of a display providing a touchscreen control interface) that is attached to a rail 1914 that it can slide along. The touchscreen control interface of control systems 1904/1904′, in some embodiments, is used as the primary controls for setting up treatment and enabling other features including various automated, semi-automated and manual controls described herein. In some embodiments, certain elements of the control system may be distributed within the treatment table or located in a separate control room. For example, portions of a control system as described herein may include various actuators, sensors, and other mechanisms used to control movement of different portions of a treatment table. Thus, in any treatment table described herein, where a control system is not separately labeled with its own element number should be considered as represented using actuators, guides, tracks, four-bar mechanisms, etc. used to achieve movement of different portions of the treatment table.

The control systems 1904/1904′ may be wired to the treatment table 1900, or may wirelessly connect to the treatment table 1900. Although illustrated as being mounted to the treatment table 1900 in FIGS. 19A and 19B, the control systems 1904/1904′ may be removable, or may be remote from the treatment table 1900. The various automated table movements described herein, as well as locking and unlocking of manual features, can be controlled using the touchscreen control systems 1904/1904′. It should be appreciated that the touchscreen of control system 1904/1904′ may be replaced or supplemented with other types of control interfaces, including buttons, switches, joysticks, etc. Additionally, the touchscreen or another independent screen may be visible to the patient to provide educational instructions or video to provide feedback.

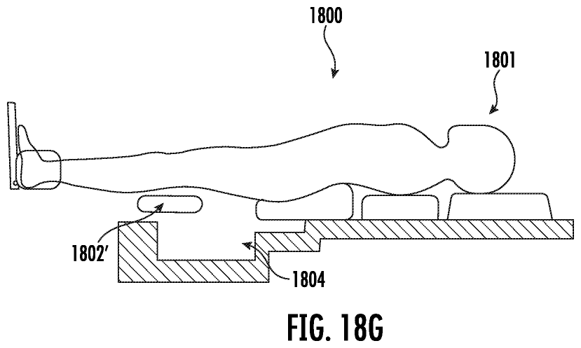

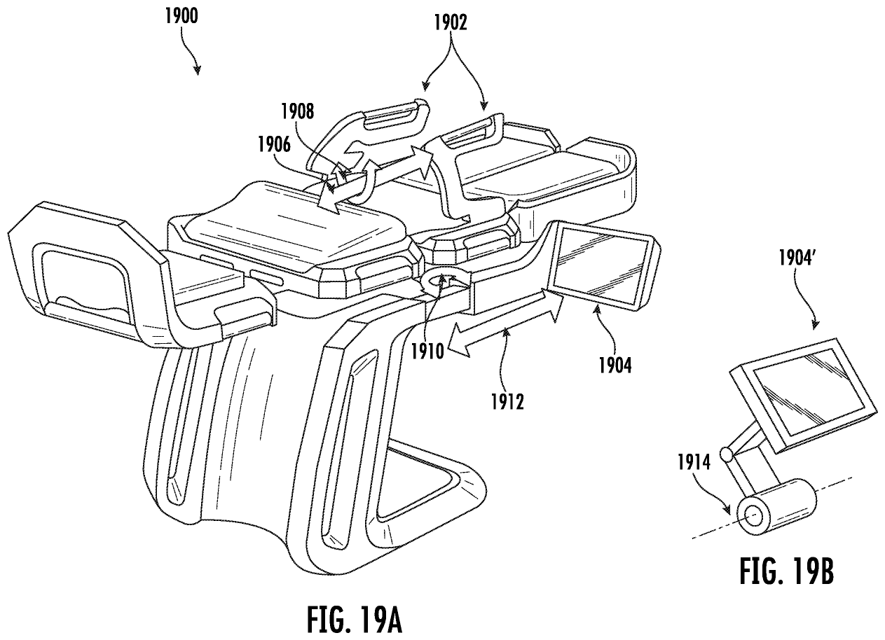

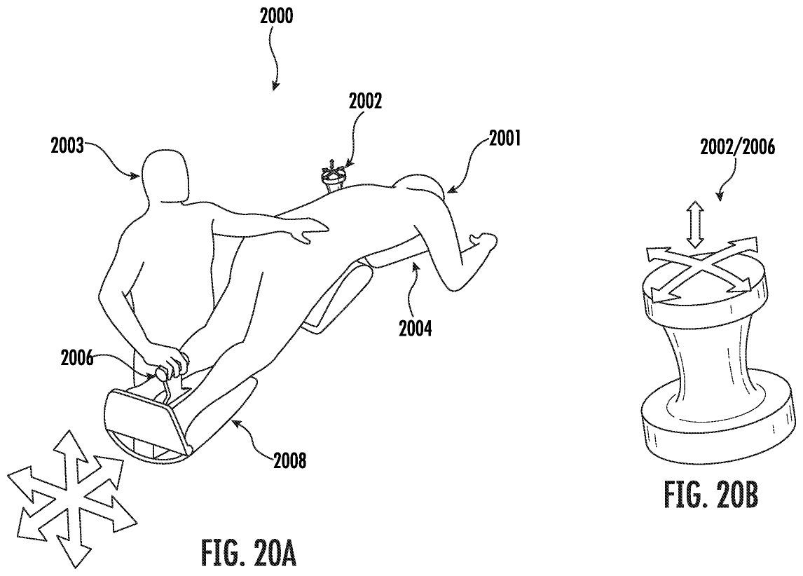

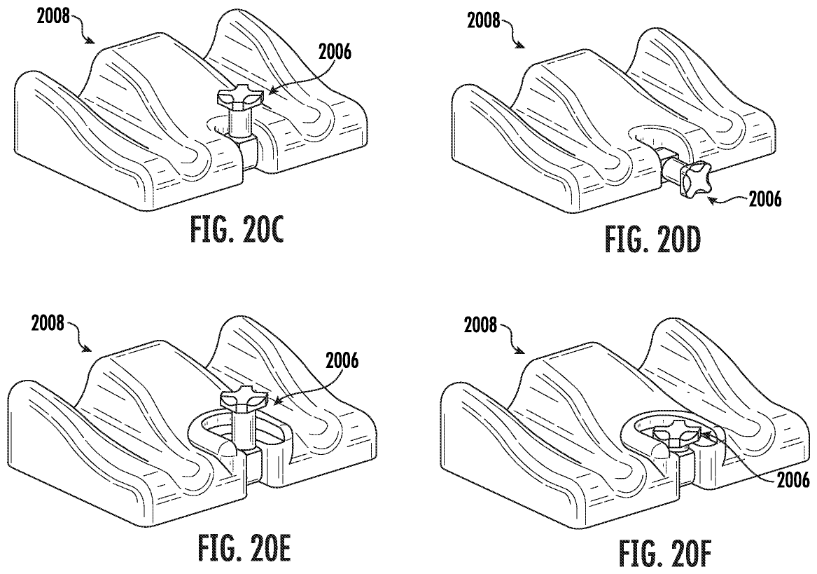

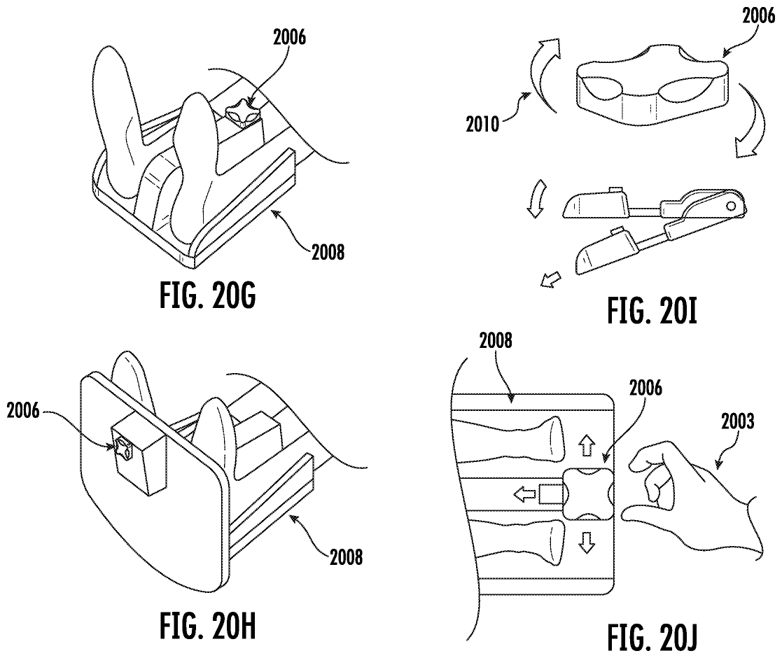

FIGS. 20A-20J show a treatment table 2000 configured with joystick controls 2002 and 2006. The joystick controls 2002 and 2006 may be utilized in conjunction with other controls of a device, such as touchscreen control interfaces, buttons, switches, etc. FIG. 20A shows a patient 2001 on the treatment table 2000, with a practitioner 2003 controlling the treatment table via joystick controls 2002 and 2006. The joystick control 2002 more particularly controls a thoracic section 2004 of the treatment table 2000, while the joystick control 2006 controls the leg section 2008 of the treatment table 2000. FIG. 20B shows a close-up view of the joystick controls 2002 and 2006. Although FIG. 20A shows an embodiment where there are two joystick controls 2002 and 2006, in other embodiments there may be more or fewer than two joysticks for controlling table movements of a treatment table. It should be appreciated that the particular number of joystick controls, functionality of such joystick controls, as well as the placement or location of such joystick controls on the treatment table 2000 may vary as desired. For example, joystick controls may be placed at various locations of a patient rotating platform, on an attached pedestal of the treatment table 2000, on a non-rotating subassembly of the treatment table 2000, on a separate remote or other controller, etc.

Each of the joysticks 2002 and 2006 has multiple functions, as shown by the arrows, plus additional commands for controlling table movements of the treatment table 2000 by tilting, translating or pressing buttons of the joysticks 2002 and 2006. In some embodiments, the joysticks 2002 and 2006 are preferably on the associated movable parts (e.g., the thoracic section 2004 and leg section 2008, respectively) and act as an extension of the hands of the practitioner 2003 (e.g., where the hand guides the movement). The joysticks 2002 and 2006 may be selectively locked by the practitioner 2003 so that one or both can be used as a rigid handle to manually provide movement of the associated treatment table element (e.g., the thoracic section 2004 and leg section 2008). The thoracic section 2004 and leg section 2008 may provide variable resistance to movement by the practitioner. The variable resistance could be greater the more the practitioner moves the element, or as another function (e.g., triangular, exponential, logarithmic, etc.) related to the amount of the movement. The control point can be switched between the different joysticks 2002 and 2006 to accommodate practitioner 2003 preference. For example, a given practitioner may be more comfortable using the joystick 2002 near the thoracic section 2004 to manipulate the leg section 2008, and can switch the control point from joystick 2006 to joystick 2002 as desired. Changing the control point may be done on the fly. The joysticks 2002 and 2006 may be positioned in a fixed position connected to a stationary part of the treatment table 2000, or may be on a separate pedestal, base unit or external controller, or handheld.

The joysticks 2002 and 2006 can be shaped as shown in FIGS. 20A-20J. In some embodiments, the joysticks 2002 and 2006 are configured to move out of the way to facilitate the patient 2001 getting onto the treatment table 2000 (e.g., to avoid discomfort of the patient 2001, to prevent damage to the joysticks 2002 and 2006, etc.). FIGS. 20C-20F show examples of how the joystick 2006 can be moved out of the way, such as by shortening the joystick 2006, folding the joystick 2006, retracting the joystick 2006 into a recess, etc. Similar mechanisms may be provided for joystick 2002.

FIGS. 20G-20J illustrate alternate joystick locations and movement of the joystick 2006 and corresponding movement of the leg section 2008 of the treatment table 2000.

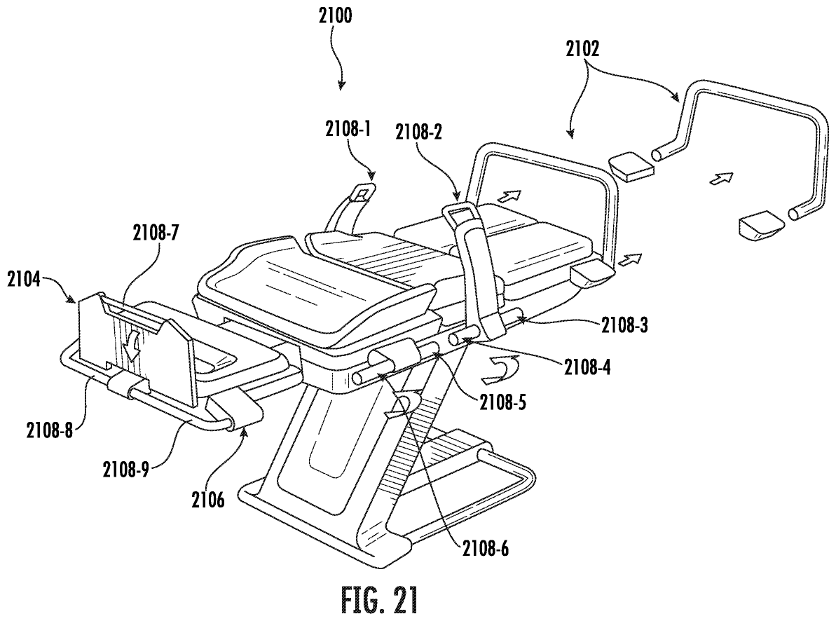

FIG. 21 shows a treatment table 2100, including an adjustable and removable overhead bar 2102, a folding step platform 2104 configured to swing down and is lockable and able to support a patient's weight, a control interface 2106, and a set of control actuators 2108-1 through 2108-8 (collectively, control actuators 2108). The control interface 2106 may comprises a keypad or touchscreen configured to enable and disable functions of the treatment table 2100, to activate different protocols or treatments of the treatment table 2100, etc. The control actuators 2108 include push bar controls (e.g., in place of joysticks as illustrated with respect to FIGS. 20A-20J). The control actuators 2108 may be integrated into the underarm supports. The push bar control actuators 2108 can be moved in three orthogonal directions, plus in any or all rotational directions. The amount of force applied by the control actuators 2108 may be proportional to the speed of movement of the push bars. The control interface 2106 and control actuators 2108 may be placed at various locations on the treatment table 2100, or on a pedestal connected to the treatment table 2100, on a non-rotating subassembly of the treatment table 2100, on a separate remote or other controller for treatment table 2100, etc.

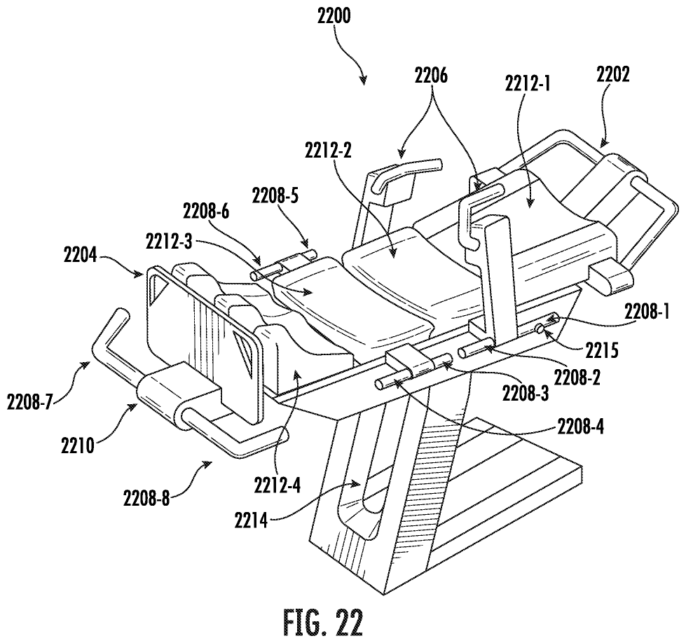

FIG. 22 shows a treatment table 2200 with an overhead bar 2202, a folding step platform 2204, underarm supports with handles 2206, control bar actuators 2208-1 through 2208-8 (collectively, control bar actuators 2208), and controls 2210. Additional button or switch controls 2215 may be added to control bar actuators to select additional functions. Additional buttons may also be placed on any hand holds the patient of user can access, such as overhead bar 2202 and the underarm supports with handles 2206. The overhead bar 2202 has a different configuration relative to the overhead bar 2102 of treatment table 2100. Further, the underarm supports 2206 are also provided, which may be removable. The control bar actuators 2208 provide functionality similar to those of the control bar actuators 2108, though their location is different. The treatment table 2200 of FIG. 22 also includes contoured pads 2212-1 through 2212-4 (collectively, contoured pads 2212) for comfort and support of a patient or user thereof. The base 2214 of the treatment table 2200 is a hollow column, thus making the treatment table 2200 appear less busy.

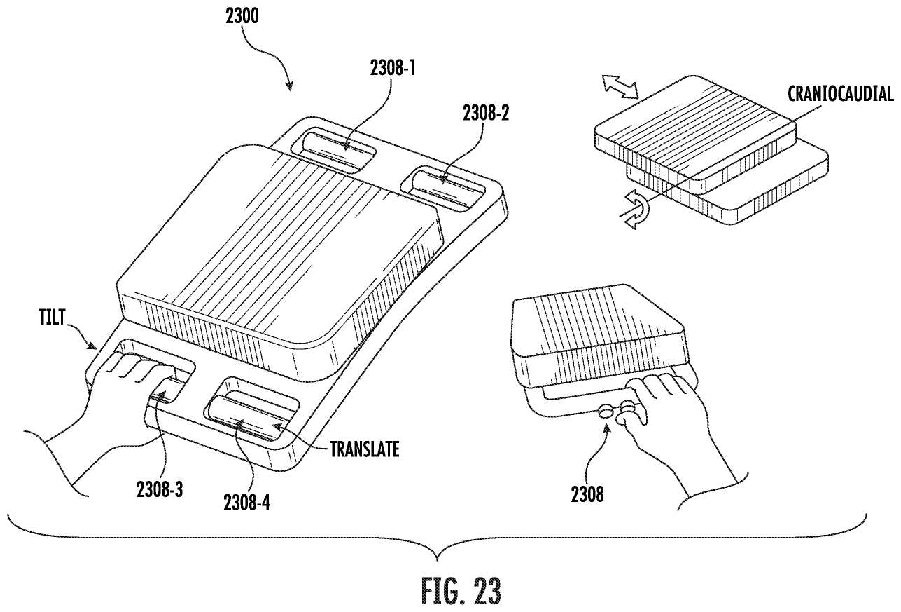

In some embodiments, push bar actuators 2108 and 2208 such as those described above with respect to the treatment tables 2100 and 2200 may be integrated into one or more cushions or support pads of a treatment table. FIG. 23 illustrates such an arrangement, with cushion or support pad 2300 and push bar control actuators 2308-1 through 2308-4 (collectively, push bar control actuators 2308) integrated therewith.

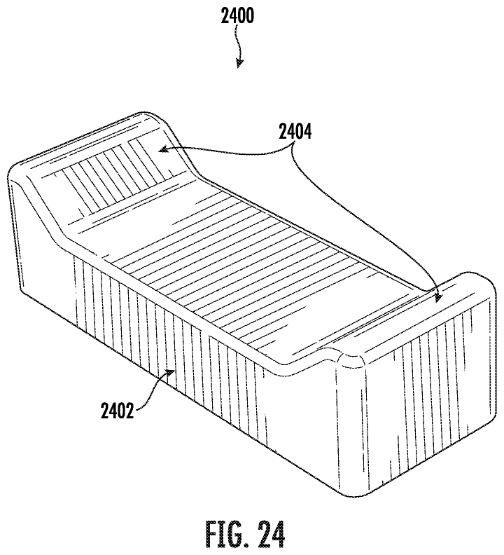

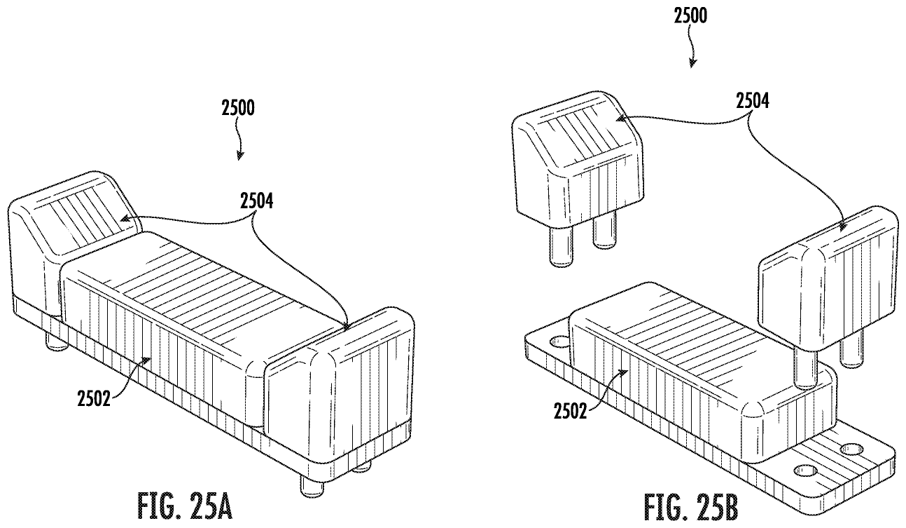

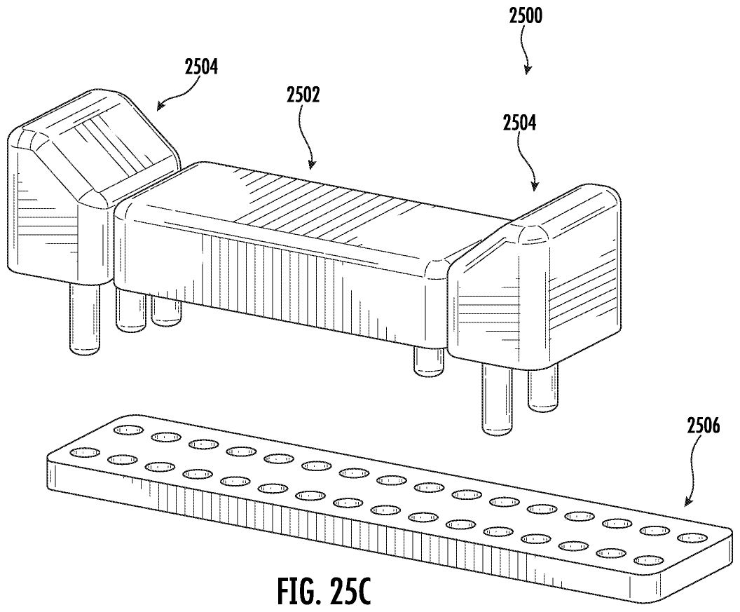

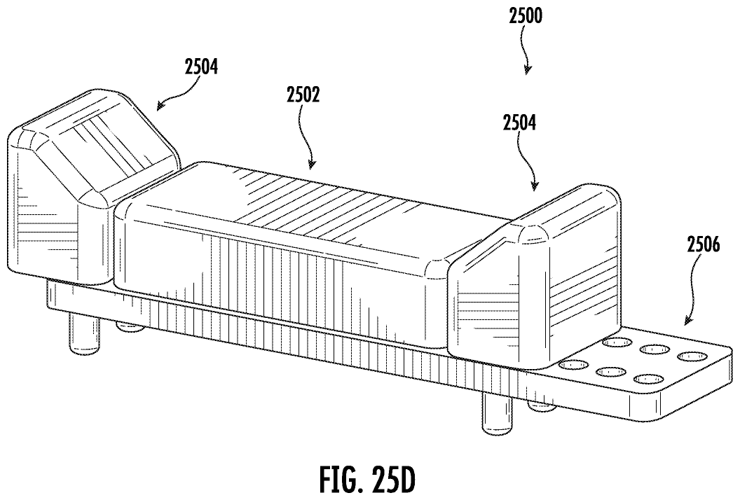

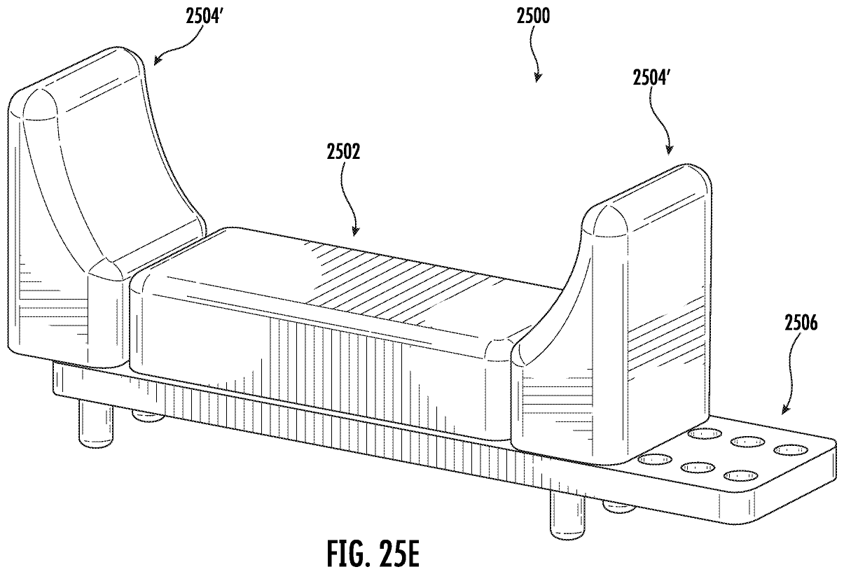

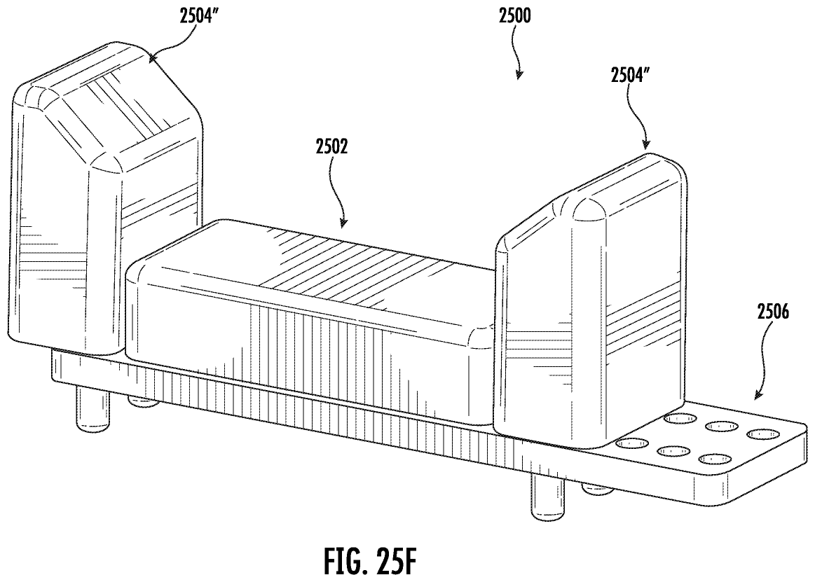

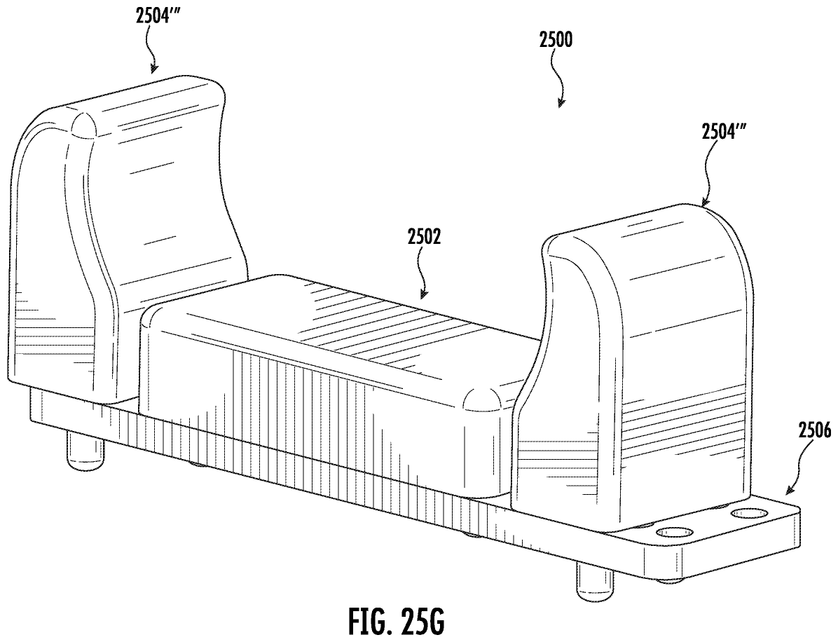

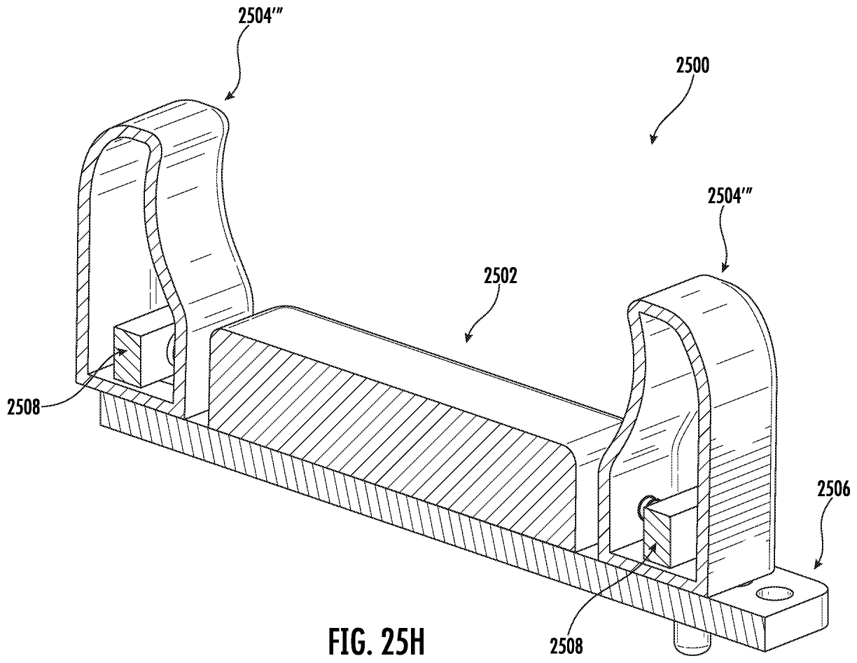

Cushions or support pads may have various shapes and designs. FIG. 24 shows a cushion or support pad 2400 with a built-in center pad 2402 and built-in side bolster pads 2404. Side bolsters provide lateral support of the patient for various treatments, especially those treatments that are facilitated by lateral movement of cushions. FIGS. 25A and 25B show a cushion or support pad 2500 with a built-in center pad 2502 and removable side bolster pads 2504. It should be appreciated that, in other embodiments, the center pads 2402, 2502 may also be made removable. FIG. 25C illustrates an embodiment where the center pad 2502 and side bolster pads 2504 are both removable from a pad support plate 2506, which includes various holes formed therein permitting modular attachment of the center pad 2502 and side bolster pads 2504 to any desired positions. FIG. 25D shows the center pad 2502 and side bolster pads 2504 inserted into holes of the pad support plate 2506. FIGS. 25E-25G illustrate different possible shapes for the side bolster pads 2504′, 2504″ and 2504′″. It should be appreciated that the center pad 2502 may also have different shapes (e.g., heights or thicknesses, with ridges or contours as desired). Further, different combinations of the center pad 2502 and side bolster pads 2504, 2504′, 2504″ and 2504′″ may be used. For example, a side bolster pad of a first type (e.g., side bolster pad 2504) may be used on a first side of the center pad 2502 while a side bolster pad of a second, different type (e.g., side bolster pad 2504′) may be used on a second side of the center pad 2502.

In some embodiments, the center pad 2502 and/or side bolster pads 2504 may be configured for spring-loaded attachment to the pad support plate 2506. FIG. 25H shows a cross sectional view of the side bolster pads 2504′″ of FIG. 25G, illustrating spring-loaded features 2508 for affixing the side bolster pads 2504′″ to the pad support plate 2506. FIG. 25I shows a top view of the pad support plate 2506 further illustrating the spring-loaded features 2508 for the side bolster pads 2504′″. Although FIGS. 25H and 25I show only the side bolster pads 2504′″ with spring-loaded features 2508, in other embodiments the center pad 2502 may also utilize spring-loaded features. It should be noted that pads with fixed or removable bolsters can be slid laterally along X-direction sliding mechanisms 912.

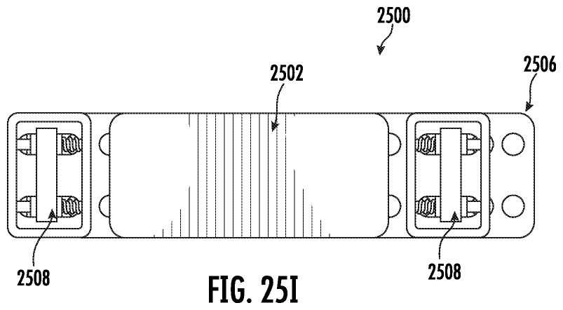

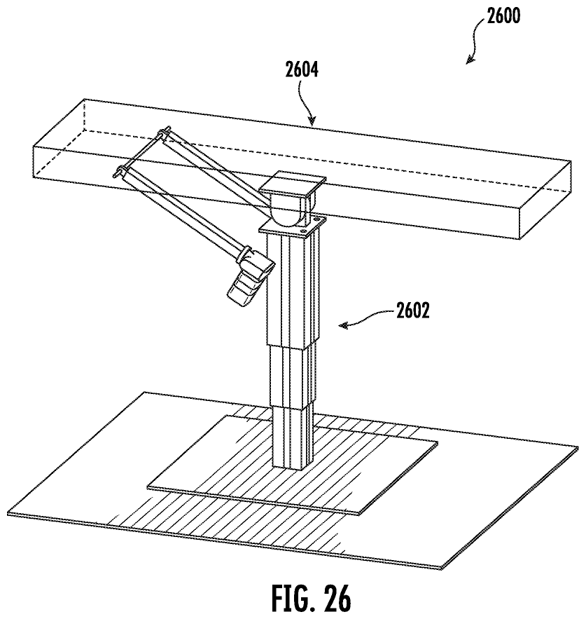

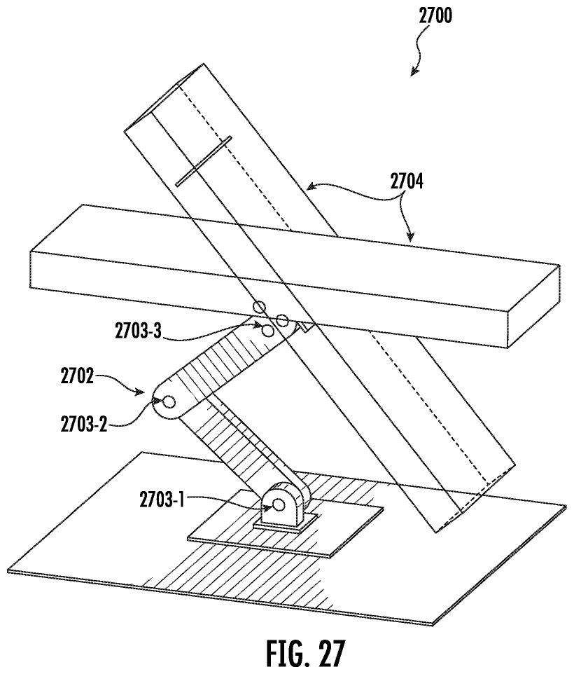

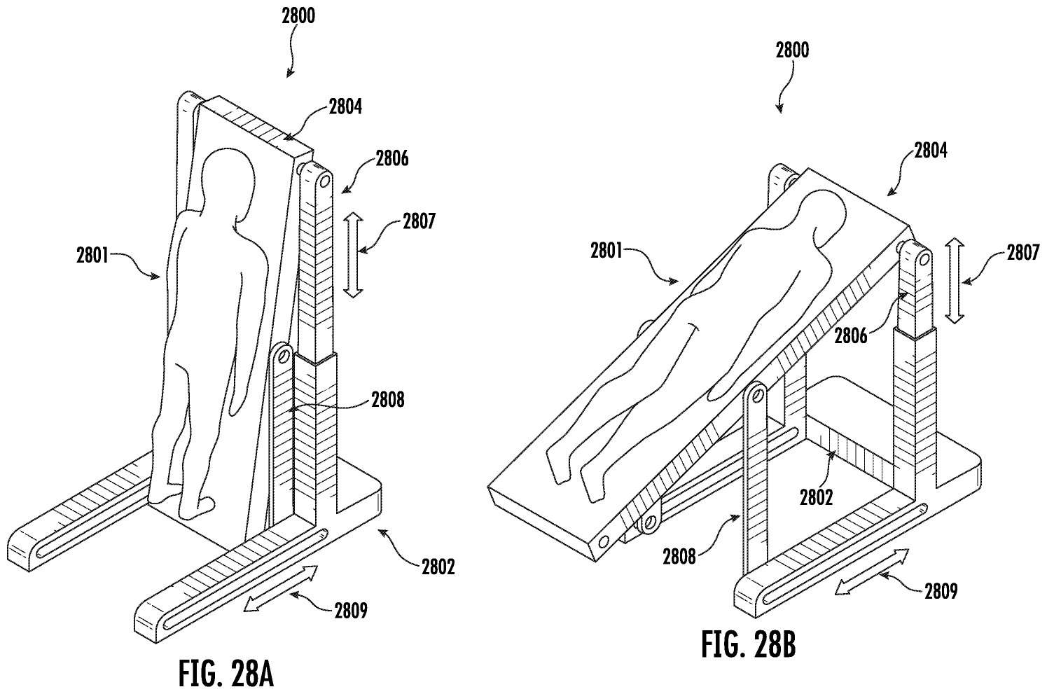

Although various embodiments are described above with respect to a treatment table that utilizes a four-bar mechanism in a base section to achieve tilt or rotation of a table section, embodiments are not so limited. FIG. 26 shows a treatment table 2600 that utilizes a telescoping pillar base 2602 to achieve lift and tilt of a table section 2604. FIG. 27 shows a treatment table 2700 that utilizes a robotic arm base 2702 to achieve lift and tilt of a table section 2704 by actuating rotation of sections of the robotic arm base 2702 about pivot points 2703-1, 2703-2 and 2703-3 (collectively, pivot points 2703). FIGS. 28A and 28B show a patient 2801 on a treatment table 2800 that includes a base section 2802 configured to tilt a table section 2804 utilizing first and second sets of sliding pillars 2806 and 2808. The sliding pillars 2806 are configured to slide up and down (e.g., in a telescoping fashion 2807) while the sliding pillars 2808 are configured to slide along a track front and back 2809 in the base section 2802. The sliding pillars 2808 can also be raised similar to the sliding pillars 2806 and can be used in coordination with the sliding pillars 2806 to raise and lower the treatment table.

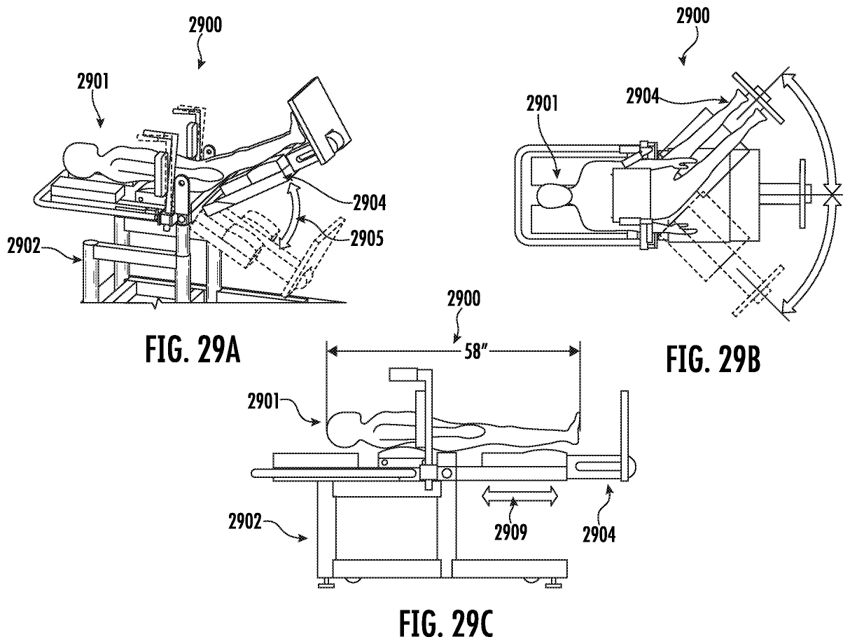

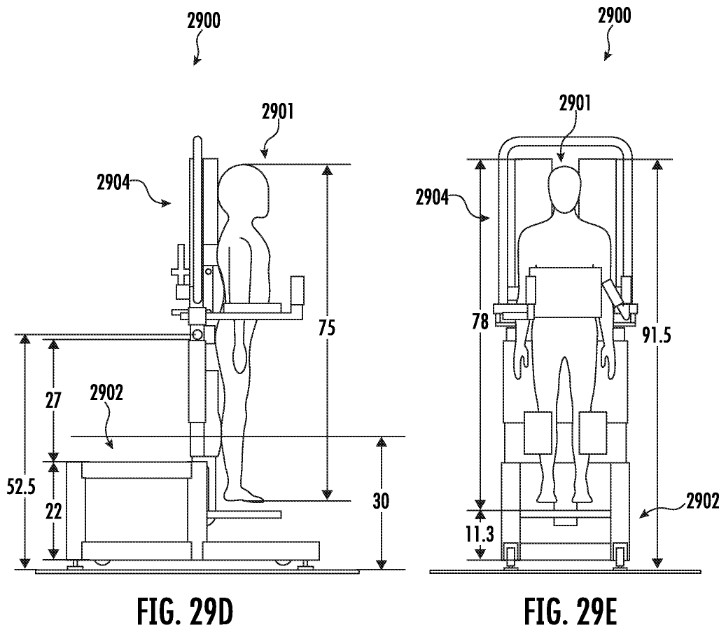

FIGS. 29A-29E illustrate positioning of a patient 2901 on a treatment table 2900 including a base section 2902 and a table section 2904. More particularly, FIG. 29A illustrates elevation 2905 of a leg portion of the table section 2904, FIG. 29B illustrates lateral swing 2907 (e.g., from 0 to 45 degrees in either direction) of the leg portion of the table section 2904, and FIG. 29C illustrates extension 2909 of the leg portion of the table section 2904. FIGS. 29D and 29E illustrate side and front views of the treatment table 2900. FIGS. 29C-29E also label examples of dimensions (in inches) of various portions of the treatment table 2900. It should be appreciated that such dimensions are presented by way of example only, and that embodiments are not limited solely to these dimensions.

FIG. 30 shows a treatment table 3000, illustrating movements of subassemblies or other portions thereof (e.g., head, thoracic, lumbar, pelvis and leg subassemblies or support pads or cushions thereof) along axes 3001, 3002, 3003 and 3004 enabling side-to-side or lateral repositioning as well as rotation. Pelvis and leg sections of the treatment table 3000 are configured to rotate around the craniocaudal axis 3001. The thoracic spine and regions above are configured to rotate about an upper axis 3002 parallel to the anteroposterior axis. The pelvis and regions below are configured to rotate about a lower axis 3003 parallel to the anteroposterior axis. The cushions or pads of the treatment table 3000 are configured to lockingly slide side-to-side as shown by movement 3004 of thoracic pads, movement 3006 of lumbar pads, and movement 3008 of a pelvic pad 3010. The pelvic pad 3010 is also able to rotate 3012 as shown.

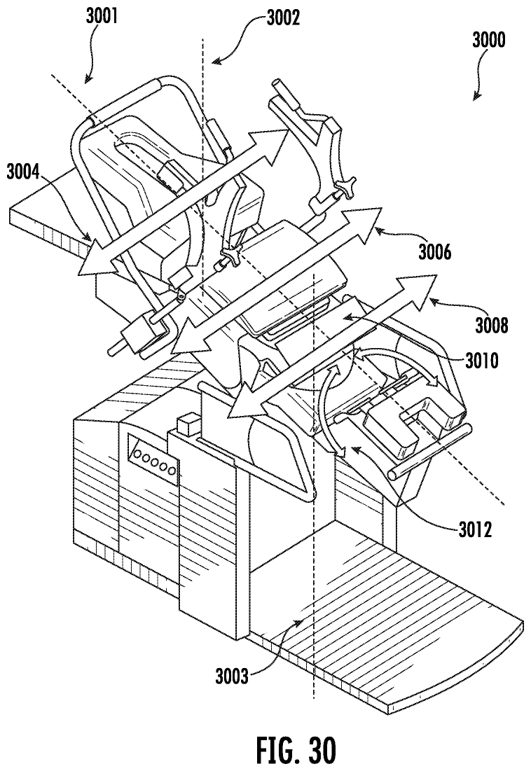

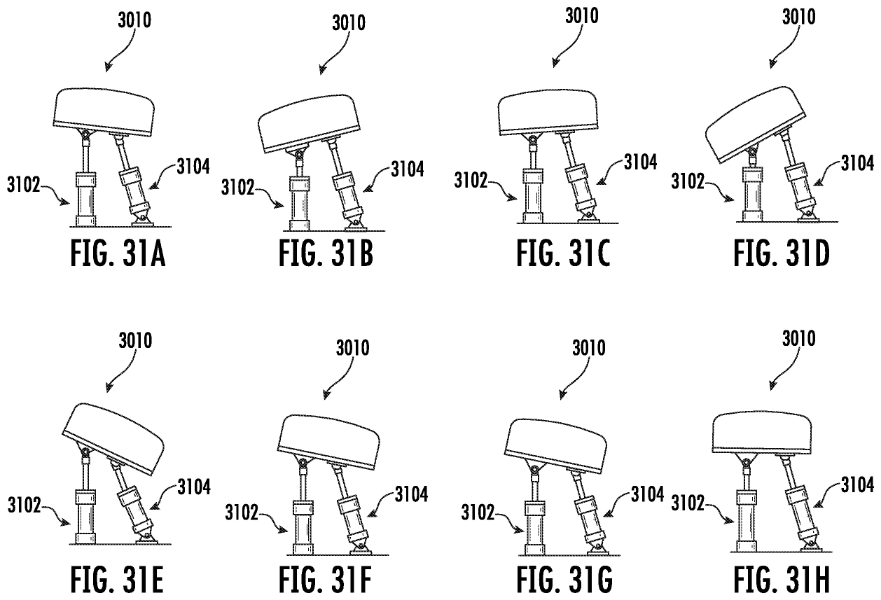

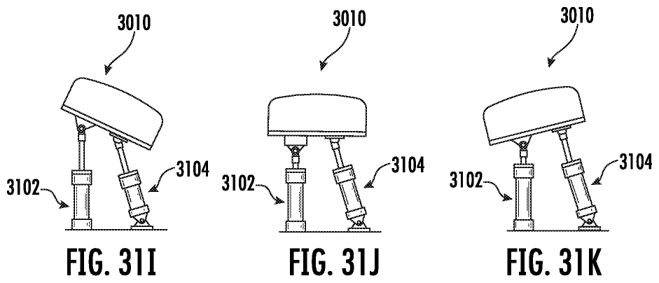

FIGS. 31A-31K show how the pelvis pad 3010 may be rotated approximately 30 degrees right and left by changing the relative heights and angles of the actuators 3102 and 3104. The actuators 3102 and 3104 may each comprise a pair of cylinder and piston actuators whose heights and angles may be changed relative to one another to achieve the desired tilt and rotation of the pelvis pad 3010 (e.g., and thus changing the lumbar support for rotation of the pelvis and spine of a patient). In some embodiments, the pelvis pad 3010 is combined in a single unit with a lumbar pad and the actuators 3102 and 3104 move the pelvis and lumbar pads as a single unit in the manner shown in FIGS. 31A-31K.

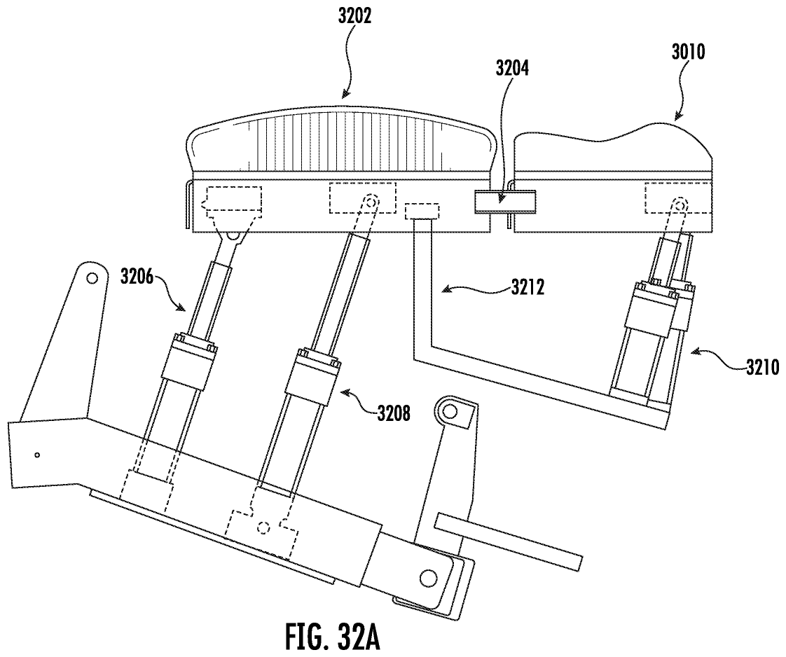

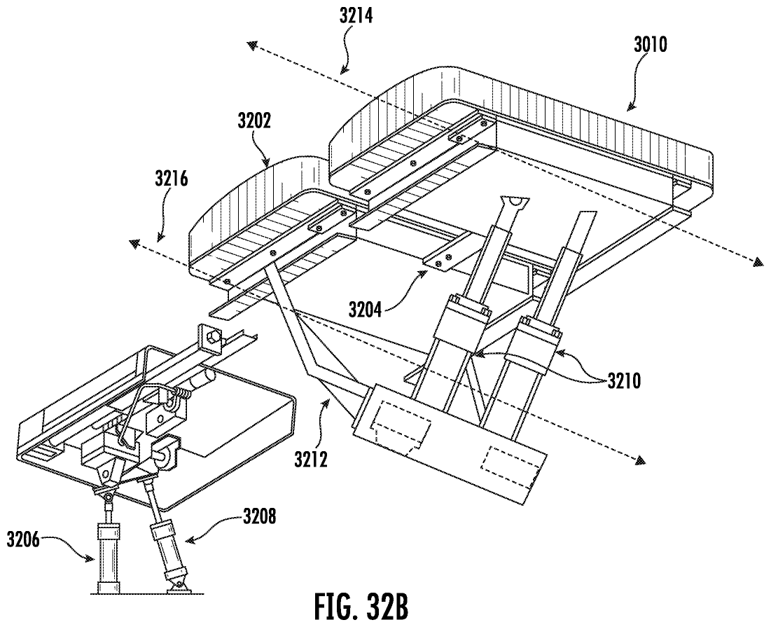

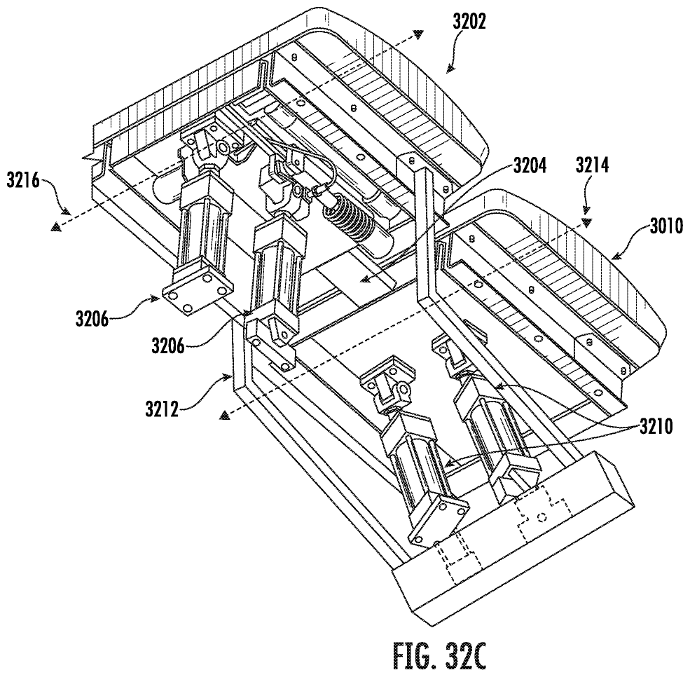

FIGS. 32A-32C show views of the pelvis pad 3010 coupled to a lumbar pad 3202 via a pivot point 3204. The lumbar pad 3202 is also connected to actuators 3206 and 3208 for movement of the lumbar pad 3202. In this embodiment, the pelvis pad 3010 includes a pair of actuators 3210 (e.g., cylinder and piston actuators) that are coupled via arms 3212 to the lumbar pad 3202 to effect movement of the pelvis pad 3010 as described herein. FIG. 32A shows a side view. The pelvis pad 3010 and lumbar pad 3202 are each configured to move side-to-side 3214 and 3216 as illustrated in the perspective view of FIG. 32B and the underside oblique view of FIG. 32C. Such side-to-side movement 3214 and 3216 may be controlled via locking mechanisms. The actuators 3210 may be configured to rotate at their attachment points to the underside of the pelvis pad 3010, with the other ends of the actuators 3210 being attached to fixed or rotating attachment points as desired. In some embodiments, the actuators 3210 and arms 3212 are interchangeable, or are replaced with a rotary support element (e.g., pivot point 3204).

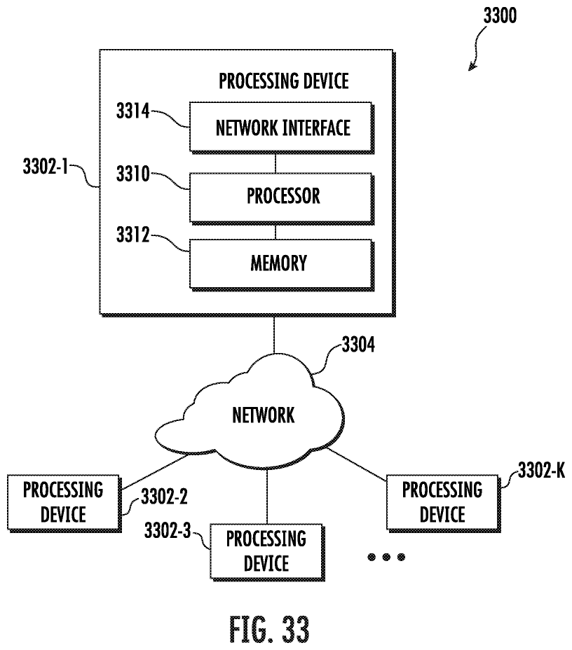

In various embodiments, aspects of a treatment table may be implemented using one or more information processing systems. For example, controls and control interfaces for a treatment table may be implemented at least in part using one or more information processing systems. FIG. 33 shows an example of an information processing system 3300 that may be utilized to implement the control system of a treatment table and other aspects described herein. The information processing system 3300 in FIG. 33 includes a plurality of processing devices 3302-1, 3302-2, 3302-3, . . . 3302-K (collectively, processing devices 3302), which communicate with one another over a network 3304.

The control systems of treatment tables described herein may be configured using one or more of the processing devices 3302 to implement its associated functionality. For example, algorithms for controlling the tilt, rotation and other movement of different portions and section of a treatment table may be implemented using one or more of the processing devices 3302, such as processing device 3302-1, which comprises a processor 3310 and a memory 3312. The processing device 3302-1 may be suitably coupled to other hardware of a treatment table (e.g., actuators, force sensors, position sensors, etc.) that support various functionality for movement of portions, sections and other components of the treatment table. The processor 3310 executes software program code stored in the memory 3312 in order to control the performance of processing operations and other functionality. Such functionality includes, but is not limited to, engaging actuators to effect a desired movement or treatment using the treatment table, etc. The processing device 3302-1 also comprises a network interface 3314 that supports communication over one or more networks such as network 3304.

The processor 3310 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of processing circuitry, in any combination.

The memory 3312 stores software program code for execution by the processor 3310 in implementing portions of the functionality of the processing device 3302-1. A given such memory that stores such program code for execution by a corresponding processor is an example of what is more generally referred to herein as a processor-readable storage medium having program code embodied therein, and may comprise, for example, electronic memory such as static random-access memory (SRAM), dynamic random-access memory (DRAM) or other types of random-access memory (RAM), read-only memory (ROM), magnetic memory, optical memory, or other types of storage devices in any combination.

Articles of manufacture comprising such processor-readable storage media are considered embodiments of the invention. The term “article of manufacture” as used herein should be understood to exclude transitory, propagating signals.

Other types of computer program products comprising processor-readable storage media can be implemented in other embodiments.

In addition, embodiments of the invention may be implemented in the form of integrated circuits comprising processing circuitry configured to implement processing operations associated with the embodiments described herein.

Although not shown in FIG. 33, other ones of the processing devices 3302-2 through 3302-K are assumed to be similarly configured with respective processors, memories and network interfaces.

One or more of the processing devices 3302 in a given embodiment can include, for example, laptop, tablet or desktop personal computers, mobile telephones, or other types of computers or communication devices, in any combination.

Communications between the various elements of an information processing system 3300 comprising processing devices 3302 associated with respective components or assemblies of a treatment table may take place over one or more networks, represented in FIG. 33 as network 3304. Such networks can illustratively include, for example, a global computer network such as the Internet, a wide area network (WAN), a local area network (LAN), a satellite network, a telephone or cable network, a cellular network, a wireless network implemented using a wireless protocol such as WiFi or WiMAX, or various portions or combinations of these and other types of communication networks.

An information processing system as disclosed herein may be implemented using one or more processing platforms, or portions thereof.

For example, one illustrative embodiment of a processing platform that may be used to implement at least a portion of an information processing system comprises cloud infrastructure including virtual machines implemented using a hypervisor that runs on physical infrastructure. Such virtual machines may comprise respective processing devices that communicate with one another over one or more networks.

The cloud infrastructure in such an embodiment may further comprise one or more sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the information processing system.

Another illustrative embodiment of a processing platform that may be used to implement at least a portion of an information processing system as disclosed herein comprises a plurality of processing devices which communicate with one another over at least one network as in the FIG. 33 information processing system.

Again, these particular processing platforms are presented by way of example only, and an information processing system may include additional or alternative processing platforms, as well as numerous distinct processing platforms in any combination, with each such platform comprising one or more computers, servers, storage devices or other processing devices.

For example, other processing platforms used to implement embodiments of the invention can comprise different types of virtualization infrastructure in place of or in addition to virtualization infrastructure comprising virtual machines. Thus, it is possible in some embodiments that system components can run at least in part in cloud infrastructure or other types of virtualization infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components or functionality of the system as disclosed herein can be implemented at least in part in the form of one or more software programs stored in memory and executed by a processor of a processing device.

Accordingly, a given component of an information processing system implementing functionality as described herein is illustratively configured utilizing a corresponding processing device comprising a processor coupled to a memory. The processor executes program code stored in the memory in order to control the performance of processing operations and other functionality. The processing device also comprises a network interface that supports communication over one or more networks.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed techniques to provide additional or alternative functionality in other contexts. The disclosed techniques can be similarly adapted for use in a wide variety of other types of information processing systems.

It is also to be appreciated that the particular process steps used in the embodiments described herein are exemplary only, and other embodiments can utilize different types and arrangements of processing operations. For example, certain process steps described as being performed serially in the illustrative embodiments can in other embodiments be performed at least in part in parallel with one another.

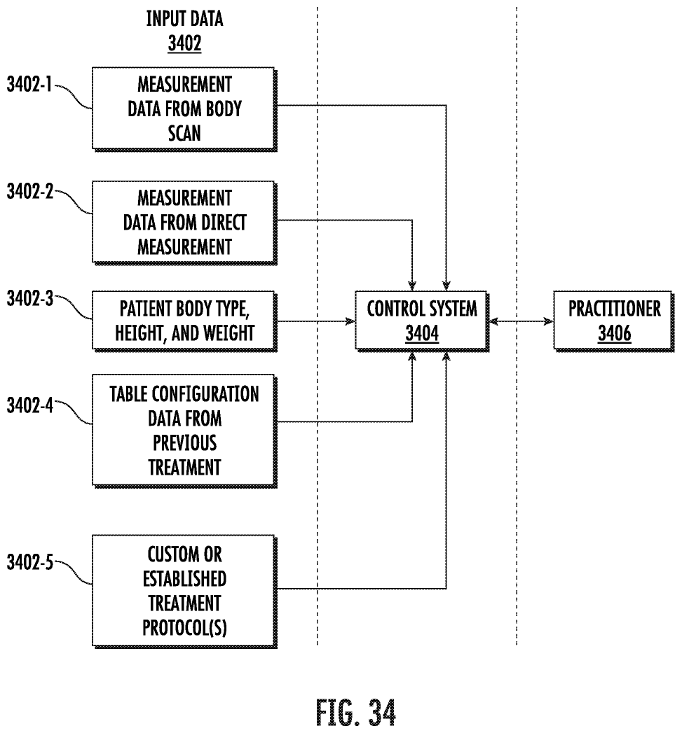

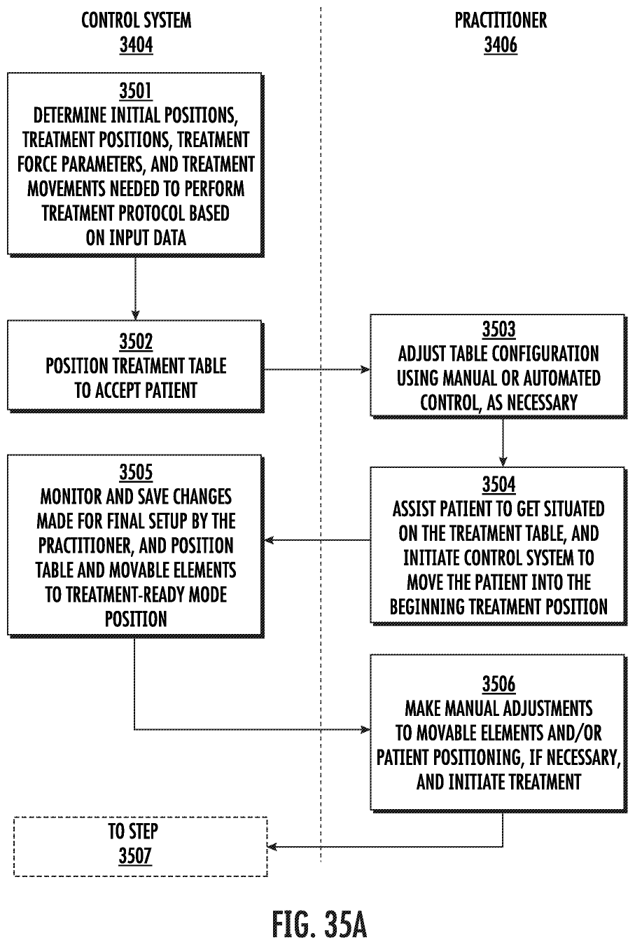

FIG. 34 shows input data 3402 provided to a control system 3404 of a treatment table (e.g., which may be any of the treatment tables described herein) that is being operated by a practitioner 3406. In the FIG. 34 embodiment, the input data 3402 includes measurement data 3402-1 for a patient obtained from a body scan of the patient. The body scan measurement data 3402-1 may be obtained or derived from any suitable source, such as patient health records, X-rays or other types of scans, etc. The body scan measurement data 3402-1, in some embodiments, is obtained at least in part utilizing a functional feature 911 of a C-arm structure 907, 907′ attached to the treatment table. The body scan measurement data 3402-1, as well as other types of the input data 3402 described below, may be manually entered into the control system 3404 by the practitioner 3406, or may be transferred using any suitable data transfer protocol (e.g., such as communication between processing devices 3302 over a network 3304 as described above with respect to system 3300). The input data 3402 also includes measurement data 3402-2 from direct measurement of the patient. Such direct measurement of the patient may be performed by the practitioner 3406, may be obtained from patient health records, etc. The input data 3402 further includes patient body type, height and weight 3402-3.

The input data 3402-1 through 3402-3 generally describes the patient that will utilize the treatment table. The control system 3404 uses this input data 3402-1 through 3402-3 to set up positions of the treatment table elements such as cushions. Additional input data 3402 characterizes the treatment table configuration 3402-4 and treatment protocols 3402-5. The treatment table configuration input data 3402-4, in some embodiments, includes data obtained or derived from previous operation of other treatment tables (e.g., feedback regarding motions and manual adjustments by the practitioner 3406 during previous treatment sessions with the same patient, with other patients, etc.). The treatment protocol input data 3402-5 may include customer or predefined treatment protocols that are selected and loaded into the treatment table. For example, the treatment table may be programmed with instructions for performing various treatment protocols involving different sequences of motion of movable elements of the treatment table.

It should be appreciated that the various input data 3402 described above is presented by way of example only, and that embodiments are not limited solely to the above-described types of input data 3402-1 through 3402-5. By way of example, the input data 3402 in some embodiment may further include patient or practitioner preference settings (e.g., such as relating to designated ranges of motion, applied forces, etc.). Various other examples are possible.

The control system 3404 utilizes the input data 3402, readings of various positional sensors, actuators, etc. of the treatment table, and practitioner 3406 input from controls such as joysticks, control bars, switches, etc., so as to control operation of the treatment table (e.g., motion or movable elements thereof). In some embodiments, positional sensors can be included for one or all movable elements of the treatment table. The control system 3404 processes such information to automatically perform treatments, or to assist the practitioner 3406 in performing treatments. Feedback may be provided by the practitioner 3406 or patient via a graphical user interface (GUI) of the treatment table, via audible tones, through vibration, pushback on controls such as joysticks, control bars, handles, buttons, etc. Artificial intelligence or machine learning may be used in some embodiments to learn typical or expected practitioner 3406 inputs for specific patient types with specific conditions.

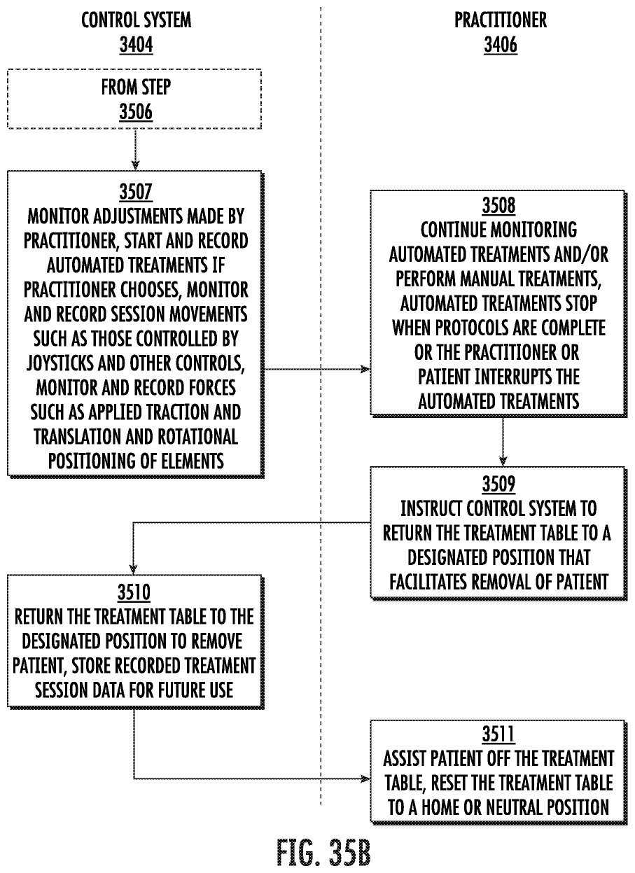

FIGS. 35A and 35B show a process flow for the practitioner 3406 to operate a treatment table utilizing the control system 3404. Such operation may be based on the input data 3402 described above. As shown in FIG. 35A, the control system 3404 in step 3501 determines initial positions, treatment positions, treatment force parameters, and treatment movements needed to perform specified treatment protocols based on the input data 3402. In step 3502, the control system 3404 positions the treatment table to accept the patient. The practitioner 3406 adjusts the table configuration using manual or automated controls, as necessary, in step 3503. The practitioner 3406 assists the patient to get situated on the treatment table in step 3504, and initiates the control system 3404 to move the patient into the beginning treatment position for a specific treatment protocol in step 3504. The control system 3404 in step 3505 monitors and saves the changes made for final setup by the practitioner 3406, and positions the treatment table and moveable elements to treatment-ready mode positions.

As shown in FIG. 35B, the control system 3404 in step 3507 monitors adjustments made by the practitioner 3406, starts and records automated treatments if the practitioner 3406 chooses, monitors and records session movements such as those controlled by joysticks and other controls of the treatment table, and monitors and records forces such as applied traction and translational and rotational positioning of movable elements of the treatment table. In step 3508, the practitioner 3406 continues monitoring automated treatments and/or performs manual treatments. The automated treatments stop when associated treatment protocols are complete, or when the practitioner 3406 or patient interrupts the automated treatments. The practitioner 3406 in step 3509 instructs the control system 3404 to return the treatment table to a designated position that facilitates removal of the patient (e.g., such as a starting, default or neutral position of the treatment table). In step 3510, the control system 3404 returns the treatment table to the designated position to remove the patient and stores the recorded treatment session data for future use. Such recorded treatment session data may provide at least a portion of the input data 3402-4 for future treatments. The practitioner 3406 in step 3511 assists the patient of the treatment table, and resets the treatment table to a home or neutral position.

It should again be emphasized that the embodiments of the invention as described herein are intended to be illustrative only. Other embodiments of the invention can be implemented utilizing a wide variety of different types and arrangements of components of a treatment table, including combinations of features described in conjunction with different ones of the figures. Also, the particular types and configurations of movements of the treatment table or portions, sections or other components thereof can be varied in other embodiments. Furthermore, the way in which a particular treatment table is utilized can be varied. In addition, the particular assumptions made herein in the context of describing certain embodiments need not apply in other embodiments. These and numerous other alternative embodiments will be readily apparent to those skilled in the art.

What is claimed is:

1. A frame positioning device, comprising:
a base assembly;
an elevation and rotation assembly coupled to the base assembly; and
a table assembly coupled to the elevation and rotation assembly;
wherein the table assembly comprises a table support and pivot subassembly, a first table section subassembly, and a second table section subassembly;
wherein the table support and pivot subassembly is coupled to the first table section subassembly via a first pivot point; and
wherein the table support and pivot subassembly is coupled to the second table section subassembly via a second pivot point.

2. The frame positioning device of claim 1 wherein the elevation and rotation assembly comprises one or more actuators, the one or more actuators being configured:
to adjust an elevation of the table assembly relative to the base assembly; and
to adjust a rotation of the table assembly about a table pivot point axis of a table pivot point coupling the table assembly to the elevation and rotation assembly.

3. The frame positioning device of claim 1 wherein the elevation and rotation assembly comprises at least one of:
a four-bar mechanism;
one or more telescoping pillars;
one or more robotic arms; and
one or more sets of sliding pillars table.

4. The frame positioning device of claim 1 wherein the table support and pivot subassembly comprises two or more actuators, at least a first one of the two or more actuators being coupled to the first table section subassembly and at least a second one of the two or more actuators being coupled to the second table section subassembly.

5. The frame positioning device of claim 4 wherein the first actuator is configured to at least one of elevate, tilt and rotate the first table section subassembly about the first pivot point, wherein the second actuator is configured to at least one of elevate, tilt and rotate the second table section subassembly about the second pivot point, and wherein said at least one of the elevation, tilt and rotation of the first table section subassembly is independent of said at least one of the elevation, tilt and rotation of the second table section subassembly.

6. The frame positioning device of claim 5 wherein the first table section subassembly comprises a thoracic support section and the second table section subassembly comprises a pelvis support section and a leg support section.

7. The frame positioning device of claim 6 wherein the first table section subassembly further comprises a lumbar support section.

8. The frame positioning device of claim 6 wherein the second table section subassembly further comprises a lumbar support section.

9. The frame positioning device of claim 8 wherein the pelvis support section and the lumbar support section comprise a combined lumbar and pelvis support pad.

10. The frame positioning device of claim 8 wherein the pelvis support section comprises a pelvis support pad and the lumbar support section comprises a lumbar support pad, the pelvis support pad being separate from the lumbar support pad.

11. The frame positioning device of claim 6 wherein the second table section subassembly further comprises a knee support section disposed between the pelvis support section and the leg support section.

12. The frame positioning device of claim 11 wherein the knee support section is configured for at least one of telescoping, sliding and pivoting independent of the pelvis support section and the leg support section.

13. The frame positioning device of claim 6 wherein the table assembly further comprises a third table section subassembly coupled to the table support and pivot subassembly, the third table section subassembly comprising a lumbar support section.

14. The frame positioning device of claim 6 wherein the pelvis support section is configured to at least one of elevate, tilt, rotate and extend independent of the leg support section.

15. The frame positioning device of claim 1 wherein at least one of the first table section subassembly and the second table section subassembly comprises at least one support pad configured for sliding along an axis extending between lateral edges of the table assembly.

16. The frame positioning device of claim 1 wherein at least one of the first table section subassembly and the second table section subassembly comprises at least one support pad configured for pivoting about an axis extending from a top edge of the table assembly to a bottom edge of the table assembly.

17. The frame positioning device of claim 1 wherein at least one of the first table section subassembly and the second table section subassembly is configured for attachment to a C-arm structure.

18. The frame positioning device of claim 1 further comprising a controller, the controller being configured to adjust at least one of an elevation and a rotation of the table assembly relative to the base assembly utilizing the elevation and rotation assembly.

19. The frame positioning device of claim 18 wherein the controller is configured to adjust said at least one of the elevation and the rotation of the table assembly between a vertical position and a horizontal position.

20. The frame positioning device of claim 1 further comprising a controller, the controller being configured to adjust positions of the first table section subassembly and the second table section subassembly about the first and second pivot points.

21. A treatment table comprising the frame positioning device of claim 1.

22. A method of operating a frame positioning device comprising:
obtaining at least one of motion and scan analysis data for a user;
determining position settings for performing one or more sequences of motion of the user based at least in part on the motion and scan analysis data; and
performing a selected one of the one or more sequences of motion by adjusting positioning of a table assembly of the frame positioning device utilizing one or more actuators of the frame positioning device;
wherein the table assembly comprises a table support and pivot subassembly, a first table section subassembly coupled to the table support and pivot subassembly via a first pivot point, and a second table section subassembly coupled to the table support and pivot subassembly via a second pivot point;
wherein adjusting the positioning of the table assembly comprises at least one of adjusting a first position of the first table section subassembly about the first pivot point and adjusting a second position of the second table section subassembly about the second pivot point; and
wherein the method is performed by a controller of the frame positioning device, the controller comprising at least one processing device comprising a processor coupled to a memory.

23. The method of claim 22 wherein the table assembly is coupled to an elevation and rotation assembly of the frame positioning device, and wherein adjusting the positioning of the table assembly further comprises at least one of adjusting an elevation and a rotation of the table assembly relative to a base assembly of the frame positioning device, the base assembly being coupled to the elevation and rotation assembly.

24. The method of claim 22 further comprising receiving input data related to at least one of patient size, patient body type, and one or more expected treatment protocols, wherein the table assembly is coupled to an elevation and rotation assembly of the frame positioning device, and wherein adjusting the positioning of the table assembly further comprises adjusting at least one of an elevation and a rotation of the table assembly relative to a base assembly of the frame positioning device, the base assembly being coupled to the elevation and rotation assembly.

25. The method of claim 22 further comprising receiving feedback related to the positioning of the table assembly associated with the selected sequence of motion, and further adjusting the positioning of the table assembly of the frame positioning device based at least in part on the received feedback.

26. A computer program product comprising a non-transitory processor-readable storage medium having stored therein program code of one or more software programs, wherein the program code when executed by a controller of a frame positioning device causes the controller to perform steps of:
obtaining at least one of motion and scan analysis data for a user;
determining position settings for performing one or more sequences of motion of the user based at least in part on the motion and scan analysis data; and
performing a selected one of the one or more sequences of motion by adjusting positioning of a table assembly of the frame positioning device utilizing one or more actuators of the frame positioning device;
wherein the table assembly comprises a table support and pivot subassembly, a first table section subassembly coupled to the table support and pivot subassembly via a first pivot point, and a second table section subassembly coupled to the table support and pivot subassembly via a second pivot point; and
wherein adjusting the positioning of the table assembly comprises at least one of adjusting a first position of the first table section subassembly about the first pivot point and adjusting a second position of the second table section subassembly about the second pivot point.

27. The computer program product of claim 26 wherein the table assembly is coupled to an elevation and rotation assembly of the frame positioning device, and wherein adjusting the positioning of the table assembly further comprises at least one of adjusting an elevation and a rotation of the table assembly relative to a base assembly of the frame positioning device, the base assembly being coupled to the elevation and rotation assembly.

28. The computer program product of claim 26 wherein the program code when executed by the controller of the frame positioning device further causes the controller to perform the step of receiving input data related to at least one of patient size, patient body type, and one or more expected treatment protocols, wherein the table assembly is coupled to an elevation and rotation assembly of the frame positioning device, and wherein adjusting the positioning of the table assembly further comprises adjusting at least one of an elevation and a rotation of the table assembly relative to a base assembly of the frame positioning device, the base assembly being coupled to the elevation and rotation assembly.

29. The computer program product of claim 26 wherein the program code when executed by the controller of the frame positioning device further causes the controller to perform the steps of receiving feedback related to the positioning of the table assembly associated with the selected sequence of motion, and further adjusting the positioning of the table assembly of the frame positioning device based at least in part on the received feedback.
